(19) United States
(12) Patent Application Publication
(10) Pub. No.: US 2021/0004708 A1
(43) Pub. Date: Jan. 7, 2021

(54) Method for dimensional manipulation

(71) Applicant: Gregory M. Friedlander, Mobile, AL (US)

(72) Inventor: Gregory M. Friedlander, Mobile, AL (US)

(21) Appl. No.: 16/880,255

(22) Filed: May 21, 2020

Related U.S. Application Data
(63) Continuation-in-part of application No. 16/530,339, filed on Aug. 2, 2019, now abandoned.
Application No. 16/530,339 is a continuation-in-part of application No. 16/552,481, filed on Aug. 27, 2019.
Application No. 16/552,481 is a continuation-in-part of application No. 16/670,029, filed on Oct. 31, 2019.
(60) Provisional application No. 62/870,352, filed on Jul. 3, 2019.
(60) Provisional application No. 62/910,889, filed on Oct. 4, 2019.
(60) Provisional application No. 62/956,989, filed on Jan. 3, 2020.
(60) Provisional application No. 62/967,891, filed on Jan. 30, 2020.
(60) Provisional application No. 63/019,056, filed on May 1, 2020.

(30) Foreign Application Priority Data
Nov. 24, 2019 (US) 1962892

(51) Int. Cl. G06N 10/00; G06F 17/16

(52) U.S. Cl. CPC G06N 10/00; G06F 17/16

(57) ABSTRACT

A method for manipulating fractal forming information, also referred to as ct states, in a dimensional form of increasing and decreasing fractal compression roughly generated by the denominator of pi (fpix), n+1, and the formula 2f(x)\hat{ }(2\hat{ }x) including transitional steps between those stepwise increases and decreases by altering the compression of decompression targeting fractal states of the composite dimensional features (next lower dimensional features) or the resulting dimensional features (next higher dimensional features). Steps include identifying the ct states which are to be manipulated, select a compression or decompression ct state component to change the selected ct states, adding the compression or decompression components to yield the new ct states and using pellet designs to maximize the efficiency of the reactions targeted.

### PRIORITY STATEMENT

Priority of patents, all incorporated herein by reference, is hereby claimed (listed below)

| Ser. No. | Filed | EFS ID |
|---|---|---|
| 62/798,573 | Jan. 30, 2019 | 35004134 |
| 62/851,832 | May 23, 2019 | 36097099 |
| 62/870,352 | Jul. 3, 2019 | |
| 16/530,339 | Aug. 2, 2019 | 36769989 (U.S. Pat. No.) |
| 16/552,481 | Aug. 27, 2019 | 36993126 (U.S. Pat. No.) |
| 62/910,889 | Oct. 4, 2019 | 37372502 |
| 16/670,029 | Oct. 31, 2019 | 37619967 |
| PCT/US19/62892 | Nov. 24, 2019 | |
| | (24 Nov. 2019) | |
| 62/956,989 | Jan. 3, 2020 | 38201762 (provisional) |
| 62/967,891 | Jan. 30, 2020 | (provisional) |
| 63/019,056 | May 1, 2020 | 39332414 (provisional) |

### 1. BACKGROUND OF INVENTION

Priority patents reflect dimensional and non-dimensional features of the universe.

Forces and time are the effect of force independent transitional changes between the different dimensional features, e.g. gravity is the transition from space to pre-charge, dark energy the opposite transition. Energy represents our ability to control within a range the pre-time changes to speed up and slow down those changes relative to time which arises gradually as the base states change, primarily between base 3 and base 5 states (ct3 to ct4).

### Field of Invention

The invention relates manipulation of time, force and matter using fractal features and maximizing the efficiency of dimensional interactions.

This new model shows pre-time and different dimensional aspects of the universe which can be manipulated to provide useful results for dimensional manipulation and prediction.

Because AUT defines time; it also defines energy as pre-time change and it opens up the ability to tap “hidden variables” directly, those ct changes that occur before ct3 and create alternating currents of gravity and dark energy.

### Prior Art

The standard model has a view of the universe which is time and dimension driven. Positrons, electrons, gamma rays, other radiation (high energy light, heat for example) and muons are examples of pre-AuT designations which are inadequate.

There are dozens of designs for fusion reactors, some patented; they all lack a fractal approach. https://spectrum.ieee.org/energy/nuclear/5-big-ideas-for-making-fusion-power-a-reality. https://phys.org/news/2020-01-relativistic-effects-laser-fusion-approach.html.

The use of “plasma guns” firing ionized gas inward to compress and heat a central gas target do not control the reactants to create stable resulting fractal interactions.

Other fusion experiments employ either magnetic confinement, which relies on powerful magnetic fields to contain a fusion plasma, or inertial confinement, which uses heat and compression to create the conditions for fusion.

Tokamaks use magnetized fuel plasma to help mitigate losses of particles and thermal energy, results that are contraindicated as shown below.

In bombs, a heavy imploding shell (the plasma liner, often a foam) rapidly compresses and heats the fuel without fractal modeling, using a fission reaction, a six percent yield is obtained with little or no post explosion control; randomized. For this reason, even where fission reactions are used to trigger stripping and pressure, only a 6% yield is observed and that is a coincidental and not designed fractal structural outcome.

Not all the models are prior art, many of them are developments after the priority documents for AuT disclosures and patents. An Example is https://phys.org/news/2020-01-attosecond-atomic-electron-cloud.html.

For weak fields, the rate of time flows proportional to 1+2V/c2, where V is the gravitational potential. That was one of Einstein's key results.

### GENERAL DISCUSSION OF THE INVENTION

Iterated equations give rise to fractals. We observe the changing iterated equations and we observe the resulting fractals. AuT allows that the inclusion and elimination of specific ct states (transitional states and complete ct states) can be used to encourage or discourage chemical reactions. An example of the redesign is to treat muons as T14 base 6 states with the extra energy being an increase in lower ct4 transition states and ratios of ct3 states and the amount of fuse change within the matrix.

Iterated Equations and Proofs

There are 3 non-transitional units of space (ct1, ct2 and ct3) result from underlying iterated equations and resulting fractals.

Since changing iterated equations give rise to fractals, mathematical fractal dimensions arise from these iterated equations. All change, including time, can be observed as result from a quantum count; a base fractal (n+1) which is distinguished from time which is a dimensional effect.

Iterated equations are observed. It is observed in the denominator of pi, called fpix:

(fpix=−1\hat{ }x+2x(−1)\hat{ }(x−1)).

The numerator appears to follow the same pattern initially, but it is more sequential, −1, 1, 2, 3, 4, 5 . . . .

“Resulting” refers to the fact that if you track solutions to fpix, the results generate the second fractals, Fibonacci series (golden ratio). There are two changing parts of quantum point (ct1 fpix) solutions and one fixed element. The fixed element is solution order. The first changing element is the positive or negative value and the second is the fuse length. The series looks like this (−1, 1, −3, 5, −7, etc) A point which has a value of 5 will exist for 5 changes (a fuse length of 5) in x before becoming negative and obtaining a fuse length of 7. Simply put, “quantum” means 1. Quantum time and quantum separation are not good terms because at the quantum level, there is neither time nor distance, instead there is a quantum count (1, 2, 3, 4, etc which is “change” and there are quantum points which are positive or negative with increasing fuse length. Time as we experience it arises gradually at the ct3-ct4 transition where there are 10\hat{ }44 changes per second based on a Planck length analysis, although sub-time change influences perceived time as well as the amount of energy within the system observed.

Ct2 and subsequent “compression states” (ct3, ct4, ct5) arise gradually from memorized solutions to ct1 and defined by the Fibonacci ratio in this formula (2f(x)\hat{ }(2\hat{ }x). A detailed explanation of those features and how they correspond to observations appears in the published articles. Speed is always zero at the quantum level. Time can be replaced in reactions and recharacterized because of compression and the ratio of ct1-3 exchange (seen as light speed) to higher ct states which are inversely proportional to velocity. Velocity below light speed may be viewed as the ratio of low ct4t states to those above ct4t9. This ratio appears in the Lorentz equation as v\hat{ }2/c\hat{ }2 where change of ct1-3 are hidden variables; giving rise to quantum moments of time and minimum dimension size when they become apparent.

### Base States

Ct1 is 100% dense, a base 1 state. You cannot move through it because it is only separated by solution order. What we call space is at least ct1, ct2 and ct3; base 1, 2 and 3 states along with transitional states between. It is viewed as “space-time” because the buildup of dimension over ct1-ct3 and much of ct3-ct4 gives rise to the stop frame animation features we call time.AuT shows why the periodic table reflects the transition from base 3 (6) to base 5 (10); the parenthetical being the 2× iterated feature that reflects scale, the lower number outside the parenthetical is the fractal stability base number f(n).

Base 3 results (3, 6, 9, 12, and 15) reflect the stability of the ct3-neutron changes, although base 5 results (5, 10, 15, 20, etc) become more important with increasing compression. Measurements indicate that the proton is an open base 10 system made up of base 3 ct4t15 states.

Different base numbering designs 2, 4, 6 (shift at 6 to 3) 3, 6, 9, 12, 15; (shift at 15 to a base 5); 5, 10, 15, 20 . . . 160 (shifting to base 8 at 160) yield structures predicted and observed.

The periodic table focuses on electromagnetic effects and the number of protons in a system; the fusion table focuses on neutron backbone geometry, stability, stabilizing shells and compression absorption and spew at the ct5t1 level. The protons and electrons are stabilizing features of the neutron backbone where isotopes are elemental features instead of the neutrons being the isotope features.

While expanding and contracting spiraling is observed in nature, it is possible to get the same effect by stepped chambers 1, 3, 5, 8 (3, 6, 9), (5, 10, 15), etc along with or in addition to actual spiraling.

All elements of existence, including time, boil down to ct1 changes and quantum change or quantum count giving rise to those changes. F=n*a, e=mc\hat{ }2, pv=nrt are prior art approximations of observed compression changes.

An example, (pv-nrt) can be broken down. NR can be eliminated for purposes of the discussion as constants in a given volume. Pressure being the effect in question is a function of temperature and volume. Volume in turn can be broken down as ct1-ct3 along with early ct4 transitional states at or below ct4t12. Temperature reflects the pretime changes in this volume reflected in time which is the energy portion of the temperature. Pressure then is a function of pre-time change of the volume divided by the volume or, effectively, pretime change divided by total amount of information subject to change.

### Molecular Bonds

Molecular bonds provide a hybrid of 3/6 and 5/10 symmetry with increasing 5/10-dimensional components at the atomic level and lower, 3/6 dimensional components holding the atoms together.

What begins as basic 5/10 pairing, evolves into the 8/16 fractal model by virtue of the varying base. The second and third rows of the periodic table represent the base 16 in the form of paired 8-8 halves in orbital terms.

Fractal math tells us that the overlapping, balanced spiral model applies to all fractals although they are differentiated based on (1) the base (numerator of pi, for the compression state in question) and (2) the amount of involved compression (2\hat{ }n).

### Elements of Proof

Energy, identified as pre-time changes, can be targeted using the model which means time can be targeted. The gradual transitions between the pre time energy states and post time states can be individually targeted. The amount of time, t9 states and lower states having high pre-time components, free within a system also define the amount of energy within the system. The closer these are to transitions as net decompression also affects the observed energy of the system since it defines the “active” component as opposed to “potential” energy component.

If this new model is accurate there must be a certain amount of post discovery obviousness. Observe:

The first is that is must be right, we see this because there are observed iterated equations and resulting fractals, fundamentally the denominator of pi and the resulting golden ratio. AuT has shown the direct relationship between those two according to several different vectors, notably tracking fpix results to get golden ratio results and the relationship of the evolving numerator of pi to the golden ratio, exponential compression results and identifying the fractals tying together force and mass features, unifying them in the process.

The second is that the model must be durable, in the face of observations it must hold up. There are innumerable examples from solving Zeno's paradox to wave particle duality. The discussion of duality, the solution to a 100-year-old paradox) is shown by eliminating infinite divisibility. The model goes further, explaining time and force. In this case the best example may be how easily it unifies force. You can do this with a hand calculator and the relative value of forces using 2f(n)\hat{ }2\hat{ }n where n=1, 2, 3, 5, 8; the first 5 solutions to the Fibonacci series or golden ratio.

Folding from n=1 to 2 yields the relative value of gravity, from n=3 to 5 yields the mass energy equation (e=mc\hat{ }2); from n=5 to 8 folding yields the strong force. The other forces are internally reconciled by the standard model as electromagnetic phenomena, although what that means is explained with more detail by AuT.

The third given here is that the model is confirmed by otherwise unexpected observations. MIT in October of 2019* found smoking gun evidence of what we proved mathematically in 2013 and applied to fractals at the end of 2018. In October of 2019, over a year after the first patents on this fractal innovation were filed, MIT scientist reported a “completely unexpected” fractal quality to observed “quantum” features. Phys.org: Scientists discover fractal patterns in a quantum material. https://phys.org/news/2019-10-scientists-fractal-patterns-quantum-material.html. Equally important, the evidence of the model surrounds us, just hidden at the subatomic level by time. Time and energy are defined as a dimensional result of pre-time change by this model which changes our ability to manipulate its manipulation exponentially.

Observed mass equivalents: The electron is 5.4×10\hat{ }12 ct3 and black hole 16\hat{ }32 neutrons which match observations. The most glaring mass equivalence is the neutron to black hole which matches not only the strong force, but also the relative size of the observed minimum size black hole to the neutron.

A more nuanced example is dealing with the electron by mass. Modeling indicates the electron is 5 stable T-12 states plus one T-12 states in a destabilized form, designated as the electron bundle. Pre-time transitions occur between the t-12 states that make it energetic from the viewpoint of time.

The ratio 1844 of the neutron to the electron is approximately 1:1836 which is the best indication that T12 is the primary component (with other, lower t states) of the electron. A secondary indicator is the “factor of 3” status of t12. The “charge” of the electron is thought to be either the movement of t12 or the T9 shell around the electron interacting with the comparable shell around the T16 proton (t9 or t12 absorption and spew). The possibility of t6 vs t9 component status is important but is easily mathematically indicated.

This is approximately the same as the proton to electron mass: 1:1836.11 which converted to T states yields: 5.44628E+12. The 0.45×10\hat{ }12 part of electrons is lower transitional states more directly tied to the electron than to other states in proximity.

The complex electron is made up of partial time or pre-time elements, so that the combination of elements appears as a single fundamental particle with a single point of charge from the viewpoint of time even as the charge reflects absorption and spew between the electron and proton reflected as net states, theorized to be t6-12 states while the lower compression states would be the absorption and spew and the neutron as a “non-charged” state where non-charged refers to the fact that the absorption and spew is not that which appears as charge.

The open spiral form is due in part to the spew and by extension absorption of the higher compression states down the arm towards the center. These structures can be targeted to manipulate dimensional results. Experimentation will define the nature of spew.

The suggested of the electron/proton interface is that the two are constantly sharing a t12 state, it is absorbed by the proton, another is ejected and caught by the electron. It is like the electron pitches the t12 state to the bating box which absorbs the t12 state and ejects that one or another. During the transmission of electricity, the t12 state is not caught by the outfield arms of the electron and escapes into “the stands” to use a baseball metaphor.

How the information absorption and spew change between fractal states is important. Ct4t6-12 exchange as pre-photons giving rise to charge (electron absorption of t6-12 negative, proton spew of the same t6-12 being positive for example and how the opposite creates the oppositely charged positron features) is comparable but very different from the type of shared, non-charge information between the two proton halves of H2 and neutron sharing is different because of the closed structure of the neutron.

Just as the mass of the arms around the core has a center of gravity, constantly shifting, so too do the arms of the electron cloud have a center of spew, constantly shifting. There is a net spew from this entire galaxy of arms which moves about near the speed of light, nearer than we do, not only because the entire spiral of ct4t12 arms do, but because the net spew shifts at pretime speeds for lower ct4 transitional states.

The minimum size of the black hole in terms of mass is on the scale of 16\hat{ }32 neutrons. This also corresponds to the strong force. This is not coincidental, but instead reflects the scale of folding reflected between the base formula where n=4 to n=5.

According to the rejected standard model, a neutron, in weak force terms, decays into a proton, neutrino and electron. The view of AuT is not dissimilar, except that the transition involves a solid dimensionally distinct ct4 state decaying into a more cloud like dispersed ct3-4 transition states with a different dimensional structure, compression, and balance.

### Force, Mass, Fission, and Fusion Generally

The atomic repulsive force reflects ct2 unfolding, anti-gravity, the spew of ct2 and ct3 states and probably transitional states in the electromagnetic particle range and well as the ricochet off largely closed clouds of information which would otherwise be destabilized or opened.

The offset lasers may add spin at the level(s) where it does the most good while other forces serve to stabilize or destabilize the reactants so that they fit together correctly and in the right order and with bilateral symmetry.

If you take 1−4 the abs(1)+abs(−2) is the difference. This feature of F-series continues for all of the points

The value of the sum at the inflection point is the square root of the inflection point sums generating the n\hat{ }2

The new science takes the broader view where the movement of particles through space is a function of ct state compression and decompression along with the internal stability of the particle which changes as x changes even though the rate of change is relatively slow compared to changes where fuse lengths are shorter.

A non-homogeneous medium changes the interaction of the waves (bends and refracts the waves) which reflects different concentrations of compression and their interaction with other stable and unstable compression states. The lower the compression, the greater the effect of pretime changes and thus the apparent acceleration of photons towards the speed of light or, more accurately, the transition between ct3 and ct4 change.

Equations describe the electromagnetic field that corresponds to a ray of light and to use these better, they must be converted to time, pre-time and particulate features which can be used, for example, in qubit operation.

One of the best places to see this is at the t4t9/6 (photon component), ct4t12 (electron component):ct4t5 (proton component): and the ct4t16 (proton) to t4 (neutron) transition.

Coulomb's law reflects one of several things: t9/t12 spew, the negative part of the compression feature (where the first graph line is going negative), etc. Because it is quasi visible (identified as photon and prephoton states (ct4t9 components) we have something we can work with.

A house has a foundation. We see the house, but without the foundation (the fractal neutron base) it falls apart. We don't see charged absorption and spew for the neutron. Instead, because of the dimensional change and consequent closing of the spiral shells of the proton into the shell of the resulting neutron, there is more internal sharing of t12/t9/6 components and the absorption and spew is primarily something else, lower ct states. A neutron spewing t12/t9/t6 would be disintegrating as the shell opened.

This restriction leads to the changes in perceived force for the different compression states.

In a gravity well (sitting here on earth) ct1 is “net” coming in and a higher ct state is “net” being spewed, providing a refracting shield of t6 states woven together by the spinning of the shield saving us from solar radiation which is either absorbed and re-emitted outward more than inward or carried in the resulting flow around the earth or reflected off the weave.

Because of exponential compression, one ct3 being spewed from earth requires over a million ct1's coning in if things are balanced. If we could see it the earth would look very bizarre with all these lines coming in and going out everywhere. What we see is a net effect (gravity) and a net effect of magnetism from the poles since the earth is spinning about the poles.

In an expanding area of the universe (think the earth moving in F-series spirals) with solar, galactic and post galactic movement) you have this ct1 pushing everything apart and since it is breaking up from higher spiral states, the breakup gives the impression of spiral movement. Ct1, ct2, ct3 net break down averaged together from a post time environment appears smooth. Because the fuse lengths are so long, the break down appears consistent even though it changes very subtly. It is too subtle to appear even over hundreds of millions of years because of the 10\hat{ }150 fuse length and the 10\hat{ }44 changes per second approximation of pre-time to post-time change rates.

The new science states that over a set value of x (absolute quantum change) mass is a function of ct3:ct4:ct5 compression, time and therefore dv are a function of changing ct1-3, the speed of light is the ratio of ct3:ct4 and energy is pre-time change within the system, a function of compression and fuse length.

Inertial mass is the quantity that characterizes the extent to which a body, floating in empty space, resists an accelerating force. This is the mass m that goes into Newton's equation, F=ma, which relates force F to acceleration a. From a relativistic standpoint, this force is a change in the pre-time changes associated with the mass. The more pre-time changes associated with the mass, the less mass-like it appears, but the faster it changes and therefore the faster it appears to be moving. This can be written dct1-3/dct3-4 is acceleration force.

### Weak Force

Range is a function of the folding range.

AuT does not take a definitive approach in what type of loading and unloading is responsible for the weak force since there are several alternatives that are worth considering, but all are structural, particle pre-time physics as opposed to field theory physics.

When you convert 16\hat{ }32 ct5 states to base 10 you get 3.4×1038, the relative scale of the strong force and gravity.

The weak force is 10\hat{ }25 (10\hat{ }38/10\hat{ }13=10\hat{ }25 which ties the weak force to the electron and neutron compression) and can be theorized to roughly correspond to the electron (10\hat{ }13 as 5.4×10\hat{ }12 measured compression states) structural component coming off of the 10\hat{ }38 ct5 component consistent with electron-proton loading along the neutron backbone on the ct5 information arms.

### Electromagnetic Force

The scale of the electromagnetic force at 10\hat{ }36 is only a factor of 100 off from the ct5 information arm loading (10\hat{ }38=10\hat{ }38 neutrons). The photon theorized at approximately six 10\hat{ }6 or 10\hat{ }9 ct3 states and 10\hat{ }−10 neutrons (ct4 states) is the source candidate for this force.

While more tortured, the electromagnetic force can fit within the model.

The short answer is that what is called the EM force is a hybrid lie the weak force but at 10\hat{ }36 is has to be a ct4-5 hybrid.

The separation of the proton and electron is the measure that leads to the 10\hat{ }36 which can be viewed as just below the strong force neutron element because P&E connection is a slightly open neutron. This suggests that the “charge” aspect should be considerably less because it is a T6-t12 effect.

### Periodic Table and the Neutron Table

There are multiple versions of the periodic table. The most important version for AuT is the compression PT which at first glance might be the neutron PT, but is more, flipping the isotope concept on its head while recognizing the importance of electromagnetic effects as consequential.

The Neutron Periodic Table (NPT) reflects pairing for balance and the transition between base 5 and base 8 system. While the appearance of base 4 below seems possible, the protons make it a base 8 system with protons acting as the solar system around each of the neutron as stars.

A strong bias of pairing (in the first 30 neutrons there are 4 odd and 15 paired states. After 30, this bias disappears as does the complete 2, 4, 6, 8 pattern although it can be corrected by multiplying the numbers by ratios reflecting the f-series transition. Skipped are 32, 34, 36, 38, 40; then 44, 46, 56, 62 by way of example, presumably as the electromagnetic force overwhelms effectively the strong force structurally. The number of odd neutron results becomes more equal.

F-series changes via 1, 3, 5 speed of rotation tied to f-series changing dimensional target.

The early atomic compression states have a higher level of purity in the sense that the dispersal of information is not so great. Li-7, the “pure version) has 4 paired and therefore stable neutrons. The reactant for fusion is the isotope Li-6 which is, in the NPC (neutron periodic table) a hybrid of Helium and Lithium.

The foundational nature of the neutron is shown because at no point are there more protons than neutrons in the periodic table. Compare Hydrogen which is not a ct-4 state. There does appear to be a cross between base 8 and base 6 stabilization in the periodic table.

Rather than deal with a necessarily confused Proton periodic table; the designations ct5t1s1-16 is a better model with otherwise “isotopic” elements being intermediary ct5T2 neutron states. Since ct5t2 would go through 256 total neutrons, there is a breakdown of sorts in compression observed. Moreover, stability, as with Li6H is often tied to a molecular arrangement with protons because of the limited sharing of spew, no one high compression state spewing just one lower state, except perhaps ct2 or the first transitional state between ct1 and ct2 spewing ct1.

Absorption and spew as early as Lithium (Deuterium also, really) is balanced by Protons and other force results of absorption and spew because the distances involved allow stability to be offset. One can think of unbalanced barbells. Where the imbalance is not great, some stability exists even where the weights are evenly spaced.

In this case, the spacing is far from even requiring stability through lesser forces. Using Archimedean principles makes sense because balanced spirals are observed. Hence you can take Li6H (more correctly ct4t1s3) and it looks like an imbalanced Hydrogen core with a hydrogen farther out, providing balance via absorption and spew in a narrow range of distance to give stability.

Ionic forms take this model of a balancing range to an extreme.

### Orbits and Electron Energies

Chemical reacting using fractal design to maximize and predict results increases the efficiency.

In terms of reactions, the sharing of the outermost compression states, the lowest order dimensional compression states precede the higher state compression and that the transition between molecular and nuclear reactions involves removing lower states between the higher compression states.

The change in the number of photons not only changes mass but the center of gravity of the electron forming the higher state of energy. Instead of the electron moving, the entire spiral shape of the fractal is shifted outward. The photon “energy” is preserved because the photon is attached to the chain of information forming the electron just as the electron is loosely connected to the protons by absorption and spew. The fractal nature of the resulting math adding T6 or T6 composite photons ensures that the energy states will tend towards set jumps in energy (jumps in mostly pre-time Ct4t6) which are in the standard model attributed to spin and orbital energies, orbital energies being the equivalent of fractal stable increases in size.

Instead of the electron moving, the entire spiral shape of the fractal is shifted outward. The photon “energy” is preserved because the photon is literally attached to the chain of information forming the electron.

From the model we understand relative wavelength:

10\hat{ }10 m=electron “wavelength” which is the size of an atom which reflects the fractal shell of ct4t12 states around line of rotation.

10\hat{ }36 m=molecule size wavelength which reflects the rotation of the molecule about a large line of rotation for the entire atom being rotated within a molecular framework.

Wavelength is a function of the “size” from the ct4-5 centerline (COC) to the orbital average length around a line of rotation 51.

One can look at this specifically using ct1 states.

There are 4.3×10\hat{ }8 ct1 states per pre-photon.

There are 4.3×10\hat{ }14 ct1 states per photon. The 0.4 of the 5.4 electrons is, according to polynomial approximation mostly T12 states but fractal stability suggests a large amount of photonic T-6 states.

There are 5*4.3×10\hat{ }20 ct1 states per electron (we have mass to allow us to estimate this).

There are 4.3×10\hat{ }24 ct1 states per neutron and approximately the same per proton.

Finally there are around (16)*4.3×10\hat{ }24 ct1 states for a minimal type of molecule having a wave form.

This allows us to have a quantity solution as well as separation solution.

10\hat{ }10 is to 2×10\hat{ }21 as 10\hat{ }24 is to 6.9×10\hat{ }24

The electron is 5.4×10\hat{ }12 ct3 states and the analysis above uses pure spatial quantities to get a density per cubic area defined by the diameter of 10\hat{ }−10 m although the sphere is flattened to a disk shape.

### The Spew Table:

The fusion process disclosed herein includes a neutron rich environment with sufficient proton and electron shells prepared to stabilize the neutrons in pairs.

Conformity of spew and absorption sharing is enhanced by the conformity of the units from which it is built. The potential for overlap of the states from which is it constructed ensure a more stable structure. Increasing the sharing can be encouraged along with the change in structure to enhance the transition from Proton to neutron.

The primary difference between the proton and the neutron is that the neutron has achieved a new geometry, mathematically 2f(n)\hat{ }2\hat{ }n for n=4. It is closed to the next lower ct4 states, where the proton is partially open, at least enough to spew whatever is shared with the electron (t12). The last of the ct4t15 stable base 3 states is partially open in the proton but has closed in the neutron.

Instead of sharing the larger intermediary states, the neutron more fundamentally absorbs ct1-3 and spews a ct state which is a pre-plasma form, perhaps uncharged ct3. The plasma spew from a black hole suggests that the neutron spew would have high energy features and the earths electromagnetic shield indicates that the spew of the neutrons is electro-mag (ct4t9/6) but plasma spew might come from the surrounding, collapsing higher states. Charge indicates that the neutron and perhaps the black hole (ct4 and ct5) might only absorb and spew lower complete states (ct1-ct3 from the neutron, perhaps ct1-ct4 for the black hole) which might explain the lack of energy features at the ct4 level along with the less energetic states which do not have sufficient compression to appear as charge.

The model suggests Antimatter is merely opposite spew state, the anti-electron spewing what it otherwise absorbs, like an anti-black hole absorbing plasma and spewing ct1 (anti-gravity). This suggests a method of generating results using matter and antimatter to offset one or the other absorption qualities to effect pre-time changes.

Tapping spew and absorption as an energy source or related work, dimension change and functionality holds tremendous opportunity at all stages of dimension (ct1-6 plus transitional states) and is already part of the laser beam generation under the AuT model and primitively addressed in the orbital model.

Experimentation will define these parameters and allow for more efficient material manipulation (chemical reaction, for example) and the fractally more stable states are reflected by the specific energies associated with excitation.

Exponent states giving rise to charge can include:

### A. Coulomb's Law

Magnetism is a stream of pre-photons classically. Pre photons can be as ct4t states below the level of ct4t9. Ct4t9 is the theoretical primary (in terms of information content) compression state of photons. Neutrinos based on weight are suggested to be comprised of ct4t6 states. The idea that photons are made of ct4t9 states and that magnetism is the movement of these individual ct4t9 states is consistent with observations.

Forces between static electrically charged particles (e.g. two protons or electrons). are governed by the Coulomb's law.

### B. Electromagnetism

Electromagnetism is a T12 or lower movement outside of a compression, giving a dimensionally complex momentum basis to the creation of a magnetic field using a current and a coiling a wire to create over changes of x a moving outer shell of the transitional states 160 which are interpreted as magnetism to the extent their pre-time features interact with post time dimensional features under the AuT definition of pre and post time features.

Electric charge of the photon is typically given as 1×10-35 e (between 10\hat{ }−32e and 10\hat{ }-46e); but this is probably due to the lack of actual charge features. Backing into the relationship, the effect of the electron on the proton is a one to one effect just as the electron is a 1 to 1 effect relative to the proton despite the different makeup in terms of dimension, compression and balance. This is the 1 to 1 effect of the cloud of a galaxy to the black hole core or the proton-electron cloud about the neutron backbone.

The proton has the same essential information content, although not the organization of the neutron.

The scale of difference between 10\hat{ }12 and 10\hat{ }16 is 10\hat{ }−4 which is close. The scale differences between the common components is different. The “component” of the proton is the ct4t15 state and the scale of 10\hat{ }12 to 10\hat{ }15 is 10\hat{ }−3. The sharing is of T6 composite states.

The suggestion is bolstered by the “momentum” and charge associated with the fundamental feature (photon) which is based on Planck's constant 6.626×10-34 J·s or 4.135×10-15 eV-s.

In quantum mechanics, the force per photon is hk, where h=h/2π is the reduced Plank's constant and k=2π/λ, is the wavevector, the Mass being 1×10-18 eV/c2.

Comparative force is typically in electron volts and the 10\hat{ }−15 eV-s corresponds well with the scale of the electron in terms of its effect on the proton and the 10\hat{ }16 range of relative force at the ct3-ct4 interface where the photon exists.

Electro-magnetism is “measured” as opposed to how it exists in a quantum state free of ct5 effects are different features.

In AuT folding, one result is that the electron is “larger” than the proton even though the proton has more mass because of the increase in compression from t-6 to t-16. For the same reason, the t16 proton is larger than the ct4(16) neutron. A core of multiple black holes with 16\hat{ }32 neutrons worth of information appears smaller than the surrounding galaxy even though the galactic cloud appears to have more information, it does not.

Fusion, Energy Generation

There are several different reactions that are called fusion, specific examples are given below: 1) where a proton collapses into a neutron. This is referred to as pre-atomic fusion since ct4 transitional state to t4 neutron fusion results, a ct3-4 reaction; 2) where neutrons are stabilized within a shell which has two basic types. 2a) taking one unstable neutron (e.g. from deuterium or tritium and combining it with a collapsing proton; which is a ct3-4 reaction followed by a ct4-5 reaction; 2(b) where two unstable neutrons are brought together. This is a ct4-5 type reaction with heavy aspects of ct3 (and other lower ct state) stabilization.

There is no “jump” between ct3 and the neutron. Between 10\hat{ }13 and 10\hat{ }12 ct3 states you have the electron, at 10\hat{ }14 you're basically looking at the Muon and you have structures like the photon (most likely between 10\hat{ }9 and 10\hat{ }10). Photons are more pretime than not and everything below 10\hat{ }9 is more like space than anything else although it contains things like the magnetic effect in particle form.

As the compression increases from 10\hat{ }1ct3 states to 10\hat{ }16ct3 states you get more and more time features. As you decompress in the other direction you see things “changing” and therefore moving faster. Around 10\hat{ }9, of course, everything appears to be moving at the speed of light. Keep in mind that ct3 and lower compression states have no time reference and so they can move at multiples to the speed of light and at ct1 there are no thermodynamics as we know them.

The “hidden variables” are ct1-3, hidden by our reliance on time. The potential is to tap energy at its source as opposed to monkeying around with post time features.

The broad process is controlling energy by the tightening and loosening of the higher fractal form.

Fusion can be described as (1) expansion of outer, lower information states, (2) bringing in equivalent Ct4 information states enough to create a stable core, (3) surrounding the core with a stable mix of the expanded lower compression states, (4) this last step involves many different features that can be summarized as providing rotational stability.

### Types of Fusion

For different reactions, different results are targeted. To make fusion you need to get neutrons to share spew. This can involve pushing them together, it can also involve destabilizing the neutrons involved, opening them like the protons and electron shells, to get a easier to control absorption and spew.

These reactions are both different than the oversimplifications in the standard model:

| Reaction | Energy Particles (pre-aut | | |
|---|---|---|---|
| H2 to N (ct3-ct4) | 1.44 | MEV | Positron, electron |
| H + D to He(ion3) (ct3-ct5) | 5.49 | MeV | Gamma rays |
| He(i3) + He(i3) to He(i4) plus 2H (ct5) | 12.86 | MeV | Light spectrum |

(1) Pre-Atomic Fusion: The P to N (H2 to N) is a ct3 to ct4 transition. In the H2 to N2 you have a helium forming, but there is less free information to start with. The process is to fill the last information arms of the proton and close the outer shell to higher “proton” ct state exchanges in favour of the lower ct states of the neutron exchange; to change the dimensional structure to a base 5/10 structure from a 3/6 structure. It is possible to create an environment of neutron short materials, those requiring more neutrons for stability to enhance fusion by providing a location for stabilizing loose neutrons.

Hydrogen has three isotopes, an irrelevant concept in AuT. Only the dominant one containing one electron and one proton and is totally different from the other two since it is a ct3-4 transition state and the others are a combination of ct3-4 transition states and ct4 states. H-E is so stable that it requires more than 20 million degrees F. to break it apart as plasma. However, separating the Proton and Electron are not over significant since the reaction sought is a dimensional change and not a destructive change. There is also a dimensional shift between ct1 and the proton going from 6 sided to 10 sided, from a base 3 to a base 5.

Dimensionally, the ct4 neutron is smaller, without much more information (relatively speaking) than the proton because it folds into another dimension and this change releases vast quantities of lower ct states otherwise a part of the proton cloud reflected by electron bundle 99 which is required for the stabilization of the proton and hence requires the extreme energy necessary to tear apart what is a stable ct3-4 transitional fractal into 2 less stable fractals.

(2) Hybrid Fusion: H+N to HN produces an unstable result which using the AuT model can be used to generate a continuous reaction of compression followed by decompression; the utility of such a reaction is limited.

(3) Atomic Fusion: The simplest form is Free N plus Free N to He. The most common source the free neutrons is unstable Li6. No matter how complex the atom, you have to build a backbone of Neutrons by bringing the two exposed neutron cores together, in adequate proximity to allow them to share dimensionally equivalent or dimensionally balancing spew can involve ensuring a spew/absorption matrix conducive to sharing through three layers of space (ct1-ct3) and through transitional states and balance the backbone structure with ct4t16 and ct4t12 clouds sharing providing balance and stability.

The concept of spew sharing suggests that the extra information lost as energy in the fusion reaction occurs as the two neutrons pull together squeezing the protons out of the way and freeing up other sources of information required to hold the atoms together without the neutron core.

(4) ct5t1 type reaction: if there are less than 16 neutrons in the resulting atom it is primarily a ct5t1 reaction, otherwise it is a ct5t2 type reaction.

(5) Fission can be viewed as the opposite, although almost all Fission reactions in energy generation begin with ct5t2 destabilization to other ct5t2 states with possible ct5t1 reactants being a part of the lower resulting states.

The “energy” generated is the release of lower ct4 transitional states, many being below the t12-t13 electron state whose pre-time features are reflected as heat and light and the creation of lower ct4 transitional states from decompressing ct4.

### Method: Fusion-Reactants

This process is preparing reactants in terms of (1) their order, and 2) compression state features (a) fuse length; (b) compressive direction (towards or away); (c) fractal state (dimensional state) components to create a reactive environment. This involves absorption, spew only to the extent already included in terms of compressive direction for the reagents in the order necessary to get the result desired. The process is targeting the dimensional features as suggested by AuT to manipulate these two broad features and their sub-features.

The design features (effectors) comprise: (1) timing (e.g. timing a step as 1:2:3 to get a spiral effect, order and types of generated reactants) (2) Quantum amount (e.g. to get a quantum change effect) (3) quantum size; (4) relative intensity; (5) shape to match the fractal desired at the current stage or next stage of the reaction (actual/virtual chambers AND reactants), (6) spiral (f-series) variation through movement of the reactants; (7) the number, (8) pressure (concentration of different ct states and amount of fuse change) (9) scale and (10) effective if not actual shape/dimensional container and effect of steps consistent with this type of modeling of fractal transitions; (11) rotation, velocity, (stability/instability) and (12) absorption and spew targeted to balance the resulting reactants for the purpose of fractal transitions are all experimental variables consistent with the model.

If everything is dimensional change, everything is the same, but some separation is required for practicality.

### Effectors 1—Order: Ways to Accomplish Fibonacci Change:

Order varies depending on the result, but order is an issue for all reactions, so Fusion order will be explained, and it can be extrapolated using fractal modelling to get any larger or smaller reaction whether molecular or pre-time.

Sequencing order for fusion is (1) separating the reactants (e.g. electrons, protons and neutrons); (2) Preparing the reactants to interact (e.g. opening electrons and protons; bringing neutrons in sufficient concentration and energy levels to interact; (3) bringing the reactants together; (4) and stabilizing the desired structures.

Order is (a) Planning (design) reactants, b) ordering reactants c) Assemble reactants in the order to be used. It is also controlling the time of reactions, the means of controlling the time of transitions between steps, the number of transitions in any steps, Fibonacci staging especially to the extent each of these features can be brought to bear at the pre-atomic level.

The Manipulation of reactants is an effect of assembling them along a reaction line. There may be multiple steps:

Fusion step 1: a) Assemble free neutrons b) manipulate the matrix to bring them close enough, so they share information to get Helium minus (two neutrons without a stabilizing shell). Step 2: a) Assemble stabilizing Proton shells, b) Manipulation is the method that leads to inserting the shells around the neutrons such as a focus on the shifting center of charge of the electron and the absorption and spew.

The invention is a method of manipulating dimensional features. Planning means treating all features, including compression state, energy, force, and time, as dimension changes between ct states. This primarily involves solving for all final and intermediary features of at least two fractal states derived from at least two iterated equations, figuring out how to create them and ordering them.

Stable neutron backbones need a shell of protons (2 neutrons need two protons in helium) to have enough exchangeable and balancing information to remain stable just as the two protons needed the complete shell of electrons and so on as things get smaller. The key to a fusion reaction of this type (one where you are not making neutrons, but merely building helium from existing neutrons) requires you get everything close enough in the right order for it to stabilize and that the shape of the compounds corresponds to the required rotational symmetry with stabilizing clouds for greater rotational stability or cushioned rotational stability, providing the necessary absorption and spew to allow the fusion to take hold.

A. A trigger for the reaction could be a plasma stream or a radioactive source delivering neutrons as a reactant. In fusion, maintaining all the reactants as a plasma is contraindicated. Manipulating the reactants would be complicated by such a process. The plasma portion of the reaction can be carried out by introducing the reactants from the mixing chamber to one or more reaction chambers designed to give fractal structure to the different compression states surrounding the finished fractal, e.g. Helium. Specific Design features to achieve compression stabilization

B. Order includes Removing the fused result, Helium from Hydrogen, high energy elements, maintaining the reactant mix balanced or rebalanced to continue the process.

It is possible to sequentially control chemical reactions including fission and fusion using features from the group defined as 1) Differentiating change and time; 2) controlling time with speed; 3) dimension specific fractal shaping, fractal targeting dimensional extremes, separating ct states, targeting specific transitional states, targeting specific fractal features with (1) dimension, (2) dimensional change, (3) absorption and spew features, (4) the intermediary transitional features between fractals, including dimensional features and the like and its worth a look at traditional views to understand the scope of this.

One way to control the reaction is to run a reactant line from the center outward or inward to encourage the movement of the reaction towards or away from the center as another triggering features is applied to the line. In the preferred embodiment discussed below the reactant line is a wire connected to one end of a plasma generating microwave transformer and the other wire is merely the other end of that microwave transformer.

The invention can include at least one reaction location along a spiral of desired compression and including sending ct states of effective compression in groups or individually sequentially, or in groups where they can react. It can also include the process of taking the resulting matrix and reacting the matrix with another matrix.

### Change and Time:

Change includes pretime and post time change of reactants; the ratio of fuse-based charge of reactants. Sustaining the reaction movement and the like based on time is secondary but basing it on change is primary. Where the reaction time is too short to use multiple chambers, a single second has 10\hat{ }44 quantum changes, a continuous reaction may be used to minimize time. Maintaining transitions allowing interaction can be important, allowing subsequent steps to be taken. The process taught is to speed up the process by converting multiple chambers into sequentially reacting layers (of pellets) which can be fed from a central source of pellets to make for a continuous reaction. The use of the word time must ultimately be replaced with quantum change to maximize the ability to manipulate a matrix. When a proton changes to a neutron, there is a reduction of pre-time states collapsing into post-time states meaning that there is a reduction of energy. There are two ways to eliminate time, one is to squeeze out lower ct states, an effect of gravity leading to gravitational time dilation. The other way is to accelerate towards a pre-time state. The Helium fusion from Hydrogen of the sun, happening in a very energy rich (pre-time) environment along with gravitational features so the states compete between pre-time and post-time tendencies to encourage eliminating low compression features and then bringing high compression features together and one may copy this with intense gravitational acceleration, targeting substitution of the lower ct states with more compressed, more post time ct states, effectively the time of the system must be changed in multiple directions.

Manipulating Time with Speed:

F-series changes may be obtained via 1, 3, 5 speed of rotation tied to fs of changing dimensional target; balancing quantities and features of the reaction to mimic the resulting states desired.

### Fractal Fuse State (i) of Reactant

This model explains how to change the matrix of any group of ct states, to create a stream of different types of vacuum, to excite neutrons to allow them to exhibit charge characteristics without destroying them to change the atomic matrix so it can be manipulated. Fuse length can be targeted as potential vs. actual energy over a value of x for a matrix.

Antimatter reflects opposite fuse direction for a matrix. Since space is ct1-3 plus very low ct4 transitional states, anti-matter (ct states with opposite compression profiles) may be used to manipulate information including breaking down ct2-4 or removing it to increase the compression to bring the neutrons together or create the proper sharing mix of absorption and spew states to enhance reactions including fusion.

CT State: Fractal:

This means the specific makeup of the ct states including fuse length. For example treating the proton and electron as different transitional levels of base 3 to base 4 transitions, neutrons as ct4, treating energy as “essentially” pre-time change features of sub-fractals primarily within the ct3-4 transition so you are sorting fuse state means; consolidating fuse states (energizing) means using speed levels, draining off the excess momentum, targeted changes in the informational matrix around the higher compression states. CT states as used herein include transitional ct states, at least those which are stable.

Excited protons are used to add rotational stability around the neutrons especially by way of cooperating absorption and spew with electrons added to further cushion and disperse the rotational energy. The reaction might include fast or slowing or even slow addition to allow stability while maintaining rotational symmetry to allow heat as experimentation dictates.

To create a fusion reaction, ct1, 2 and 3 states are removed from between the neutrons 30 to the extent they are not shared. “space” according the standard model is ct1, ct2 and ct3 along with some lower transitional states of ct4 in AuT. While often referred to as ct1, ct2 and ct3; the lower transitional states of ct4 along with unobservable higher transitional ct states can make up what is called “space” in the prior art.

After desired amounts of ct1, ct2 and ct3 and other aspects of space are modified to allow direct sharing of spew and absorption between two neutrons in ct5t1 fusion and to bring ct4 transitional states together into ct4 base 10 states in ct3-ct4 fusion, it is necessary that a stabilizing shell of protons and electrons be constructed around the combined neutrons in ct5t1 fusion and to bring an additional neutron 4 and a stabilizing shell to create stable neutrons in ct4-5 fusion. The newly stabilized atom allows for the release of enough information from post time states to create the beneficial or destructive “energy” effects.

The various driver means can both insert and remove information sequentially and reinsert information where pulsing is required to mix or compress or decompress the information mix defining the different forms of information within the reaction chamber. One type of information may be used to push another out, such as using energy to push neutrons together and remove pre-time information states between the neutrons, but also the ensure that shared information states between neutrons and stabilizing information states around combined neutrons are present.

Fractal Shaping:

One method of targeting fractals is with shape. The changing structure of the reaction chamber(s) is an important aspect of this invention. surface variation, e.g. graphite surfacing to get a six-sided carbon structure, designed base states and the like can be used to enhance shape effects of the reactants. While much of the preferred embodiment deals with physical structures, the elements can be targeted using virtual chambers built from the elements as long as the structures targeted, and the resulting structures can be manipulated.

Compression (Concentration)/Decompression:

A means (pulsed plasma canons and/or laser pulsing and/or explosives) can: a) push together the neutrons and protons or pull them apart as with plasma so you have separately or together. Electromagnetism may be used to concentrate and order, especially, the protons and electrons can also push apart protons and/or electrons and bring them back together to create a compression pounding effect like a pile driver.

Compression means, isolating means, decompression means are part of this.

These can be to decrease the area to be targeted, increase the neutrons at that level, and to add stabilizing features in an order desirable. Creating negative charge to carve in a path for protons can be followed or combined with by positive charge to add a subsequent shell of electrons and even to provide rotational stability with sequential compression stability of the type required.

Compression and rotational stabilization with sequential compression (neutrons brought into proximity, balancing shells of protons and then electrons) can be enhanced by having the proper plasma energies and plasma holding foam materials and layers of foam so that the shells may be added by layer instead of or in conjunction with electromagnetic addition of information.

Pressure is at least as important and that pressures at the interface of the crust and mantle of the earth are adequate for that purpose. The fusion bomb model suggests that higher pressures and heat/energy compression are required, but there are reasons to opine that this can be dealt with because in any equation under AuT, all elements are the same. The pressure equation can be significantly altered, and this brings into play the potential for using spiral compression along with dimensional variants in pre-time space in place of intense pressure and gravity; using concentrators, such as blast resistant barriers, shaped explosives, high energy ct states (plasma canons and lasers, shaped carriers (water and water in shaped container form) f sides of a virtual chamber (e.g. by effecting a reactant (pellet) from 5 sides to get a base 5 effect.

### Compressive Direction

Moving states apart is typically done by increasing the energy levels by shining radiation, adding charge (inserting ct4t6-ct4t12 range compression, for example) at absorbed wavelengths or particulate amounts to increase operationally the amount of ct1-2 type states or adding heat and these can be moderated as to any of the involved states to maximize the results focusing on the information arms to be destabilized and expanded, sequentially if necessary. The use of compression (pressure) and vacuum can work with this process since that varies lower ct compression information within the reaction chamber Destabilized fractals

To accomplish fusion, it is necessary to manipulate these different states to destabilize and re-stabilize them and manipulate proximity.

### Disrupting and Recombining:

Disrupting and recombining ct shells provides an environment where sequential Ct states of varying compression can be prepared and put into proximity with the correct balance in the correct environment and order to combine and stabilize, bringing neutrons together and building a stabilizing shell for example. Plasma generating microwave transformer or other plasma generators may be used. A more intact proton shell, perhaps expanded with lower information states or destabilized to the same effect by limiting spew, provides room for the neutrons to be contained and is more reactive. Stabilizing the shell and the resulting fractals is also indicated. Having items within the flow but outside of the plasma require cooling since few large fractal composites (fractals within fractals) can withstand the heat of the plasma since energy requires a breakdown of CT state. You can lower the heat required by the reaction by treating the reactants and making them more prone to fusion in the absence of plasma, by carrying on the reaction adjacent to the plasma yielding open components, or by allowing the plasma to cool as the sequencing occurs. Inserting excited photons (photons with short fuses) into a portion of the bundle change the structure.

### Fractal Targeting Focused on Fractal Origin:

This includes reducing or increasing the amount of any ct or transitional state to encourage the reaction of the elements.

Since gravity is ct1 to 2 compression, acceleration, explosive or otherwise, directly towards or away from the center of gravity allows this ct1-ct2 fractal to be targeted. Orienting the reaction relative to existing gravity can be used to enhance spiraling together or apart. For the same reason, movement in multiple dimensions (one or more mechanical spin directions) can be used for increasing the number of changing ct1-3 states in the same way that acceleration and gravity affect time and the use of these in varying degrees allows for greater manipulation, e.g. gravity at force 1, rotation in one plane at force 2 and rotation in a second, third, etc plane being force 3. The neutron system is one of absorbing one or more aspect of space and ejecting what is believed to be a higher state, at least on balance. Ct1 is the carrier for all of these and moves effortlessly between ct1 and ct2 generating gravity or anti-gravity in response. Gravity is long-term collapse with a matching system of long-term expansion, but these can be reversed or combined and over time the system within any matrix does reverse itself.

### Fractal Targeting Focused on Dimensional Extremes

(such as those involving pressure and vacuum) have to be imagined in terms of fractal intermediaries and results. The fractals are formed together by sharing (one example being t6) spew from electrons and absorption by the protons matrix and the cycle of information back again binds the proton and electron as well as stabilizing them, the stability of one fractal is tied to the presence of a cooperating fractal and shared information between “complete compressed states,” e.g. neutrons, allows them to stabilize each other. to remove or thin the outer clouds in Hydrogen, remove or thin the outer clouds from a neutron source (heavy hydrogen or heavy water being two likely candidates); place the neutrons within the hydrogen protons or wrap the hydrogen protons around the neutrons; and finally reintroduce stabilizing structure of lower compression states, particularly if not primarily electrons.

The number of chambers and the shape of “dimensional features” may vary to get different effects of fractal manipulation. A larger fractal chamber, such as a five-sided cube might encourage a 5:5 type alignment as the larger fractal encouraged the smaller just as the smaller dense fractals shape the outer orbitals. While the sequence would be subject to experimentation a 5:5 chamber made of walls energy (photonic or wave) or any combination of ct states for ct4 alignment, transforming through moving the reactants or reshaping the chamber to a 6:6 ratio when stabilizing protons were added as a natural progression.

CTB-Layering:

Reactants may be placed in layers. Layering is used to obtain sequential compression and decompression, to get sequential shaped changes, to get sequential fractal, f-series effects (using separation, thickness, concentration, mixed materials, gradually changing versus rapidly changing materials to encourage reaction, separation, absorption and spew and combinations thereof); to get different materials for the fusion process, including plasmas; to hold in heat until compression can be initiated or to stabilize the reactants (and/or) until stabilizing other states can be added (or to add them); to get linear changes along lines of reaction and the like; rotational elements to work with the absorption and spew to increase stability of the resulting fused materials. Durability (through thickness, length, concentration, material, reaction time) of layers is important to mimicking ct state changes, time must be balanced with pre-time changes, a pellet system is the concentration in place of a sequential system where the pellet has all the features of the reaction built into it which can include the shape of the surfaces on which the reaction elements are placed or where plasma reactions occur. The types (qualities) of purities or impurities in any given layer, including the makeup of voids, change the layers, a void being ct state components is subject to more variation and may be used to create implosion (vacuum) of various compression types.

CT State: Balancing:

Just as bringing two galaxies together to form one might require exposing the galactic cores, this process requires controlling the momentum, by balancing the outer less compressed states including the holding matrix or medium at each step must be designed with an eye towards stabilizing or destabilizing absorption and spew. One can “salt” a mixture or matrix with features that will (naturally or upon destabilization) yield stabilizing and destabilizing features. Proximity with orbital stabilizing movement with appropriate stabilizing absorption and spew fractally balanced structures. Neutrons need to be mixed, lured, and/or pounded into proximity so they can enter the stabilizing proton shell without disrupting the stabilizing fractals. “Beams of neutrons” added to expanded ct4 neutron cores and bathing the resulting combination in the type of ct states which would stabilize more compressed cores (more neutrons) or better cores (e.g. Helium from Lithium six, for example); providing the necessary absorption and spew to allow the fusion to take hold. The start is concentrate neutrons, providing an environment with sufficient balancing can be accomplished with heating to plasma, then controlled cooling in an environment to accomplish the stable symmetry with balancing, ct disrupter absorbing states for organizing the matrix resulting with bilateral symmetry corresponding to the resulting fractal structures desired.

Spiraling

Spiraling around an interior of a pellet to encourage spiral effects, effects which spiral reactants, for example neutrons (and/or other lesser compression states) is conducive to balancing in fusion. This is also an aspect of rotation at some or all stages of the reaction including sufficient rotation to achieve pressures against barriers which can be supplemented. Actual spin can be used to create a spiraling means for creating rotational symmetry as well as reducing the amount of time within the system. Spiraled chambers and mimicking spiraling, such as changing dimensions, reaction times, pressures and the like in the same scale as the changing spirals (1, 2, 3, 5; 5, 3, 2, 1 for example) and even the various types of vacuum in the center or other locations of the reaction. Spew and absorption of a given range is the equivalent of the rotational stability sought within a fusing matrix. Swirling at the right rate of change with a matrix encourages an end fractal result.

### CTA-Separation of Different Ct States:

The separation of lower states by the next higher state remains critical. Separation is tied to compression state. If enough ct1 is eliminated between ct4 states, then they would form the next transitional ct4-5 state. This is why electromagnetism approaches the strong force 10\hat{ }36 at close range because it requires this change between the proton and electron to bring them together.

Fission type reactions can be enhanced by separating the neutrons and their proton shells at the proper fractal connections to encourage formation of separate stable isotopes and shaping the reaction to match those resulting shapes can enhance the transition and control or even capture the resulting “radiation” by focusing on the dimensional changes instead of the more difficult time based energy aspects.

Another way is to mix the elements, for example using ionized hydrogen (to give charge) cycled through the neutrons, with cycled electrons and cycled fields (ct3-4 low transition states) to allow near collisions of neutrons to occur in a mix that is stabilizing and encourage stable neutron information sharing

CT State: Fractal Matrix Options; Absorption and Spew:

Absorption and spew control expanding (destabilizing), contracting, change rate (rising or slowing) stable or unstable intermediary states. The tighter the internal sharing of absorption and spew the harder and stronger the bond, so bonds can be controlled (made more or less reactive) by organization of the absorption and spew in the structure. This is manipulating exterior information along the fractal matrix and stabilizing the core with required sharing including fuse state with states external to the core (e.g. a neutron). Vacuum under the model is manipulatable as more than space, it is ct1 and ct2 as gravity and anti-gravity. It is ct2 and ct3 as denser form of velocity and a transition of pre-dimensional and pre-time states from those with dimension and time. It is ct3 and transitional states of ct4 as energy and time and vacuum energy and so much more. All of these are absorbed and spewed from the larger states, except to the extent that spew is limited by particulate size, too dense to be absorbed.

Using Manipulation

Manipulation is not all about change. For quantum computing change and time can be treated as results of the application of two fractal equations for a use from the group selected from, comparing, computing, and, targeting relationship between ct states for predictive purposes.

Manipulation is broadly considered, and can come from the idea of targeting fractal relationship in the reaction or fundamental change of the universe, to predict the future or prepare future results, which term targeting is a way to include the group comprising: (1) treating energy as information change between pre-time and post time effects especially at different dimensional or base number system levels including moving at least one pretime state relative to at least one post-time state so the “energy of the system” is controlled; (2) manipulating alternatively trapped states, transitional states, hinge states and compression states to effect dimensional changes; (3) treating space as non-dimensional and black holes as 4 dimensional states as described herein and the intervening states as dimensional compression states between the black hole state and the non-dimensional ct1 state; (4) treating dimensional/base number features as fractals defined by the fractal iterated equations giving rise to the dimensional states; (5) comparing one or more fractals, (6) targeting relationships between the two fractals; (7) targeting fractal changes for the group comprised of energy generation, quantum computing, transportation, material manipulation or a combination of those; (8) changing information states (ct states) by changing a feature, especially absorption, spew, compression, decompression states, time and pre-time states of at least one fractal component ct state (including transitional states in almost all cases); (9) compressing states and decompressing states; (10) creating a regional change using one or the other of two opposite states to change the other; (11) changing regional concentration of one of two opposite states; (12) changing opposite states so that desired features are maximized in a resulting regional matrix; (13) stabilizing or destabilizing dimensional states by adding or removing lower ct states from a higher compression (virtual) information arm; (14) viewing changes over x and comparing those to a view of changes over time of information arm loading; (15) affecting one ct state to change another ct state; (16) treating wavelengths as the expression of pre-time quantum dimensional change and using tail trimming and compression to more directly affect features; (17) balancing time and non-time elements for maximum efficiency, for energy generation transmission, chemical or electrical reactions, (18) manipulating Quantum change in pre-time ct states; (19) manipulating the interface of curvature and fractals; (20) recording pre-time quantum errors using a post-time frame, especially for quantum computing; (21) identifying errors introduced from lower ct states, especially for quantum computing; (22) identifying point of transition from net compression to net decompression for a ct state; and transitioning between the two adding or removing lower ct states transitioning at a different level, especially for quantum computing; (23) filling, breaking or emptying fractals within fractals; (24) sharing at least one outer compression state of each of two regional states to react the two regional states; (25) treating electrical energy as net spew of AuT information from the electron to the proton in terms of pre-time absorption and spew of at least one specific transitional states, (26) using dimensional changes including at least one feature from the group comprised of: charge, fuse length of one or more ct states, compression, decompression, hinge and trapped states to create and manipulate energy, matter and other dimensional features; (27) averaging ct state features to get results; (28) removing compressed states anchoring non-compressed states (29) removing less-compressed states stabilizing more compressed states to create dimensional changes; (30) manipulating features as non-3-dimensional features using gradations of compression in place of dimensions; (31) manipulating dimensional features as a single entangled strand of ct states; (32) treating force and time as effects of an underlying dimensional change; (33) treating dimensions as different base states where ct and base states equal both complete and transitional ct states; (34) changing selectively base state features as odd and even exponential features; (35) changing a fractal, dimension, ct state feature, component, for a region defined by fractal stabilizing features, (36) using at least one coexisting ct state to effect opposite ct states, (37) defining energy in terms of pre-time changes in a region; (38) creating velocity from the folding and unfolding of ct states; (39) creating velocity comprising the steps of: Identifying a first mass comprised of at least one ct3-ct4 transition state and a second mass comprised of at least one first intervening ct state and a least one second ct state where intervening refers to the folded order of location between the two states; converting the intervening at least one ct state, folding within another lower or higher ct state; (40) storing energy based on pre-time and post time features of the material involved; (41) maximizing dimensional efficiencies comprising the steps of: minimizing transitional vibrational features conflicting with the desired transitions; (42) maximizing results based on AuT features of the affected dimensional states; (43) utilizing elements of time independent change; folding or unfolding; location of folding and unfolding; or combinations of those; (44) creating charge changes, rate of charge change or other ct state movement changes comprising the step of controlling the distance between at least two different matrix based on the AuT features of the separating matrix; (45) preventing intervening lower ct states from crossing into folds between the differentiated states; (46) generating either a winding or unwinding of space to get fusion or fission or to enhance those reactions in an order consistent with the reactions as defined herein; (47) compressing space or releasing the trapped non-dimensional space to manipulate gravity; (48) manipulating at least one of the ct1, 2, 3, 4 or 5 forces; compressing or decompressing wave energy into mass; manipulating entropy for the system in question; tearing apart compressed space; (49) generating energy from selectively targeting compression or hinge states; (50) generating energy storage around force being dimensional changes; (51) separating states by affecting the hinge states in particular to break it up; (52) developing AI (artificial intelligence) or other variable results based on the net, compression or decompression, transitional and compression features inherent in AuT mathematical processes; (53) inserting variation into intellectual development, problem solving and exponentially more complex problem solving by creating random number generation; (54) taking the base model of the staged process for generating results in AuT and applying these features with substitutions or shortcuts in the exact formula for artificially creating the same to improve human intelligence; (55) quantum computing using quantum correction for changes of the various compression states for generating quantum result, (56) correcting quantum results for ct changes within a matrix; (57) providing for the changes based on expected compression or decompression solutions in one or more of the quantum states in question; (58) putting change within a system or matrix using scaled changes in the manner of AuT and adding randomness by periodic changes within the changing sub-matrix and/or count and using the quantum features of compression, hinge, free state and variable limits of the type shown in AuT; (59) treating all increasing dimensions as increasing compression, not expansion despite this being counter-intuitive.

There are other matters where this idea of targeting fractal relationship applies, as with predicting the future or past comprising the steps of (1) determining the arrangement of ct states of a desired range at a given value of x in terms of at least one of the following, spatial position, organization, visible, sound or other spectrum; separating forces from the underlying predestination and averaging expected ct changes that give rise to cause and effect by limiting time to the ct3-4-5 interface discussed below and change which occurs at all levels in the universe including those which are pre-dimensional and comprises results to past solutions for insight. Another is; tapping spew or absorption states for energy; utilizing pre or post time change to deal with dimensional features for desired reactions; controlling absorption and spew states to control compression and decompression of associated dimensional states; treating time only as an effect replaced in all manipulative equations; or controlling time by controlling ct state substitution.

### Method Claims—Combining Features

A method of practicing fusion for proton and electron shells comprising the steps of (1) lifting back the electron and proton outer shells around the neutron cores of two neutrons to be fused, (2) lifting back the electron shells around at least two proton cores; (3) separating at least two protons, (3) bringing the two neutron cores together; (4) inserting the neutron cores between the separated protons to form a new neutron core and (5) closing the proton and electron outer shells around the new neutron core (with the type and amounts of information states necessary to stabilize the new core) according to the fractal model taught herein. The process of exposing or modifying the cores of atomic and molecular matrix can come in several forms: (1) changing; decreasing or increasing the ratio of lower transitional states to neutrons within the matrix, (2) changing the nature of absorption and spew of the different matrix of reactants as by (a) increasing the amount of lower transitional states around them, (b) removing transitional states around them or around one side of them and (c) it is to target the center of charge (abs/spew) or areas offset from the center of charge of any reactant or the different matrix or sub-matrix within the reaction to (a) lift back the outer shells or (b) close back the outer shells around the more compressed cores within the matrix, so that the additional steps can be carried out.

The method is a method of setting up or obtaining hot fusion without excess energy, targeting the fractal features of the reaction. In observed fusion, extreme pressure is used, typically from high gravity or from the ignition of a fission bomb. While the effects must be similar, a fractal approach means at the quantum level, no energy exists and gravity is isolated as folding at the ct1-ct2 level so that by design the fractal features of intense pressure can be established without radical effects.

### Fission

Fission is more than just the opposite of Fusion. It is possible to slowdown reactor container degradation by applying the concepts of AuT to reduce the energy of the gamma and alpha wave states, which are likely ct4t6 and ct3 states with a lot of pretime change which can be stripped off as energy, using the catalyst type method as a constituent part of the reactants woven into the reactants, surrounding the reactants or in any method of composite chemistry or as a part of the shielding, even as a part of rod system, as by having alternating rods for separating the pre-time states and transferring the resulting energy where it can be used to supplement the work or the reactor or for disposal.

### Material Manipulation—Chemistry

The neutron backbone model allows for the creation of larger, more balanced, less balanced, more reactive end(s) molecules. Fusion and fission involve tapping the strong force at the folding and unfolding of ct4-ct5 transitional states, but the combination of ct4 and ct5 states is chemistry.

An example of material manipulation would be to slow the degradation of the containment vessels in fission reactors by targeting the fractal features of the reaction and reactor core. Targeting reactions based on AuT features will improve reactions, energy generation the movement of resulting fractals. State changes, typically called chemical reaction, fission and fusion is shown with these general steps: (i) determining the reactants to be used; (ii) changing the ct state structure by adding or removing different ct states.

When two hydrogens get together, you don't get a helium which is a Neutron balanced state, although it has two sets of net charge. Hydrogen is not a ct4-ct5 transitional state, it is a ct3-ct4 transitional state.

Tritium which is theorized to be an intermediary with two neutrons associated with one hydrogen is more unbalanced and even in the standard model it is expected to exist only long enough to react with Deuterium to yield one helium plus 3.5 MeV and one “free” neutron plus 14.1 MeV.

In AuT the 17.6 MeV is pre-time information freed from the matrix upon the collapse into the more “time-stable” post time neutron form, the information “squeezed out” of the fusion reaction.

There are features of this reaction such as rotational symmetry, absorption, and spew environment, which can be targeted.

Lithium 6, 7 is an early example of a “true” ct5-6 transition state with a stabilized extra neutron being more stable, perhaps because of pairing, than the less stable 3 neutron version of Lithium 6.

When looking at a fusion reactant, it is important to note that the less stable version is more likely to provide unpaired, free neutrons for the reaction to helium.

The same is true of Deuterium. Beryllium and Nitrogen might also be sources of unbalanced neutrons. A new view of the periodic table is necessary.

### Quantum Computing

The method of creating Qubits by treating time as bubbles of information as partially durable partially changing dimensional arrangements of compression states; using at least one tie of lower state strands of information between at least two higher states to create information transfers; tracing a matrix of ct states, such as a photon in its pre or post time positions; using a net valuation but, a pre-time calculation of results; the location of a matrix of states as they move along a line, they move back and forth, tracking compression or decompression; positive and negative net results, or folded or unfolded results. Tracing a matrix of ct states back and forth between two higher state particles; computing using at least one of the 3 iterated functions defining the compression of qubits; using the different ways of folding alignment, linear solution order alignment or other lines of quantum entanglement and tracing vibrational changes for the chains of lower ct states connecting higher ct states together. It may also include using one or more of the elements making up a ct state or transitional state such as one or more of the 5 t12 elements making up an electron; cutting out shorter transitional elements that might more quickly shift the charge or including those shifting more quickly for the purpose of manipulating or computing; increasing or decreasing the lower ct features being manipulated as by using more of the lower ct features in elements of quantum change which have less time involvement to increase or decrease relative speed from a time based perspective; minimizing or increasing lower ct changes to minimize or maximize errors resulting from pre-time polarity change.

Polarity can take many forms, the base positive or negative of a single ct1 state, towards or away from compression or charge depending on the state of compression involved.

The photon as a concept can be ct12, reflecting its ability to be added and raise the energy of an electron, a ct4 which is small enough and ct6 which appears more like a different, neutrino state; but these pre-electron elements are worth considering for the relative significance.

The use of faster than light communication between particles which share folded information states provides a potential carrier for faster than light communication between tied particles, including the t12 states making up electrons, primarily the lower states making up t12 states.

Moving states apart is done at certain levels with plasma; but the invention envisions more precise pre and post time changes (energy levels vs. matter, inserting ct4t6-ct4t12 range compression states with specific compression and decompression features, for example) at different stages within the reaction and for different purposes, some destabilizing and other stabilizing, some changing dimensions and some doing both.

In the compression model it might make sense to begin explosive compression before plasma and the plasma may attend the shape by the number and their arrangement or the shape of the exterior or interior openings or other means to generate the dimensional decompression and compression states required.

The dimensional change can mimic the F-series changes desired as well as the other fractal modifying features from the lists in this disclosure.

These processes can be moderated as to any of the involved states to maximize the results at each stage of the process within a reactor or a virtual chambers shaped to encourage the end result desired by creating shaped or rotational fractal effects to net out a fractal shape for a given part of the reaction.

Centrifugal force and rotational speed can be used to eliminate certain aspects of space and time at various points in the reaction.

It is also suggested to add a stabilizing proton shell and around that the stabilizing electron shell add a rotational averaging effect cushioning the tendency of the stabilized neutrons to spin apart.

This model differs because instead of throwing more energy at a naturally occurring effect, it attempts to encourage and stabilize the effective fractal end product.

We know we can accomplish this with lower energy because: 1) Energy does not exist at the quantum level and 2) compression occurs in nature. The process is setting parameters for it to occur.

We need to look at the space between cores to be reacted at ct-ct3 instead of the broad term vacuum and ct3-4-5 states between to bring the neutrons together or move them apart depending on the desired reaction.

### 2. BRIEF DESCRIPTION OF DRAWINGS

For a further understanding of the nature and objects of the present invention, reference should be made to the following detailed description taken in conjunction with the accompanying drawings in which like parts are given like reference numerals and wherein:

FIG. 1 shows a simple process for obtaining fusion according to this process.

FIG. 2 shows how compression and structure interact, conceptually balanced fractal information building.

FIG. 3 shows an exploded view of a hydrogen fractals.

FIG. 4 shows how FIG. 3 applies to elemental hydrogen.

FIG. 5 shows wave creation in a pretime environment.

FIG. 5a shows the separation of pretime and post-time information from FIG. 5.

FIG. 5b shows a second evolution of FIG. 5a

FIG. 5c shows an alternate evolution of FIG. 5.

FIG. 5d shows a ct4t12 composite electron.

FIG. 5e shows an evolution of FIG. 5d.

FIG. 6 shows compression from ct4t12 as represented by FIG. 5, to the neutron and why charge is not seen at the neutron level.

FIG. 7 shows a concept view of the isolated neutron evolved from FIG. 6.

FIG. 8 shows a concept view of absorption and spew between protons and electrons as a stabilizing shell for neutrons.

FIG. 9 shows an alternate view of FIG. 8 with the inclusion of a neutron shell.

FIG. 9a shows a fractal view of FIG. 9.

FIG. 10 shows the view of FIG. 9 with the neutrons removed as an alternate view of the embodiment in 4.

FIG. 11 shows another alternate view of FIGS. 9 and 9a.

FIG. 12 shows the fusion process from a fractal perspective.

FIG. 12a shows a close up of the first steps of FIG. 12.

FIG. 12b shows a close up of the second steps of FIG. 12.

FIG. 12c shows a close up of fused helium from FIG. 12.

FIG. 13 shows the operation of a catalyst.

FIG. 13a shows the catalyst from FIG. 13 in operation.

FIG. 14 shows a view of a simple molecule, CH4.

FIG. 14a is a view CH4 utilizing the model from FIG. 14.

FIG. 15 shows the relationship between the spiral and fpix.

FIG. 15a shows an alternate view of FIG. 15.

FIG. 16 shows the neutron backbone structure through Argon showing alternate views of Neon and Argon.

FIG. 16a shows the incorporation of protons into Carbon.

FIG. 17 shows the continuing neutron backbone structure for Krypton, Xenon and Radon.

FIG. 18 shows the alternate view of the neutron backbone for neon from FIG. 16.

FIG. 19 shows the alternate view of the backbone for Argon from FIG. 16 with a connecting bridge 478.

FIG. 20 shows the alternate view of the backbone for Krypton.

FIG. 21 shows the alternate view of the backbone for Xenon.

FIG. 22 shows the alternate view of the backbone for Radon.

FIG. 23 shows the alternate view of a backbone for a heavy, balanced atom.

FIG. 24 shows a view of the backbone of Uranium.

FIG. 25 shows the heavier backbones from the Fission of Uranium.

FIG. 26 shows a conceptual view of the excess neutron backbone from FIGS. 24 and 25 including an unstable neutron 4u.

FIG. 27 shows another view of the dimensional transitions between electrons and backbone elements, here helium.

FIGS. 28 and 28a show the reconciliation of electron orbitals to the neutron backbone for simple atoms.

FIG. 29 shows a fractal view of Lithium with protons.

FIG. 30 shows an alternate to FIG. 29 for neon.

FIG. 31 shows a conceptual view of deuterium.

FIG. 32 shows an alternate view of water.

FIG. 33 show the fractal view of the burning of Hydrogen and Oxygen to form water via the outer shells and backbone elements.

FIG. 34 shows fusion of the Lithium atom to yield Helium.

FIG. 35 shows the dimensional shaping of fusion.

FIG. 36 shows a diagram of a minimal embodiment of a pellet for a fusion reactor constructed according to the teachings of this patent.

FIG. 37 shows an alternate pellet design to that in FIG. 36.

FIG. 38 shows a reactor designed to use a pellet of the type taught herein.

FIG. 39 is an alternate view of FIG. 38.

FIG. 40 shows another alternate pellet design.

FIG. 41 shows a modification of the pellet shown in FIG. 40.

FIG. 42 shows another spinning pellet design.

FIG. 43 shows a detail modification of the pellet from FIG. 42.

FIG. 44 shows a modification of the reactor from FIG. 38.

FIG. 45 shows an alternate view of the reaction from FIG. 44.

FIG. 46 shows another alternate pellet design.

FIG. 47 shows another alternate pellet design.

FIG. 48 shows another alternate pellet design.

FIG. 49 shows another alternate pellet design.

FIG. 50 shows another alternate pellet design.

FIG. 51 shows another alternate pellet design.

FIG. 52 shows another alternate pellet design.

FIG. 53 shows another alternate pellet design.

FIG. 54 shows another alternate pellet design.

FIG. 55 shows another alternate pellet design.

FIG. 56 is a chart which shows the solutions for fpix added for the first 32 changes in X.

FIG. 57 shows 5000 points in a chart like FIG. 56.

FIG. 58 shows one method of folding from ct2 to t3.

FIG. 59 shows an alternate folding to FIG. 58 leading to Gaussian curvature.

### DETAILED DESCRIPTION OF THE PREFERRED EXEMPLARY EMBODIMENTS

Current fusion focuses on forcing the reaction with increasing energy. The AuT model infuses fractal math and pre-time dimensional change science in place of energy. There are dozens of adjustable parameters based on the new science set out in the general discussion of the invention. The neutron is viewed as a backbone instead of a proton model with neutron isotopes.

The process of exposing compression cores including collapsed whole cores and partially collapsed transitional cores can be controlled by (1) increasing or (2) decreasing the concentration of lower transitional states around a core which requires a certain absorption and spew for stability.

Atomic Fusion general steps: (a) determining the reactants to be used. Hydrogen and a neutron donor which can be combined. H2 (heavy hydrogen) heavy water (Deuterium or D), Li-6H; (b) changing the ct state structure by adding or removing different ct states or transitional states in order to (c) expose the nucleus protons 67 and (d) encourage the neutrons 30 to close and (e) stabilizing the resulting neutron backbone with protons and electrons.

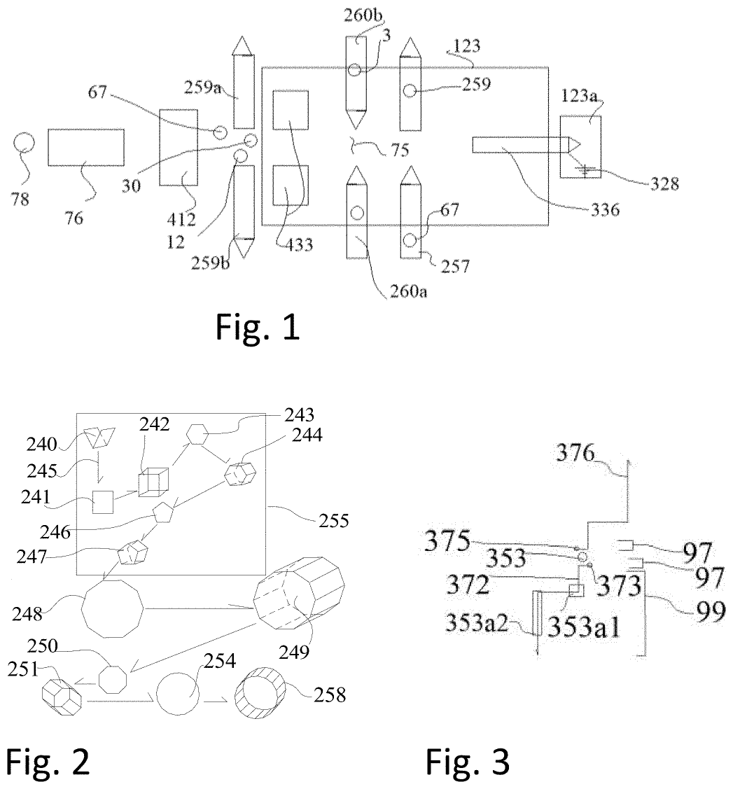

### Process (FIG. 1)

FIG. 1 shows how virtual elements can be organized keeping in mind that the only way to do this is to get past the idea of working only with post time states and get down to the pre-time states. While lasers and explosives can give rise to low order post time compression, targeting specific pre-time and post time fractal ct states and the transitions between those are the only efficient way to work with the fractal universe.

In this case a first reactant 78, typically Li6 is delivered in quantity using first source driver 76 moving through spin inducing plasma pulse canon means 412 for generating a plasma to separate neutrons, protons and electrons; the latter two are then minimized using flow control means 259a to draw out at least some of the protons 67 and flow control means 259b to draw out at least some of the electrons 12. At least one focusing means 433, typically a series of shaped explosives or lasers discussed in figures which follow, is used to drive the more isolated neutrons together in the desired geometry and with the desired rotational symmetries. At this point the neutrons are concentrated in the mixing chamber 75 and particle generators 260a and 260b feed in the appropriate type of at least one type of “absorption and spew,” which can be various types of space (here ct3 state 3 is shown which would be the application of a specific type of vacuum) or very low order ct3-ct4 transitional states in whatever order is required to encourage the neutrons to come begin information sharing between them. The information (here state 3) from 260a and 260b may also be offset, by offsetting items 260a and 260b to encourage rotational symmetries.

Next injector 257 pushing stabilizing features, here protons 67, into the chamber to help stabilize the fusion of the neutrons and perhaps subsequently electrons (not shown) for the same purpose while flow control means 259 takes out such reactants as would destabilize the reaction. Like a catalyst, a current carrying layer 336 may be used to draw out high energy particles which would otherwise be radiation to a secondary power generator 123a here being a current resistor 328 to carry the energy secondary to the primary power generator 123 which is typically a steam powered generator.

FIG. 1 shows setting a simple version, such as a reaction of Li-6 to Helium. Li-6 has three Neutrons which are an unmatched set held in reactive balance by the proton shell of 3 unstable protons. The combination of unstable protons and unstable neutrons achieves a rotational/absorption/spew balance that can be easily modified. The AuT model is not a tritium model but shows a disintegrating Li-6 into He and a free Neutron which, in the presence of a neutron rich environment (e.g. Deuterium), turns into Helium to some extent and dissolves into the underlying components of the atom. The model allows targeting different features, whether energy generation or continuing fusion by targeting the fractal elements.

In the AuT neutron model, the underlying geometry of the reaction reflects the next level of fractal compression/decompression at the ct4-5 level rather than the traditional view of proton stability in the periodic table reflecting a mixture of ct3-4 and ct4-5 compression. While neutrons change the “isotope” in the standard model, in AuT the question is compression of the “neutron backbone” and stabilizing clouds of protons and electrons build on this backbone. The mixed nature of the base numbering systems and resulting compression and geometry are targeted to get more efficient reactions.

For this reason, the instability of Li-6 vs. Li-7 is better understood, and an Li-6 combined with any other odd neutron isotope can be envisioned.

Virtual chambering is a function of shaped (beam streams) and shaped explosive compression (spatial manipulation) as well as plasma (also spatial) decompression.

### Transitions and Time FIG. 2

The key to true chemistry, including efficient fusion and fission manipulation is to focus on intermediary and end fractals including stabilization.

FIG. 2 shows a conceptual view of the transitional steps approximating the math of transitions along with the building of time. Scale of compression is difficult to show, so the focus here is base number pairing (for balanced spirals) and base number shift.

One method inherent in AuT is using the structures and interactions of higher ct states to understand interactions of lower states. Subject to dimensional fractal changes and compression scales, there are similarities between large and small ct state observations, e.g. comparing galaxy collisions to atom collisions. Dimensional shifts and compression shifts allow for the simple base equations to give the observed complex results.

FIG. 2 begins with an incomplete fold 240 of ct1 states. Continued folding 245 leads to a transitional c1-ct2 base 2 square ct2 state 241 which leads to a transitional ct2-ct3 cube state 242. Ignoring the more numerous intermediary states given mathematically herein, ct2 states compress to a six-sided base ct3 state 243 which stabilizes as a six-sided cube ct3-ct4 transitional state 244. Each exemplary transition is shown by an arrow reflecting continued fusion 245.

This same process continues for the ct3-ct4 transition yielding a five-sided ct4 state 246 then a stabilized transitional five-sided cube 247.

This five-sided cube 247 is the rough equivalent of a ct4t16 proton.

The cube 247 collapses into a ten-sided base ct4 state 248 which is the equivalent of a neutron.

These compress to a 10-sided cube 249 of two ct4 states which is the equivalent of Helium.

This 10-sided cube when sufficient ct4 states are present morphs into an 8-sided base state 250 which morphs into an 8 sided cube 251 which continues the process towards a collapse to a 16 sided base ct5 state 254 which in turn collapses to a sixteen-sided cube 258 which is a black hole.

What is not reflected in this dimensional change is compression which grows exponentially with each dimensional change.

Time 255 arises before the neutron state although it is spread out in the dimensional states that make up the neutron and higher ct4-ct5 transitional states.

The pre-time changes at or before cube 244 can be largely thought of as faster moving at the speed of light, although pre-time changes occur faster than the speed of light which is tied structurally through ct3-4 transitions to time. Energy is the effect (kinetic) of these pre-time changes as compression changes to decompression (or decompression to compression), within a matrix. Energy is also (potential) the potential for these pre-time changes on early ct3-4 transition states based on the amount of pre-time elements making up a matrix.

Each step suggests the value of shaped chambers (virtual or otherwise) or shaped reactants in bulk or at the closest possible approach to the atomic level. Individual atoms are difficult to target, but the closer particles get to their pre-time state, the more they can be used to get “virtual” chambers formed by pushing reactants together in a targeted shape and the bigger (more compressed information) the reactant, the more easily targeted from a post-time perspective.

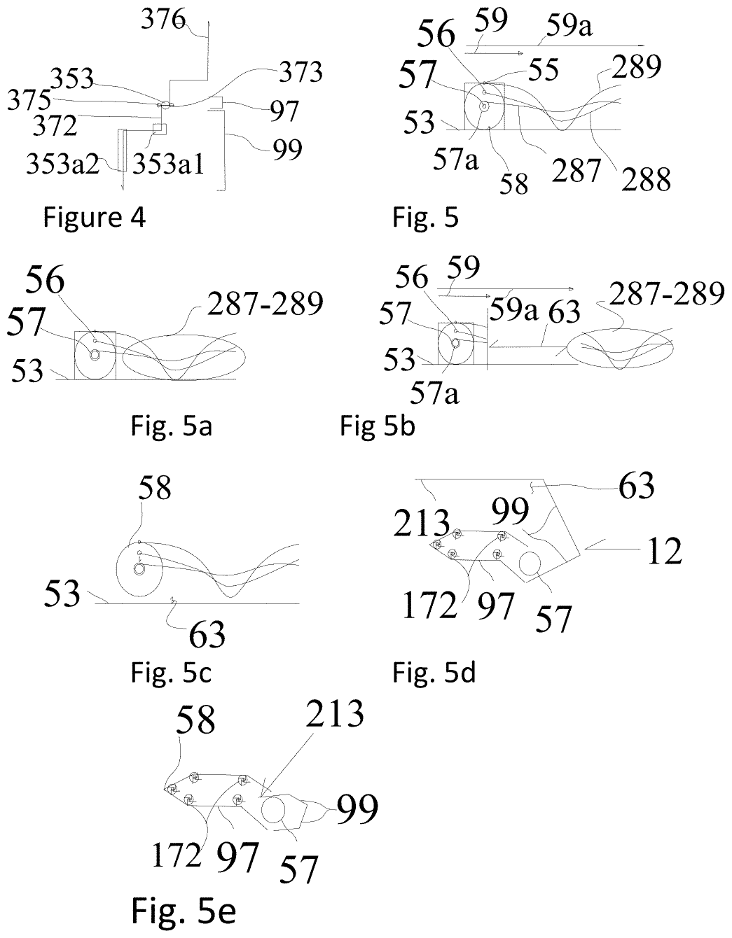

### Balance FIGS. 3 and 4

FIG. 3 uses hydrogen (H2) to show balancing reactants using the combination of fractals pairs with overlapping spirals.

This is an idealized view of the H2 layout and hence bundle 99 and electron shell 97 are shown as they generally would appear mathematically as two protons 375 and 373 approach.

FIG. 4 shows the two protons of H2 from FIG. 3 together as H2. The drawing shows a “perfect” overlap, ½ of the length of the two arms, forms a specific grouping, a central compression circle with two half circles (½ the length of the two arms in diameter) form on either side. While this average appears in nature; perfect overlap is contraindicated in absolute terms and changing exponentials (odd and even) lead to circular arrangements with even exponents and the spiral structures from odd exponents.

Absorption and spew lead to the balancing arms, arms 372 and 376, presumably with increased dispersion of information towards the end farthest from the protons. This balancing required by the sharing of information and reflected as rotational symmetry gives rise to both dimensional perspective as well as molecular and atomic bonding symmetry

FIG. 3 shows the shared information 353 as a stable fractal interface between neutrons. This form of pairing can be viewed as continuing in the direction of compression or decompression of the shared information 353. Shared information 353 can be replaced with a higher ct (neutron backbone) core and its surrounding cloud for the periodic table type compression. Because of dimensional compression, the Helium backbone can fit within this small cloud of shared information 353 defined by the area between protons and their electron clouds.

Fusion reactions occur within the area defined by shared information 353 between proton cores 375 and 373. The proton structure would largely remain intact in Helium with the two neutrons forming a core within the shared information 353; but in larger atoms and molecules, the proton structure would have to adapt to the neutron backbone as described in subsequent figures.

In this case, the representation is of two hydrogens each having a first proton core 373 and second proton core 375 and the shared core 353 along with an electron represented by a first offset spiral 375 and second offset spiral 372 to stabilize each of the protons. There is shared information of the shared core 353 when the two hydrogens are bound representing the overlap of information observed between core 373 and 375. This appears to be rotationally balanced where this symmetry is reflective of the stability of balanced information exchange between the more compressed protons and the less compressed electrons.

The effect of information gradually dispersing along the spiral arms is reflected in momentum reflecting the absorption and spew and resulting rotational pair stability of lower compression states on the higher compression states as they spread out.

The electron shell 97 would be in proximity to the protons and from this shell would extend the bundle 99.

Exciting an electron might take the information shown as second shared information 353a1 and expand and excite it to the information shown as expanded second shared information 353a2. While these would remain parts of bundle 99, they would be pushed out physically along incremental fractal arms. Unless the arms 375 and 372 were balanced, the addition of information would be destabilized the atom and would destabilize the shared information 353.

In a decompression reaction, the shared information breaks up the two reactants.

Expanding the connective locations (shared information) allows for information sharing from outside the matrix to occur more easily. Especially at the neutron level where the system is closed into another dimension, the need to open the folded information between neutrons without breaking them up requires a fractally regulated transition encouraging the desired structural results.

One can see that from a momentum standpoint, momentum reflecting underlying required balancing of symmetries for the shared information to remain in place over many changes of x, the balance shown in the galactic fractal is balanced by the opposing corresponding features although the type of force reflected varies with the compression scale due to exponential compression and base compression features.

A lack of stability in higher compression states reflects an unstable center of gravity at first and second information bundles shown as smaller circles items 373, 375. There is shared information shown as the larger circle item 353 which starts as more dispersed information.

Lower ct states can be used to manipulate items 372, 373, 376, 375, or 353 to open any reactants or to open and close features of catalysts just as the surrounding information matrix structure can be used for the same purpose, whether in solution or part of the reactant or catalyst structure.

### Duality and Hydrogen to Neutron FIG. 5

FIG. 5 shows compression of the wavelengths in line with the longer time frames 59a and shorter time frame 59. Quantum changes in x can be shown using the rotation of wheel 58, for example, to represent the rotation of the ct4T9 state 166 relative to one or more higher ct state (e.g. relative to t4t12).

Depending on the width of the diameter of the representative state 166 relative to a center 57; the diameter of the resting state 57a, middle excited state 56 or a second excited state 55 generates wave forms 297, 288 and 289 respectively as the wheel 58 is rotated relative to the baseline 53 which is a relativistic time frame, meaning dimensional change from the frame of a rotating spiral. All values of the wave form generated in the pre-time environment are viewed together and pre-time elements are energy for that particular feature.

Lines 59 and 59a represent the number of changes in x. There are roughly 3 times as much change in x in line 59a as in line 59. If the same amount of time is involved, much more energy is created by line 59a and more pre-time changes, therefore more curves are present.

Ratios are (1) the number of revolutions per second reducing wavelength and the number of changes in x per second increasing the energy. Pre-time changes occur, generally, but not entirely as pre-ct3 and ct3 changes versus post ct3 changes. The pre-time change and the “energy” of the wave are tied to how much the fundamental elements of the wave are changing in a pre-time case compared to the post time case. Something which is changing a lot pre-time will have a lot more energy and things tend to lose energy and gain energy depending on how the underlying values of fpix for the matrix in question is changing.

Wave particle duality is not duality once time is eliminated as a false flag. Instead it is the change of position between ct3 states relative to ct4 states over changes of x as viewed from the time perspective once time becomes relevant to the changes that occurred outside of the time reference.

One process is to use this model of wave features for efficient use of wave, time, quantum computing and energy features.

Wavelengths vary with mass. Waves begin to collapse at the ct4 level as the compression increases and pre-time changes become less relevant even as the period of rotation stays the same. If one were to fully collapse the wavelength, then the line would be the straight line of base line 53 where no pre-time changes occurred over the time frame of reference.

FIG. 5a shows a simplified version of FIG. 5 where the three waves 287,288 and 289 are shown averaged as oval 287-299. The most likely is stripping.

This allows us to target energy at its most fundamental properties.

FIG. 5b shows the oval 287-299, the historical, pre-time information separated as energy. It may be absorbed by observation collapsing the wave to a point of potential energy. The separation 63 represents the separation of pre-time and post time features of the wave generated by the structure in a pre-time environment.

This separation of pre-time information is how energy is generated from a chemical, fusion or fission or any other exothermic reaction. An endothermic reaction operates by having this type of pre-time information in the oval 287-289 separated where it can be attached to a time dependent state.

FIG. 5c shows a different concept where the entire wheel 58 is separated from the base line 53 so that it doesn't rotate against the next compression level. This would also reduce wave qualities relative to a point of reference represented by the baseline 53 where the separation 63 is between the baseline 53 and the wheel 58 representing the effective circumference from which the wave is measured, typically an average.

FIG. 5d shows how the wheel 58 is created, compression averaging. The wheel in this case represents the separation between the core at electron shell 97 from center 57 and the effective end of rotation at leg 213. Together these define an electron 12 which has both pre-time and post time features evident.

The same effective design would apply to a photon, the example used is an electron 97 because its features are clear. Either would be viewed as an approximately six sided ct3-4 transitional fractal. The electron 12 shown has 5 ct4T12 172 states forming the primary elements of the shell 97 of the transitional fractal. The theory holds that a “ct4t9” photon would have 5 ct4t9 states and a cloud of lower states approximating the 6th ct4t9 as a spiral arm but functionally would be the same except where items 172 would represent ct4t9 states instead of ct4t12 states and the bundle 99 would represent a dispersed ct4t9 state instead of a dispersed ct4t12 state.

There is an opening represented by center 57 in the shell 97 and a bundle 99 of information as a spiral arm extending from the five ct4t12 172 states tapering to the end of the bundle 99 at leg 213. This looks like and is a galactic spiral arm, although with a lower dimensional footprint and exponentially less information, one being the fractal equivalent of the other. The ‘subtle’ difference between the bundle 99 and shell 97 is based on the fractal nature of the shell and the surrounding nature of the bundle 99. The two designations necessarily overlap but can be distinguished by the effect of the t12 states on the surrounding cloud of information which forms shell 97. One alternative to stripping is that observation compresses the pre-time changes, the cloud of information around the photon elements compresses from pre-time versions to post-time states. Accelerating convert time elements to energy by increasing the number with pre-time elements in the accelerated matrix.

FIG. 5e shows how the separation between 57 and 213 can be reduced, reducing the wavelength through collapse of bundle 99 and leg 213.

The photon shown in other drawings is a fractal equivalent, wavelike because of its tail of history. It is particle-like because it is a point for any value of x.

Energy within the wave form shows up as the number of changes in a qubit (photon or electron as examples) which are changing in a pre-time environment because they are within a portion of the 10\hat{ }44/second change window to be picked up as pre-time changes viewed from post-time. When these pre-time changing elements of ct1 are pulled off one electron and attached to a second electron, the first electron loses energy and the second takes it on. While a poor analogy, it is like siphoning gas from one car to another.

While a tail immediately begins to develop, whether collapsed or removed; moving at the speed of light, the photon reaches the screen without a significant tail. If the photons were kept isolated and moved far enough, they should achieve a wavelike form again. The loss of the tail in duality may be a combination of one or more of the following:

The pre-time changes come off as energy, observing absorbs the wave portion of the photon stream (FIGS. 5a and 5b) or it closes the cloud to a more compressed form (FIGS. 5c and 5d), it stops the spinning, or it separates the state being rolled against from the state being rolled or some combination of these.

Another option is that the photon is lifted off the state against which it is spun, it is stopped (practically) from spinning, or some combination.

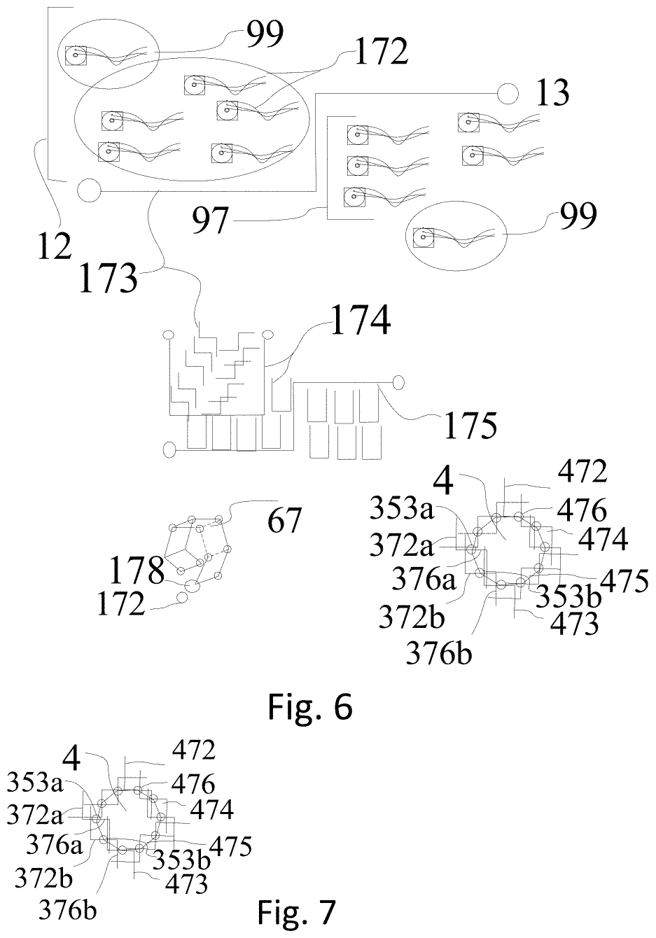

FIGS. 6 and 7—Compression from ct3 to ct4

FIG. 6 shows how the wave/particle state of ct4t12 172 is incorporated into the transitional state that we know as the electron 12. There is an electron shell 97 and surrounding bundle 99 which are base 3 structures in the rough form of six sided spiral arms as shown in FIG. 5 with the bundle 99 being the information incorporated in the full ct4t12 shell with the bundle 99 representing a disbursed ct4t12 in a more cloud-like, more pre-time state.

These electrons are halves of the ct4t13 compression state 173.

The structure of ct4t13 is 12 of ct4t12 and being an odd exponent (10\hat{ }13) is an open spiral state.

Stability appears to be tied to the base 3 state, hence the observed stability of ct4t12 and ct4t15, the respective building blocks of the electron and proton and the stability of the half ct4t13 states of “essentially,” if not completely 6 ct4t12 states 172 in the electron shell 97 observed as 5.4 ct4t12 states.

The structure of ct4t14 174 is twelve ct4t13 states in an even exponent arrangement which is important in the formation of the proton. Twelve of the ct4t14 states make up the even exponent ct4t15 state 175.

The proton is made up of 10 base 15 states, not six or twelve, because it is transitioning to the ct4t10 states as a ct4t16 176. The proton has other features shown as the proton 67 which is shown as a partially closed, “paired 5-sided” shell (FIG. 6) as opposed to the six-sided shell of the electron. There is an unstable ct4t15 spiral cloud 178 which includes the shared ct4t12 states 172 which merges with the surrounding matrix to balance the proton 67 with its electron as shown in FIGS. 3 and 4 as items 372 and 376.

### Atomic Neutron Fusion FIG. 7

There is a larger transition which takes place as the proton 67 collapses into the neutron base 10 state shown in FIG. 7. The information necessary to stabilize the proton 67 is reflected in the unstable ct4t15 spiral cloud 178. Information within the cloud 178 is released upon collapse as the energy of the proton forms neutron fusion.

By targeting the changing geometries and different absorptions and spews which balance the transition, the reaction can be based on quantum features instead of the false energy component.

For a neutron 4 to form, the paired 5-5 Proton folds into a base 10 state. For the reaction to be complete, the neutron must be balanced.

The ct4t15 (10 ct4t15 states less one ct4t12) unit proton to a ct4 state occurs an inflection point between the ct4t15 and next lower stable fractal, the ct4t12 which in turn relies on the next lower fractal all the way down to the ct1 to t2 transitions. When the difference in compression is less than ct4t12 and all the lesser transitions, all the stable states in the proton are ct4t15 states and it collapses into a neutron until the balance changes back.

Since this is a fractal model, this inflection point can be calculated, corrected for compression and base state in either direction.

The folding results in balancing arm 472 overlapping with opposing arm 473. There is also a shared information web 474 between the highly wound arms of the 10-sided structure 475 made up of base 3 stable T15 states as a series of base 10 neutron centers, 3 of the 10 such centers are labelled here as 353a, 353b, 476. This web 474 keeps out charge sharing but allows lower ct states (viewed as space) to enter and exit. Before the final step of folding, arms 472 and 473 would look more like items 372 and 376 of FIGS. 3 and 4. The dimensional collapse creates a fractal, mesh like cloud of information that keeps the neutron from absorbing ct12 material and limits the absorption to lower ct states that don't exhibit charge characteristics; explaining how the neutron holds the atom together and forms a backbone which supports the proton periodic table.

Around second neutron center 353a there is neutron first offset spiral 372a balanced internally to the neutron with neutron second offset spiral 376a. This is repeated for a second center of neutron shared information 353b about which there is a second neutron offset spiral 372b and a second neutron second offset spiral 376b, and so on to form a 10 unit ring forming the collapsed neutron.

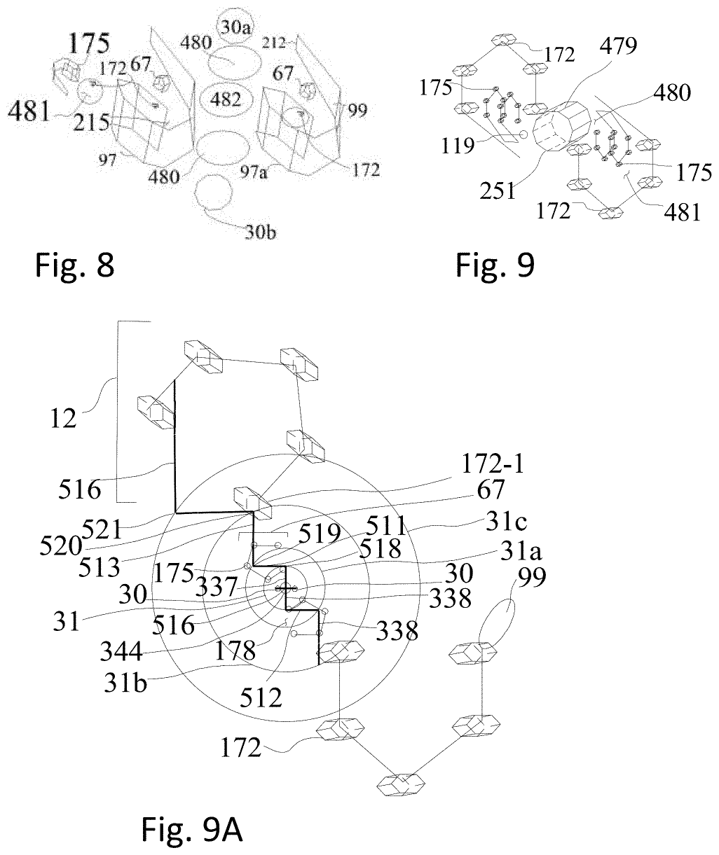

### Molecular Helium Fusion FIG. 8-11

In FIGS. 8 and 9 show different views of a neutron pair in helium, the end game for most fusion reactors. The AuT model allows for a flow with reactants partially fusing so there is a constant process up to a pre-determined point. The neutron pair 30a and 30b can be seen balanced by protons 67 and electrons 97 and 97a.

Referring to FIG. 8 there is absorption and spew balancing between ct4 and ct4t15 480, neutron to proton balancing. There is balancing ct4t12 to ct4t15 481, between the electron and the proton, here shown as the sharing of the t12 states 172 that make up the bulk of the electron.

Finally, there is balancing ct4t15 to ct4t15 482 essentially proton to proton balancing which is offset by t12 repulsion 481.

The proton collapsing into the neutron is one where the resulting neutron has less energy, but more information than the proton because the free pre-time states have been reduced and the information exchanged has less of an energy (ct3-ct4t9-12) component. High pressure (in the earth's core and on the sun) can form Neutrons by squeezing out the lower, more energetic information states. The squeezed-out states exit as space, pre ct4t12 radiation and the like.

FIG. 8 shows conceptually the coexistence of the proton and electron. What is seen here is that the proton has begun to shift from a six-sided ct4t12 structure to a 10-sided ct4t15 structure or a paired 5 sides structure. The proton conceptually is open to an extended cloud of material, which is likely a ct4t12 spew compared to a ct4t12 absorption by the electron.

### FIG. 9

As the neutrons come together as shown in FIG. 9, there is ct4 to t4 balancing 479 between the two neutrons which have thereby combined to make a helium 10-sided cube 251. This could be 8 sided in structure given the transition from base 5/10 to base 8/16 that takes place but considering the collapsed structure of the neutron the 10-sided cute makes more sense at this level of compression.

The flattened neutron can be partially stabilized with shared spew from a single proton although the pairing is not ideal due to the minor structural difference and the skewed form of the electron. For this reason, having a neutron present can “seed” the collapse of the shared proton.

FIG. 9 shows the embodiment of FIG. 8 where the two halves of helium 251 have combined and where balancing Ct4-Ct4 spew and absorption 479 has been added and P to P sharing 482 has shifted to P to N sharing 480. This also shows the sharing between the proton and neutron of a ct3 state 119 which is presumably the largest ct state feature that can move between the two, the absorption of which holds the atom together as the strong force.

FIG. 9a shows how the fractal nature of the math ensures that the energy states will tend towards set jumps from one fractal to the next, not “in energy,” but in terms of pre-time information states CT1-CT3 and lower CTT43 takes the more stable fractal-shells. The standard model attributes spin and orbital energies, orbital energies being the rough equivalent of variously stable fractal CT state increase which involved, for example, an increase in the number of ct4t12 states within an electron cloud.

Heat in the reaction adds and removes photon like elements, t9, perhaps t6, to the structure. “Integer” separated wave lengths (attributed to taking a circle and breaking it into equally separated wave states: 1, 3, 4, etc) are assigned to “circular” orbits separating the perceived circle into equal parts correspond to fractal changes. Hence, the added information shown as, e.g a T12 state to an election, would give an incrementally greater size and therefore a greater wavelength to the atom. This might reflect moving between the different size diameter of the circles shown in FIG. 9a as intersections with the overlapping spirals where 511 is the 3 spiral top, 512 the 3 spiral bottom, 513 the 5 spiral top, 514 the 5 spiral bottom and (ignoring the bottoms) 515 the 8 spiral top, 516 the 13 spiral top and where the circles intersect both the top and bottom intersection as the 2-3 top intersection 518, the 3-5 top intersection 519, the 5-8 top intersection 520 and the 8-13 top intersection 521 reflecting the circle engaging the matching bends in the spiral arms. While this reflects the neutron shell, the same applies to the proton shells and the excitation of electrons can be viewed as moving them out from the center neutron core 31, second circle core 31a to the third circle core 31b and to the 4th circle core 31c with other places of stable excitement possible with larger atoms.

This shows the sharing of a “free” ct4t12 states 172F between the proton and the electron from which the phenomena of charge are derived.

Stabilization occurs for protons relative to the neutron backbone, but it can also be considered as circles around the resulting proton backbone for electrons.

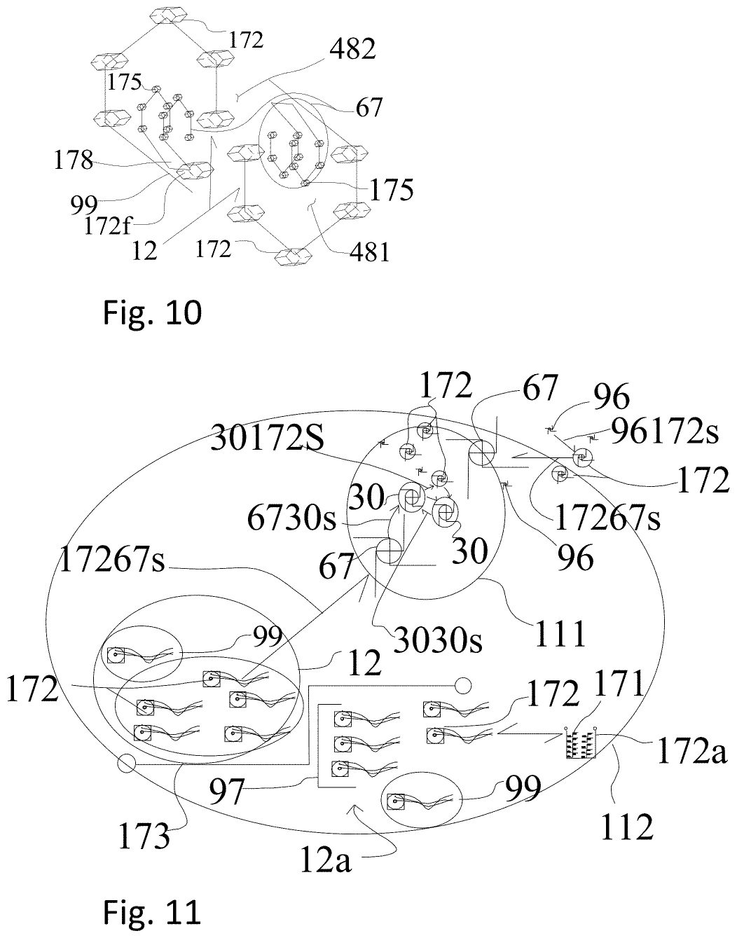

FIG. 10 shows Hydrogen, H2 as it would appear in this modelling showing the molecule comprised of protons 67 primarily made of ct4t15 states 175 along with unstable ct4t15 178 stabilized by electrons 12 primarily of ct4t12 states 172 along with bundle 99 which is largely an unstable ct4t12 state.

Similarly, there is the unstable ct4t15 178 for the proton which forms what would be bundle 99 in an electron.

### FIG. 11

FIG. 11 (see 33 for a similar view) shows an alternate view of the modelling of a stabilized Helium represented by two neutrons 30 with balancing protons 94 and an electron cloud reflected by the electron orbit 112 around the Helium bundle, nucleus 111, a first matrix which includes photons 96 and ct4T12 states 172 free of the electron 12 and the electron shell 97.

A stable molecule or atom has balanced spew. For the sake of consistency, the sharing of information uses the two states between which spew is being examined and adds an “s.” For example, neutron to neutron spew 3030s, proton to neutron spew 6730s, photon 96 to ct4t12 spew 96172s. It is referred to as spew being the average direction of a compression/decompression series which can change the net direction for any value of x; Spew 17267S being from electron's ct4t12 172 to a proton 67 is unique and defined as charge, perhaps as magnetism in the form of ct4t9 states (not shown). It could also be designated less specifically as spew between an electron and a proton as 1267S which might be charge, as opposed to magnetism. A different view of a ct4t12 state 172a shows the ct4t12 state as a bundle of ct4t11 states 171.

The spiral 173 separates two groups of ct4t12 states one being shown as electron 12, the other being shown as 12a including its separately identified electron shell 97 and reflects the association the electrons maintain in a balanced state notwithstanding the spirals of the paired higher compression states as will be discussed and shown in reference to other drawings.

One can see both the circular tendencies in even math (e.g. ct4t12 172a); and the spiral results in the odd math (e.g. ct4t13 173).

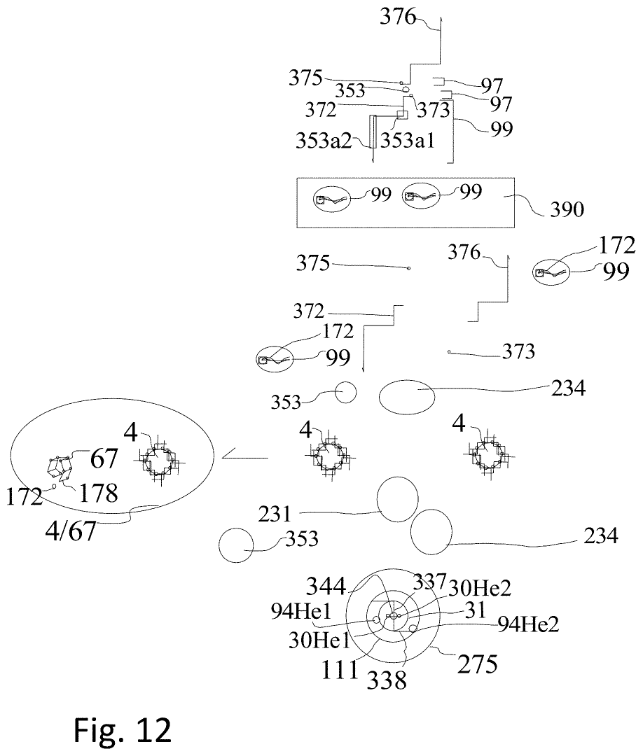

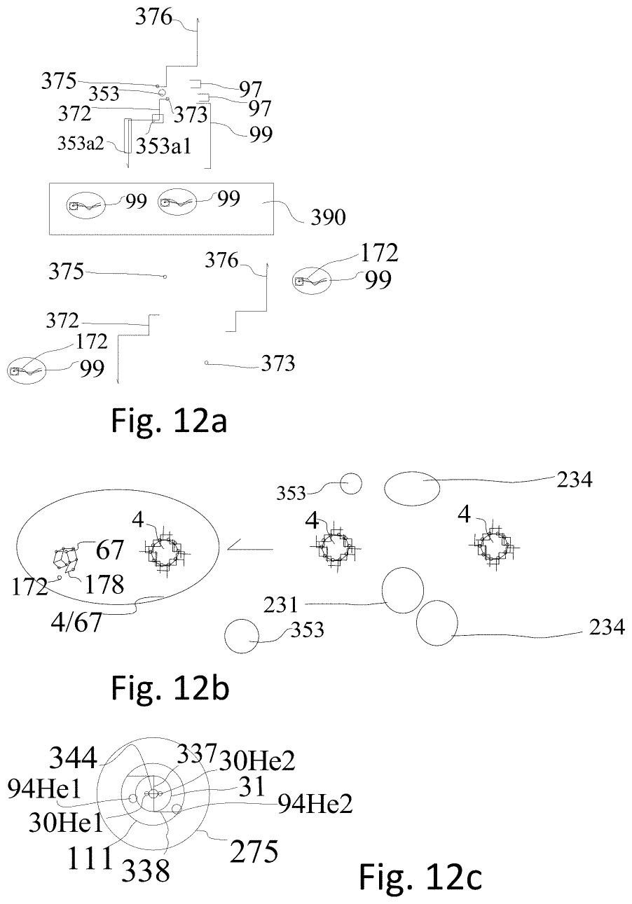

### Fusion FIG. 12

FIG. 12 shows how the models can be combined to show targets for encouraging fusion according to this model. Specific dimensional features can be targeted. To add clarity elements are broken out in FIG. 12a-12c.

FIG. 12a show at the top a typical H2, broken out.

Adding energy is shown by Plasma 390 containing waves represented by the bundles 99 as a larger pre-time change state largely independent of a proton or excited within an electron. Plasma, using this model, can be controlled to get a more targeted effect using the concepts embodied in FIG. 2 relative to what states are possible and the transitional states described in the discussion of the model.

The result below the plasma 390 is that the hydrogen is broken down into the core and the shell, essentially separating the electrons 376 and 372 from the protons 373 and 375 and creating something of a dispersed t12 cloud shown with free states 172, 99 and the shared information 353 being no longer shared.

As the plasma cools and high pre-time change states otherwise are reduced to bring the reactants back together these free states and supplemental states must be used to rebuild stability to get fusion.

While the precise mix of neutron to neutron spew, neutron to proton spew and proton to proton spew require additional experimentation, understanding that these are portions of what has been previously identified as space and possibly the interface between space and ct4t13 and higher states allows for it to be targeted for manipulation using the disclosure in the patents.

In FIG. 12 b neutrons 4 are added along with spew 234 (from FIG. 11) to represent the type of information shared between protons and neutrons to encourage the neutrons otherwise present to form H2N (in the prior art referred to as Helium-3, although in AuT there is no Helium without two neutrons to allow stability). Neutron to neutron sharing spew 231 and possibly more spew 234 can be added to increase this interaction which otherwise must be accomplished with pressure and fractal shaping.

A hybrid 4/67 between the neutron 4 and the proton 67 can be created to give charge characteristics and allow a broader use of item 353, Proton to proton sharing of information, so that information 353 can be used to simultaneously bring the hybrid 4/67 and the proton cores 375 and 373 or other protons as described herein together as He4.

There are two versions of the reaction, one where the neutrons are put together with the protons around them, the other where the protons are added one at a time, but either way the process goes far beyond maintaining a plasma.

FIG. 12c shows the desired result. In this case, the Protons 94He 1 and 94He2 are shown in different places within the nucleus 111, the indication being that normally the backbone of neutrons formed by the overlapping spiral arms 337 and 338 virtually described by the two neutrons 30He2 and 30He1 sharing information 344 would anchor the protons, but they would remain in place only approximately or on average because of the constant compression and decompression from the viewpoint of time, however fixed they would be at any value of x. The corresponding spirals of the protons are not shown in this view, but these “cloud-like” spirals of proton information are indicated as unstable t15 178 just as the unstable t12 states of the electrons are indicated without showing their spiral framework as bundles 99, viewed alternatively as wave/particle or field effects by prior art.

The fractal model tells us that subject to dimensional changes and informational changes all the states of folding, dimension, curvature, and spiraling have the same basic structure. Electrons balance the protons rotationally; the protons balance the neutron backbone so described.

As the matrix of the neutron core is expanded outward as discussed in the following Figures, the location and function of the protons and their associated electrons can be viewed from this initial fractal model and used accordingly for modelling atomic and molecular interactions to better manipulate chemistry which now is reconciled with fusion and fission into a single discipline.

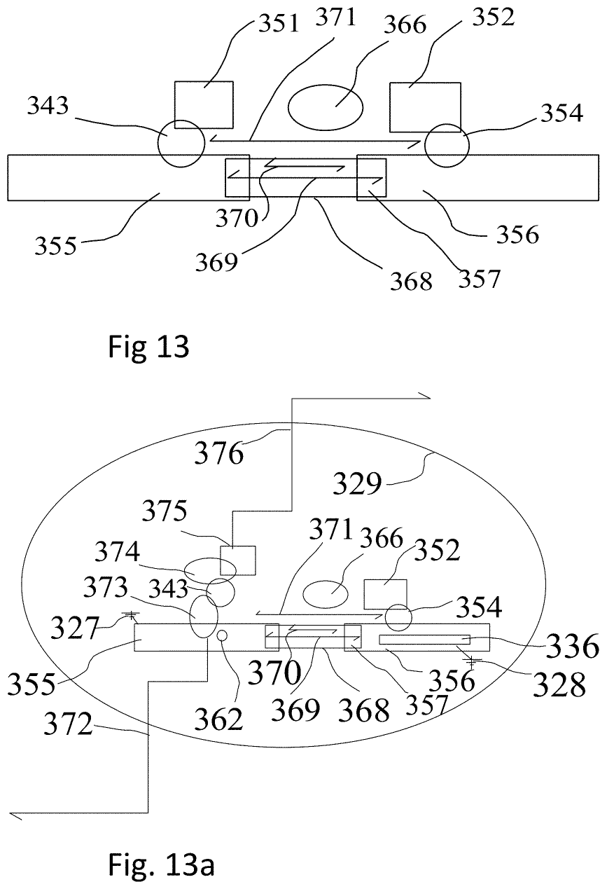

### Catalyst FIG. 13

One can extrapolate from the balanced model to examine the operation of catalysts to design better catalysts and target specific aspects of catalyst function to get different results.

FIGS. 13 and 13a shows how catalysts operate and can be used to improve catalysts and increase compression for fusion or other material manipulation processes. We will address a compression catalyst. A decompression catalyst works in the opposite fashion.

Reference will be made to the type of feature, which is consolidated in different cases, using AuT designations which are more accurate than neutron, proton and electron designations.

The proton core 375 is joined via shared information 343 between cores 373 and 375 which are secured to balancing electrons represented by the spirals 372 and 376. The catalyst arm 355 holds the proton core 373 coming out of the catalyst.

One embodiment is a pre-fusion energy reactor using a current carrying layer 336 within or below the catalyst arm 356 to carry current to a chosen location here resistor 328.

The broad view of the process is using the framework of fractal organization and information exchange as absorption and spew to predict reactions and interactions and to encourage or discourage reactions and interactions of different dimensional states as defined herein.

The catalyst can target either the proton and neutron or the neutron backbone selectively using this new model.

The affected particles are a first reactant (e.g. a neutron) 351 and a second reactant (e.g. another neutron or Proton) 352. The first reactant shares shared information 353 with a first catalyst arm 355 of the first catalyst 316.

The second reactant 352 is held by second shared information 354 to second catalyst arm 356. The two reactants (first reactant 352 and second reactant 351) have reactant information 366 between them, but this does not necessarily encourage reaction.

The interaction between information 366 and information 362 allows for reactants (in the form of information 362, for example) to be infused into or removed from shared reactant information 366 to control the spacing between first spacing 370 creating the potential for a catalyst pump.

There may be an enhanced draw of T12 states with high pre-time change components from neutron core 343 into first catalyst arm 355 and second catalyst arm 356 which can be drawn out as energy.

Between the first catalyst arm 355 and the second catalyst arm 356 is a first catalyst bond 357 which is information which can change from first separation 358 to second separation 359 bringing the two reactants (first reactant 351 and second reactant 352) together. In a true catalyst these arm separations 357 and 358 and shared information 343 squeeze together by putting out information into the shared information 343 and/or 366 from which it is effectively recycled back to 343 and/or 366 when the reaction is completed.

The nature of shared reactant information 366 allows for the reactants to interact and as taught herein information 366 and 343 can be enhanced to encourage the sharing of spew and absorption between reactants 351 and 352.

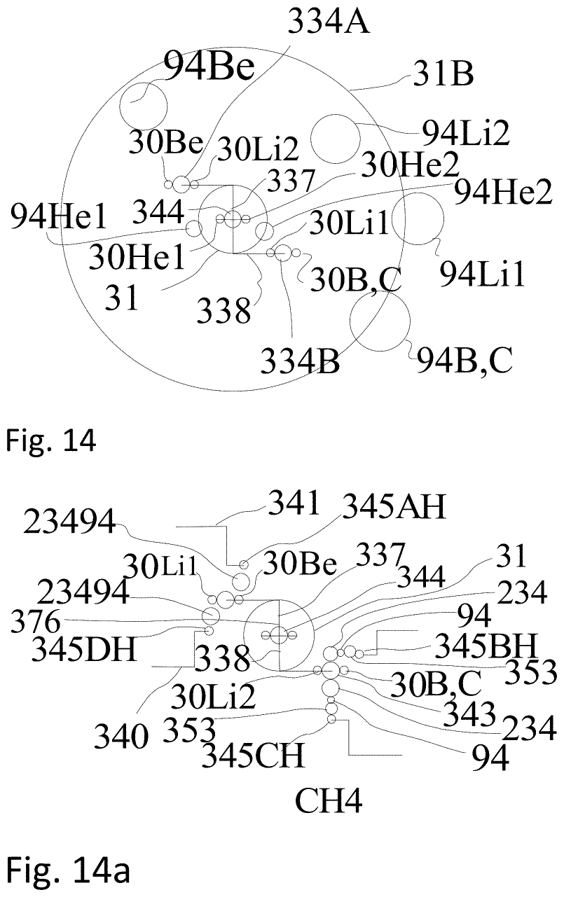

### Higher Order Spirals FIG. 14, 14a

FIG. 14 shows a Carbon Neutron core expanding on the fractal modelling of the H2 core in FIGS. 3 and 4.

We see the buildout from the basic structure discussed in FIG. 4, but here instead of two protons forming an H2, we have two neutrons 30He 1 and 30He2 forming a neutron backbone core for Helium.

Since the backbone is built from the center outward, this discussion will start at the center of the neutron backbone and move outward. FIG. 14 shows a relatively simple, balanced atom having a Be Neutron component 34Be, two Li components 30Li 1 component 30Li2 and a B—C neutron component 30B,C.

Protons 94 are shown as circles around each of the letter designations for each neutron component being balanced, 94He 1 being the proton balancing the first neutron 30He 1, and similar arrangements for the other protons 94He2, 94Be (an unbalanced neutron as discussed later) and the two “proton isotopes” 94B,C showing how the balanced 30B,C neutron can have two different proton components (one for Boron and one for Carbon) and still be a stable backbone for the atom.

FIG. 14a shows how the backbone model from FIG. 14 interacts with Hydrogen from FIGS. 3 and 4 to form a simple molecule, CH4, and adds some detail, showing, exemplary components as hydrogen spirals 341, 337, 339 and 340 bonding hydrogen cores 345AH, 345BH, 345CH AND 345DH (which are also the same as protons 94 along with their spirals 341 shown for 345AH and spiral 340 for 345DH by way of example), in this case 341 through shared information 353 to protons 94 which, in turn use absorption and spew as shared information 234, a manifestation of shared information, to join with in this case the core 30Li2 and 30B,C. For clarity we can combine these as, for example, item 23494.

Two neutron cores represented by the neutrons 94He 1 and 94He2 overlap through shared neutron information 344 which corresponds to the shared information 353 between protons. Because each of the neutrons are collapsed as shown in FIG. 7, the nature of the overlap is a dense concentration of lower ct states, below ct4t12, being shared.

The traditional nucleus 111 (not shown) extends outward to include the protons 94. In the simple, largely balanced Helium atom, the nucleus 111 can be considered like item 31, 31a, 31b, etc from FIG. 9a depending on which includes the protons. This is not necessarily the same for larger atoms nor is the nucleus always stable.

Composite spirals are combinations of, for example 338 neutron spiral and proton spiral 339, or 337 and 341, interact while providing balance, absorption and spew changing the effective location of items 31, 31a, 31b, etc to correspond to these modified spirals which are more fluid in shape and need to be viewed as a matrix as discussed in other figures.

It is apparent that in terms of the Neutron backbone, Boron and Carbon are the same and the “P-isotopes” (proton isotopes as opposed to neutron-based isotopes) are Boron and Carbon. “Stable” neutron shells tend to be balanced, but that balancing can be aided by spew and absorption between the surrounding Protons and the Neutrons in the shell.

Hydrogens with their own spiral shells of electron components (not shown in this view) are shown conceptually in FIGS. 8 and 9 and discussed in conjunction with other figures in this disclosure.

Shared information, for example information 234, is largely ct4t12 and lower type information. The ct4t12 electromagnetic type of information is what makes up most of the hydrogen spirals, such as 341.

The exact appearance of this extremely active matrix is fixed for any value of x and largely mirrors the appearance of a galaxy with two arms having greater compression as they are followed from the ends to the center and compression can be seen as beginning at the ends of these arms and steadily compressing towards the center here shared information 344 between neutrons. Like spiral galaxies, there is no “perfect” structure except at inflection points of compression exemplified by the moment of collapse of a black hole.

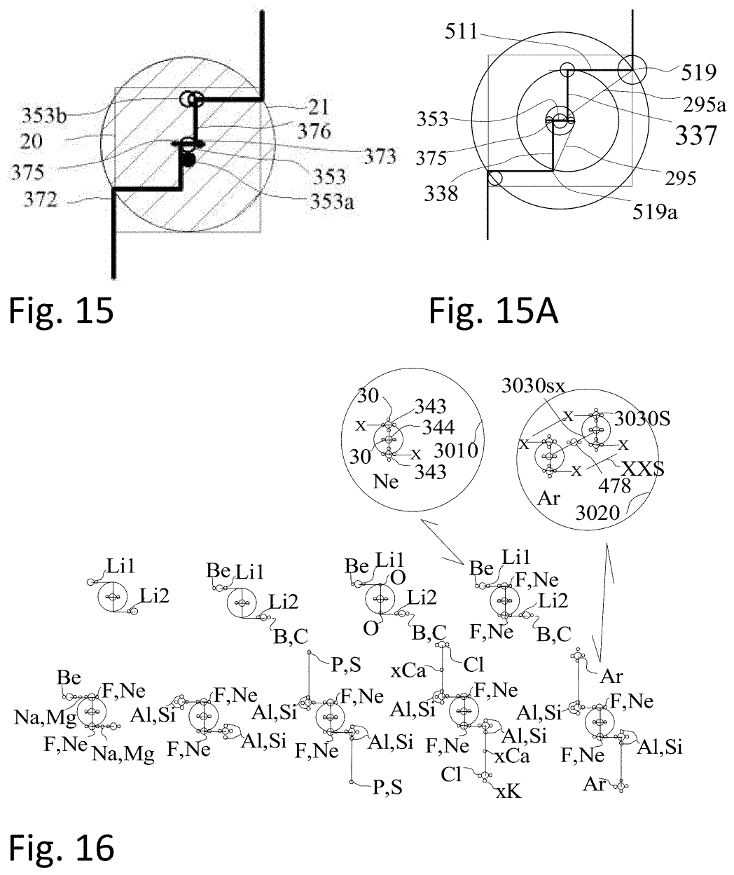

### FIGS. 15 and 15a

One can target fractal components using the relationship shown by other fractal components. If one were to look at two black holes circling as a point of reference, one can see in slow motion what occurs faster at the neutron level and even faster at the proton level and faster still at the electron level and target the reaction accordingly. The best way to see how this can be done is by referring to FIG. 15.

This is the overlay of the fractal math with the Vitruvian Man (the registered trademark of Clean Water, Inc. shows another view) where the center of a person about which the body is built corresponds with item 373, the amount outside of the overlap with items 375 and 353. What FIG. 15 suggests is that any shared information 353 can be adjacent to another shared information 353a and that at any turn along the spiral, another shared information 353b can be generated in alignment with the central core of shared information 353 but offset by the fractal separation required by the model. The FIG. 15 model shows “3-5” possible stacked bundles above item 353 and 3-5 below to balance, but this does not account for all of the variations. For the sake of clarity, the arrangement is labelled in rough terms consistent with the periodic table based on the proton shell about this backbone.

Following this suggested arrangement, the higher concentrations of information are closer to the core and include other, more compressed ct4-5 compression states which at the galactic level would be black holes and associated neutron stars. Here, only the neutron arrangement is shown for clarity, but as is described in more detail in priority patent applications and covered generally herein the surrounding proton and electron shells are largely pulled toward the same fractal relationship from their base 6-10 naturally occurring structure to the base 10-16 structure by the required information sharing that gives these structures their rotational symmetry.

This provides a better, fractal view of the atomic and molecular models than the stacked orbitals which are an effect and not an actual appearance, at least not theoretically.

Proving the Neutron Back bone of the periodic table is relatively trivial given the fractal model. AuT suggests a different base numbering system between the proton and neutron. The choices are 2, 3, 5, 8 and the modelling suggests the Proton is a base 3 system (ct3 transitioning to ct4) and that would make the neutron a base 5 system (transitioning to base 8). We don't see much of the base 8 transition because you have to look at neutron stars and black holes to see the transition, but we do see the base 3 to base 5 between the electron and proton.

FIG. 15 shows how this fractal structure is carried forward into the human form showing how the fractal analysis could be overlaid with the square first matrix 20 and circle second matrix 21. It also shows the evolving relationship between pi and the Fibonacci series. The overlap and the 1:2 relationship of overlap to non-overlap F1 to F2, 1 to 2 of the Numerator of Pi, etc. and reflects the early association of positive to negative results. The conversion of curvature to Fibonacci series.

This drawing, overlaid onto the Vitruvian Man by Da Vinci aligns the human center with shared information 353, the head at 353b directly above and fractally separated from 353 and 353A covering reproductive features of the Vitruvian Man.

The shift from space to ct2 also involves the transition from the first fractal generating iterated equation (fpix) to the second iterated equation (2f(x)\hat{ }2\hat{ }x).

This shift in equation is why gravity sometimes appears out of line with other forces.

The transition from space to the first folded state not only gives rise to gravity but also gives rise to dimension.

The fractal gives rise to a changing base (f(n)) or 2f(n) and a changing number of folds. Each dimensional state becomes a ratio of the prior state of compression (ct state) to the next state of compression.

The relationship of fpix and Fibonacci is further exhibited in FIG. 15a. Here you can see the offset using designations from the prior drawings along with hypotenuse 295 and 395a relating the various lines.

A relationship of 2+(3+⅓) can be viewed between legs 337 and 511 using the same designations as in FIG. 9A. Hypothenuse 295 and second hypothenuse 295a shows how you can use the relationship x\hat{ }2+y\hat{ }2=r\hat{ }2 shown by Pythagorean theory and you end up with this relationship:

At each “doubling” of the amount of information, the accuracy increases by a factor of approximately 2\hat{ }n You can see this in the math where the first two rows are arm lengths, the third is the resulting hypothenuse to the circle and the bottom is the degree of accuracy resulting reflected by the difference between leg 2 and the hypothenuse resulting.

| | legs | squares | legs | squares | 2.5 × leg10 | 2 × leg25 | | |
|---|---|---|---|---|---|---|---|---|
| leg 1 | 1 | | 6 | 36 | | | | |
| leg 2 | 2 | 4 | 10 | 100 | 25 | 50 | 100 | 200 |
| leg 3 sum | 3 | 15.11111 | | 136 | | | | |
| leg 3 plus extension to center | 3.333333 | 11.11111 | | | | | | |
| hypotenuse | 3.887301 | | 11.6619 | | 29.15476 | 58.30952 | 116.619 | 233.2381 |
| Round off hypotenuse-radius | 1.295767 | | 3.887301 | | 4 | 8 | 16 | 33 |

This allows an examination and therefore targeting of the point where the transition between a transitional ct3-4 state and a ct4 state occur.

Another way of looking at this is that as the Fibonacci curve doubles in size, its relationship to a resulting circle is roughly and exponentially increased. A limit allows curvature to approach what is observed such as Lim(ABS(SUM(A−B)Fpix) approach zero; along with a changing compression state, primarily 1-4 at the level where we experience curvature relative to a denominator including a sum of points separated by charge (1,−1) and fuse length ([−1\hat{ }x plus 2×(−1)\hat{ }x−1]) between charge changes.

Does n−1 equation give rise to spacing of −1 equation; is the −1 equation the first such equation?

No that is 1, 3, 9, 27. Instead, one can see the building from 1, 2, 3; the quantum count; to the f-series since if you take the f-series through 21 the separation for f-series is 0(1−1), 1(2−1), 1(3−2), 2(5−3), 3(8−5), 5(13−8), 8(21−18) which is a way of counting down to the point of origin.

Similarly compression counts back using the n−1 equation in the −1:1 sin ration where it is 1, 3, 9, 27, 81 each of which is 3× the separation and each separation is 2× the prior number from one another so you have the building of compression tied to the same quantum counting fractal modelling.

This also provides a rough transition to know how many neutrons will be required for any “post current periodic table element” would have and insight into the relationship for molecular transitions.

One can extrapolate from the balanced model shown in FIGS. 3 and 4 to examine higher order orbitals. When the conceptual “specific fractal jumps” are viewed, it can be seen how specific “excitement energy states” of a hydrogen necessarily fit within the structures which are in place to create a fractal (compare to the larger fractal spiral galaxy) and staged (see the different stable states of each fractal understanding there are sub-fractals which are more pronounced as compression increases which can be seen by the t1-t16 CT4 transitional states and the very complex galactic models between ct4 and ct5 seen through telescopes) set of energy levels observed.

Why this matter is that if you are looking for a reaction, atomic, molecular, fusion or fission, smaller or larger, you can determine what you are looking for in terms of end product and intermediaries using these ratios. While this only uses the f-series change, the use of compression (there is a very narrow compression difference between the proton and the neutron accounting for the small discrepancies) differences and fuse lengths would allow for a much broader application.

If, for example, you wanted to know what the next “element” was, you could apply the simple math of fractal, F-series math of the type shown in the periodic table and you would “know” approximately the number of protons and neutrons that would make up that element. You can target the features that get you to this place. Since the universe is fractal, this same series applies to all areas of science from Biology, to space travel, to fusion, to pre-fusion science. Having this model, you know where you are and where you are trying to get to with a very specific mathematical algorithm which can be used directly, as with neutrons and protons, or indirectly to make approximations for large scale systems.

Based on mathematics, the neutron core can fit within the electron shell, likely all the way up to the point where the neutrons and protons begin to diverge in number when the balanced shells you see in FIG. 9 become unbalanced.

The fractal indicates this is a core of 2 protons balancing a pair of neutrons followed by a shell 3×3 ct3-4 shell. The suggestion is bolstered by accepting that as fractals build it goes:

At the proton you have: 2×Core:3×3; then paired cores and 3×3; then paired pairs. This is followed by a triangular arrangement from the base 3 arrangement.

At the neutron core you have 2×Core:5×5; then paired pairs, then the third arrangement, presumably stabilized from the inside out There is an extra neutron reflecting the complexity of the balance of the base 3 to the base 5 systems.

| Pattern of Protons | | | Fractal Shells | | | | | |
|---|---|---|---|---|---|---|---|---|
| | base 6 | base 2 component | Pattern of Neutrons | | base 5 | base 2 component | | |
| 10 | 6 | 4 | | 10 | 10 | | excess | |
| 18 | 6 | 2 | | 22 | 10 | 2 | | sumx2 |
| 36 | 18 | (3 × 6) | | 48 | 20 | 6 | | sum × 2 |
| 54 | 18 | (3 × 6) | 77 | 76 | 20 | 8 | 1 | sum × (1/2) |
| 86 | 30 | 2 | 60 | 136 | 60 | | | sum × 2 |
| 176 | 90 | | 40 | 176 | 40 | | | sum × 1/3 |

The “backbone” defines the lower fractal quantities of the protons which in turn control the electrons.

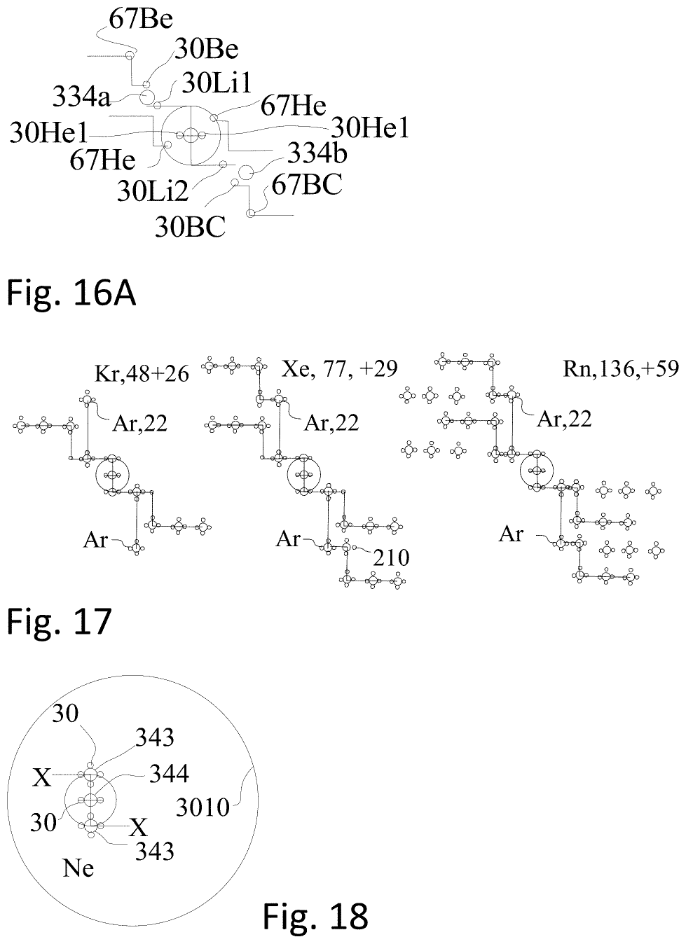

### FIGS. 16, 16aa and 17

FIGS. 16 and 17 take the conceptual framework of the disclosure and show how spiral building of the periodic table neutron backbone might otherwise appear. Letter designations are used to show the relationship of this more balanced structure with the periodic table based on the outer proton shell and designation of the corresponding element, e.g. Ar represents Argon and the Ar,22 represents the location of the 22nd neutron building outward from the core and mark the exemplary location of neutrons along a fractal spiral.

FIG. 16a shows the numbering of one of those elements, Lithium along with the broken-out elements for the backbone transition to Carbon.

### FIG. 18

To put FIGS. 16 and 17 in context, FIG. 18 shows an alternate view of a stacked version of Neon. FIG. 16 shows many of the elements broken out in different view, in this case shown the first bridge 478 holding two 10 unit neon fractals together in balanced within a 20 unit neutron backbone 3020 compared with the 10 unit neutron backbone 3010 which uses the helium core on either side of item 344 to provide a bridge of sorts which can be theorized because of fractal modelling given FIGS. 15 and 15a reflecting observed phenomena.

An odd neutron 210 is shown for the limited amount of unbalancing that can be present. The balancing that is experienced with protons in a solution in such a situation is discussed herein showing the importance of extra information sharing. Another effect is the different types of bonds at play.

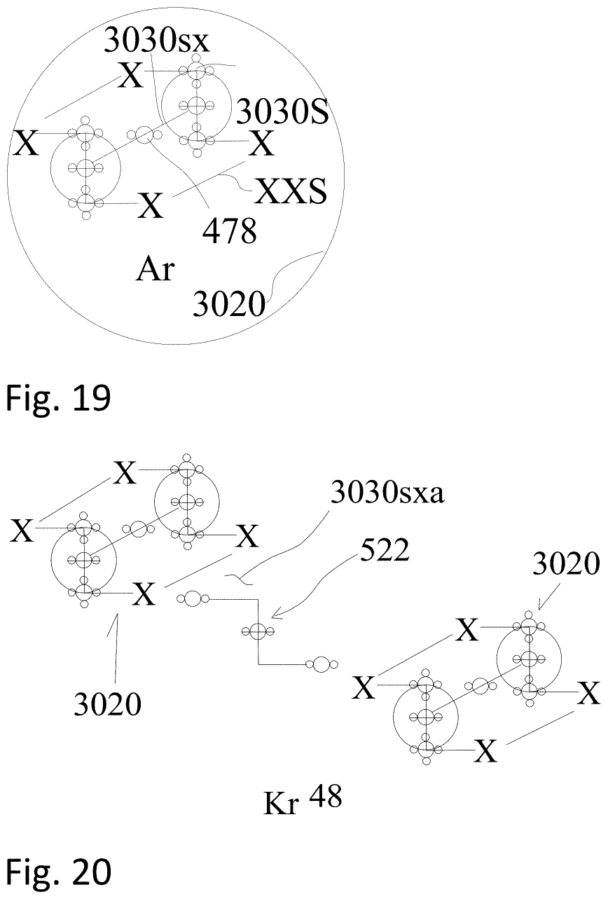

### FIGS. 19 and 20

FIGS. 19 and 20 shows how fractal pairing of the type shown for two neutrons in Helium can be expanding to create balanced continuations of the modelling for Neon for the next two Noble gases, Argon and Krypton. Where pairing around the initial spirals is indicated.

In FIG. 19, XXS refers to exterior spews XXS that are outside of a core, here the neutron backbone for Argon. It could also be the electromagnetic field outside of an atom. It is a term for whatever type of effects of compression and decompression are not specific to the element in question internally. Then there are the spews more easily designated elements such as the strong force interaction shown as 3030S here between two adjacent neutrons. But here you also have different, more removed strong force secondary interactions 3030SX between the bridge 479 and the neutrons outside of the bridge, but still a part of the backbone 3020. The designation of x is also because the spew 3030SX may be any neutron or group of neutrons in the backbone that are affected.

FIG. 20 shows a more complex bridge, Krypton bridge 522.

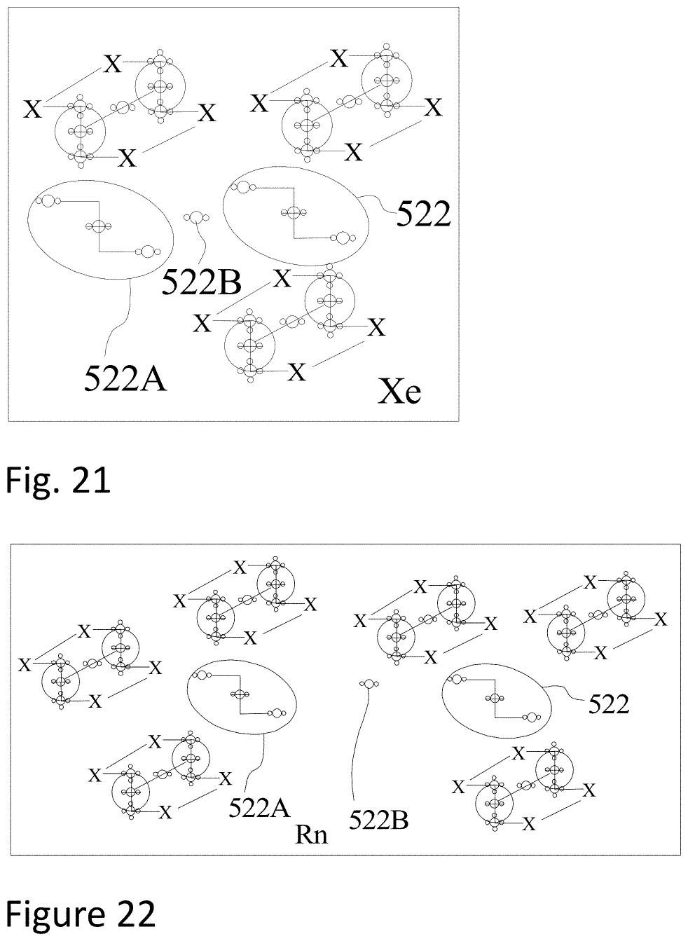

### FIGS. 21 and 22 and 23

FIG. 21 22 shows where balancing under the modelling of FIG. 18-20 is no longer perfect, suggesting the modelling of FIGS. 16 and 17 might be a part of the additional changes with a combination bridge comprised of krypton bridge 522 with bridge 522b, and bridge 522a for Xenon (Xe) and Radon (Rn) which are correctly shown here based on their Neutron Bridge and not for the proton periodic table component Protons.

While the exact nature of the bridge may vary, this type of fractal modelling will allow for any molecule or atom the ability to look for bridges to target in triggering reactions along with the other elements identified by the model.

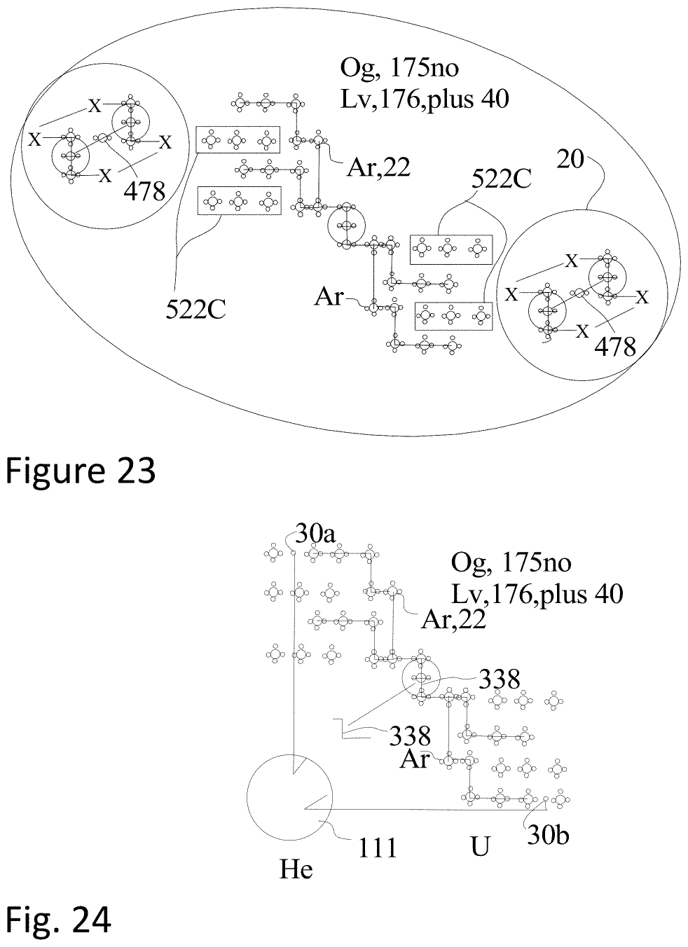

Bridges 522, 522a, 522b, and the more exotic bridge 522c in FIG. 23 of appropriate makeup might be applicable to maintain the atomic structures approximating the fractal structure required overall by the mathematics of compression.

### FIGS. 24, 25 and 26

FIGS. 24, 25 and 26 show another view of Uranium and some of the break-down components, particularly two “excess” neutrons 30a and 30 b which can combine to form a Helium shown as nucleus 111.

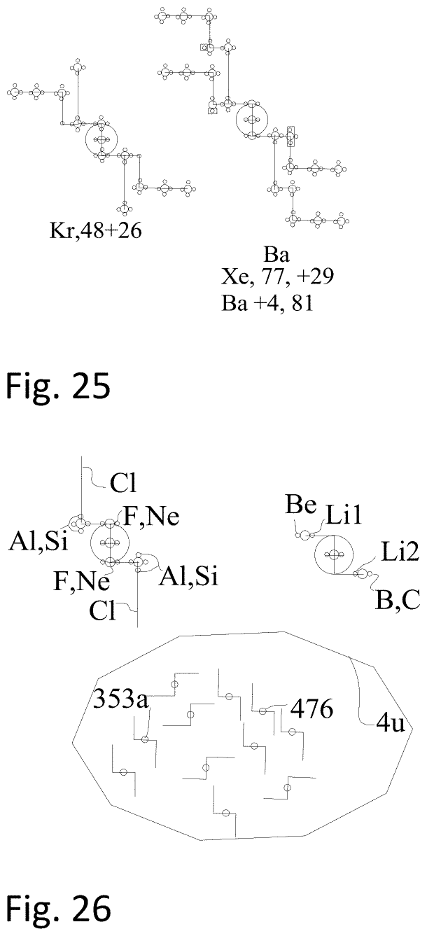

FIG. 25 shows the two main components which Uranium breaks down into, Krypton and Barium. Explosive fission combining u235 and a free neutron to get u236 which breaks down the following way.

| | | | | |
|---|---|---|---|---|
| Barium Ba | 56 | 137 | 56 | 81 |
| Krypton Kr | 36 | 84 | 36 | 48 |

What is observed is K, Ba plus 3n plus 177 MeV; a Cl equivalent, but fragmented, average 2.4 neutrons=7He with 215 MeV average energy in these.

FIG. 26 shows the “left over” component neutrons.

FIG. 26 shows a view of the Uranium Backbone (143 Neutrons); where there is F-series and vertical stacking along spirals and vertical stacking where the spirals are less directly involved, but still contribute to the modelling.

| | | | |
|---|---|---|---|
| Uranium U | 238 | 92P | 146N |

This shows 148 neutrons. It is 2 to 5 neutrons heavy.

U-92:U235=143n U238=146n; U236=144n all of which are called isotopes in proton periodic table modelling; but in the fractal neutron backbone model these are all different backbone structures with different stabilizing proton shells.

A slow breakdown shown above allows free neutrons 30a and 30b to form Helium within a nucleus 111 to be formed for those using the model discussed herein.

In the more explosive version, Uranium starts as a Og 175, Lv 176 plus two balancing 40 unit clouds.

U235 takes on a “destabilizing” neutron to form what is called U236 but which in AuT is a different, correctly less stable neutron backbone. Either way, it breaks down to 146/147 units plus 17-18 extra neutrons.

The AuT version shows are two forms of the backbone degrading to get radiation from the breakdown of different radioactive isotopes. In the top U235 breaks down FIG. 26 shows the resulting stabilizing backbones left after degradation, although multiple products besides these can exist.

While it Is not believed that Chlorine and Carbon are produced specifically, the backbone elements left over from the bottom reaction would form chlorine if they were to come off cleanly, they do not. More important here is that an unstable neutron 4u is shown breaking down into its components shown by example as lower compression, unaligned spiral components 353a and 476; 10 in number subject to further breakdown to reflect what was previously the compressed structure from FIG. 7. While technically it is no longer a neutron 4, the purpose of this drawing is to show how the less time dependent form in FIG. 7 converts to a less organized, more time independent form to yield a greater impression of what is called energy in the prior art but which is, in fact, greater disorganization of the spiral structure and a decrease in compression along with the effective increase in pre-time changes for the matrix designed by the neutron 4 shown broken down in FIG. 26.

These 235 versions of Uranium are distinguished from different backbones, additional neutrons are part of the backbone, e.g. U-238.

The strong force is not the force that holds the atom together, although it is that also, it is the absorption of ct1-ct3 by the neutron and the spew of higher compression states that maintains the balance.

The neutron is folded so tightly as it transitions from a proton ct3-4 transition state to a ct4 state that the higher charge related transition states cannot get in or out of the matrix without the neutron falling apart.

In an exothermic radiation reaction, lower ct states are freed up and the more pre-time change these have, the higher their energy.

To features can be addressed together using the new science of energy incorporated in AuT. The idea is to design reaction where the pre-time features are attached to features going into an energy storage or transmission area where they can be utilized and where they don't affect the container. Since can be viewed as elements held within the radioactive core of ct4-5 transition states, they can be manipulated before they take on independent high velocity aspects that make them impossible to capture from a time-based perspective.

Cold fission within the fission reaction is well known. AuT includes a mechanism which defines the energy and shows multiple mechanisms for drawing down the energy in the rays.

Current theory holds that everything is made up of fields. AuT shows that these “sub-fields” are pre-time particles that have different amounts of pre-time change which we call energy.

The reactants generate heat but also degrade the container.

A more direct path to energy is from the reaction is also possible having a better idea of the process. Knowing what energy is, the pre-time and post time elements, allows for the potential of drawing off enough of the pre-time elements in the form or current or otherwise to reduce containment degradation and provide an alternate path for energy generation. In AuT there is no spacetime. Time is a result of early dimensional change. There are no fields, fields are the application of dimensional changes of various types expressed, often distorted by their multiple positions, over time. They contain “energy” which turns out to be nothing more than pre-time effects; energy is the change in the universe before time is experienced.

To fully understand this model, it is necessary to cover the technological advance. This summary assumes that the basics of the model are understood.

Molecular building results from an increase in compression and the backbone of atoms and molecules are neutron cores. While initially relatively simple, information sharing at the atomic level is more complicated.

It's important to understand how the neutron holds the atom together and why that does not appear as charge which is the proton-electron bonding primarily examined in, for example, the periodic table.

Because the neutron is tightly woven together as a more complete compression state, it cannot absorb or spew t6 and t9 states which are associated with charge, but can only absorb and spew less compressed states, ct1-ct3 typically viewed as pre-time space states although words like time and space are misleading in the model, so ct states will be used and ct1-ct3 are the base pre-time and space states although the gradual building of time means that ct4t12 and lower states are also largely pre-time.

| | | | | |
|---|---|---|---|---|
| top | 18 | 4 | 72 | 148 for uranium |
| bottom | 18 | 4 | 72 | 238 |

| | | | | | |
|---|---|---|---|---|---|
| free | 2 | 1 | 2 | | 145 for u 235 |
| pairs | 1 | 2 | 2 | 148 | 146 for u 236 |
| cloud | | | | 148 | less the 2 free as shown |

Dampening has targeted elimination of neutron bombardment. AuT focuses on control of the emission of ct states known as gamma and alpha waves, instead trying to turn those into energy or less destructive ct states.

Focus on the neutron backbone instead of the isotope model allows more control of reactions.

In order to understand how the innovation discussed herein works, it is important to go beyond the backbone which is comprised of post-time states separated by pretime states, neutrons separated by protons, electrons, lower transitional ct4t states and space in the form of ct1-ct3 and the transition states between ct1-ct3.

The first is to understand that the difference between energetic and unenergetic pretime states has to do with the amount of pretime change involved.

High energy Gamma and Alpha rays are largely pretime change features shown in FIG. 5 to ct features separated by the amount of compression and pretime change (tied to fuse state) from one another.

While the drawing shows the transitions from 176 core electron units to the proton, you can go in either direction to see additional fractal units in transitional and non-transitional states.

The core features of a Helium below are instructive. All of the elements shows have different amounts of pretime change. The neutrons are close AuT ct4 units and can only absorb and spew ct3 and lower states without breaking up. The protons and electrons being more open shells can absorb and spew ct4t9 and 6 states which appear as charge.

The individual units of the electron (175) ct4t12 states have fairly high pre-time elements, but not much compared to what the prior art describes as alpha and gamma rays which have large pre-time elements.

Gradual bleed off of information can be accomplished with a catalytic reaction. Cold fission or cold nuclear fission is defined as involving fission events for which fission fragments have such low excitation energy that no neutrons or gammas are emitted.

Cold fission events have so low a probability of occurrence that it is necessary to use a high flux nuclear reactor to study them. The idea here is to increase the ratio of cold fusion to hot fusion, not by removing neutron and gamma ray emissions, but by absorbing those emission is a way that minimizes the effects outside of the reaction except for heat.

The model allows the application of the model to reduce degrading features or capture degrading features to slow down container degradation by reducing the energy of the gamma and alpha wave states, which are likely ct4t6 and 3 states with pretime change which can be stripped off as energy, possibly using the catalyst type method as a constituent part of the reactants or as a part of the shielding, even as a part of rod system, as by having alternating rods for separating the pre-time states and transferring the resulting energy where it can be used to supplement the work or the reactor or for disposal.

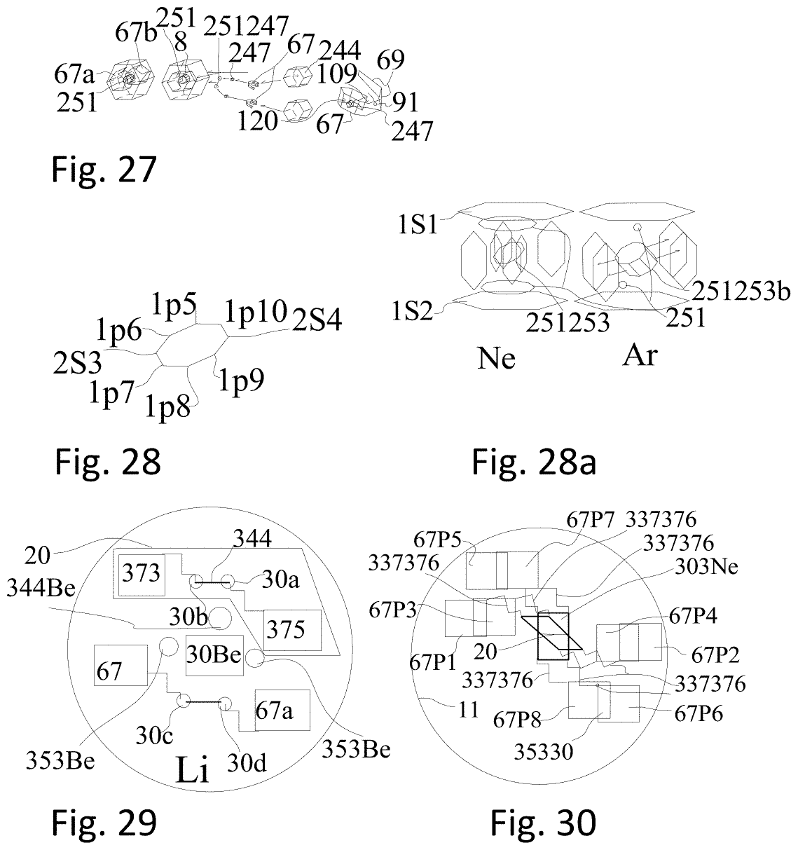

### FIG. 27

FIG. 27 shows the stages of compression from electrons to Helium; dimensional features that can exist during the fusion process and is exemplary in conjunction with the disclosure including fractal intermediaries 351247 between intermediary item 247 and core 251.

### FIG. 28

FIG. 28 shows the electron shell resulting, in this case showing different fractal shell 251253 for the Neon Fractal and the more complex fractal shell 251253b fractal for Argon with representative base 6 electron shells shown with their designations 1s1, 1s2, in FIG. 28a item 251253 is broken down as the 2s3,2s4 and 1p5-1p10 orbitals using the language generally used in the prior art. Exemplary is the expansion outward of this core orbit structure 251253 with one elemental orbit 251 showing how the electron may occupy a more dispersed location.

The proton and electron shells mimic the internal arrangement of neutrons distorted by the different fractal compression necessary to balance the states through increases in dispersion of information.

The neutron backbone and the proton number in the periodic table can be balanced with the fractal model. The periodic table as it most prominently designed only deals with the shell around the backbone and while significant, hides rather than illuminates the backbone and true function of the periodic table. Because its presence in endemic, some references will be made to it with the understanding that it is only critical to the backbone in that it stabilizes the backbone.

Above Chlorine (17/35) there is a steady divergence as the number of neutrons increases relative to the protons. FIG. 28B shows the table is corrected for F-series compression, here by dividing the neutrons by 5 and the protons by 3, the lines representing the protons and neutrons begin to line up. Any F-series alignment works as long as the correction uses “Fibonacci” changes (e.g. 1:2; 2:3; 3:5; 5:8; 8:13) you get steadily lower variations and alignment of the proton and neutron numbers.

### FIG. 29, 30, 31, 32,33

FIG. 29 through FIG. 33 give a view of the interaction of the proton and neutron spirals showing the transitions to the observed periodic table compared to the neutron periodic table as the fractal breaks down from a base 5 to a base 3 system continuing the discussion from FIGS. 27 and 28 before transitioning to a discussion of this interaction in Fusion beginning with FIG. 34.

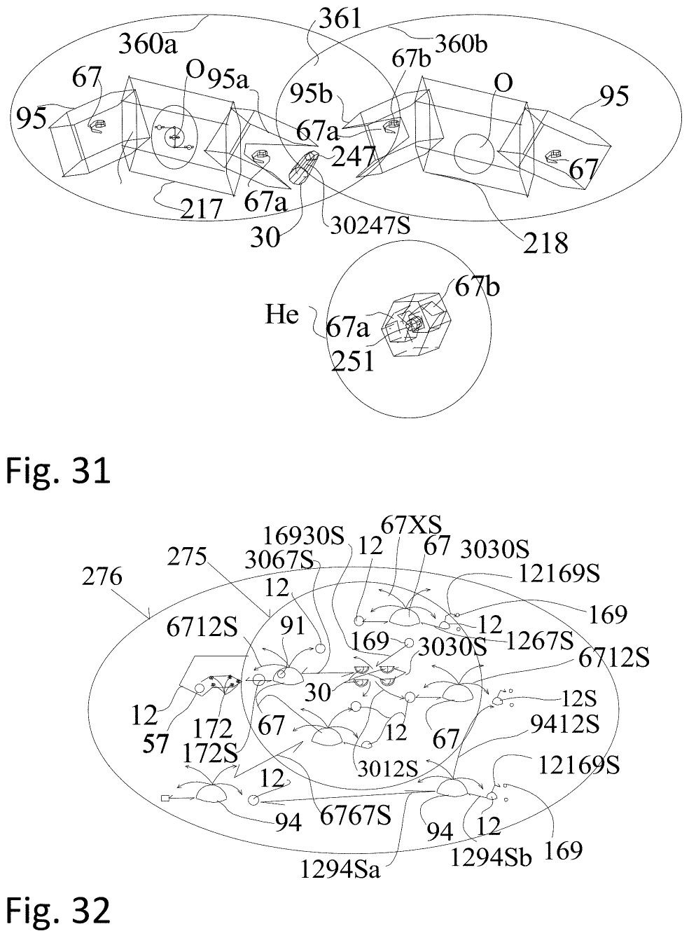

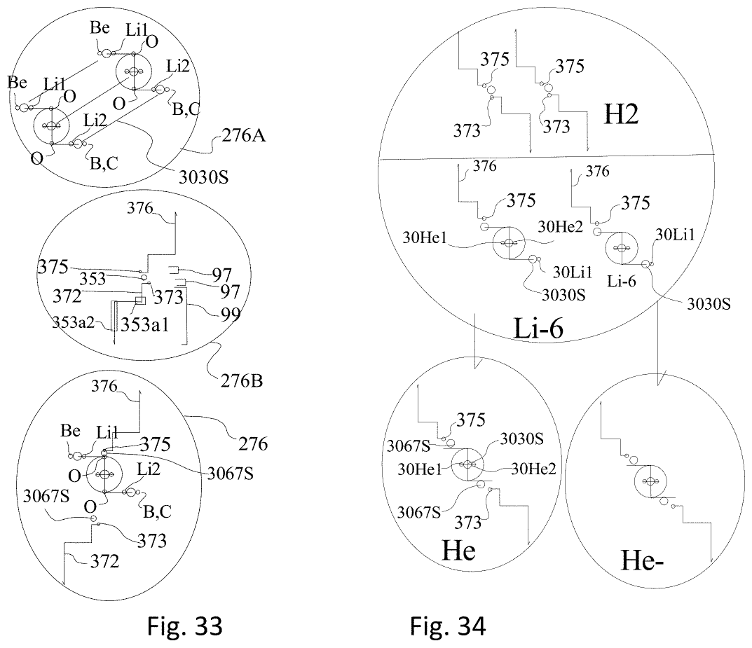

FIGS. 31 and 33 show the need to view the structures from multiple points of view to reconcile our time-based observations with those of the pre-time environment along with FIG. 11.

The average center of charge 57 when viewed from the standpoint of time defines the location of the electron.

FIG. 29 shows a Lithium atom having protons 30a and 30b, 30c and 30d plus the Beryllium neutron 30Be with its shared information 344Be. There are protons 67 and 67a balancing the remaining two neutrons 30c and 30d.

The Helium part of the Helium backbone 20 includes balancing protons 373 and 375 and shared information 344 which is seen as the strong force net folding inward of space between the neutrons.

FIG. 30 shows a more complicated arrangement and for this reason the number follows the periodic table designations and the shared information is characterized by the elements primarily involved in the sharing with the atom matrix 11. Here each of the protons is numbered 67P1-P8 for those protons outside of the Helium backbone 20 which can be seen by looking back to FIG. 29 but forms a bridge in the center of the neutron backbone designated as backbone 20. Proton 67P1 balances against proton 67P2 on the shared information spirals which in this case are hybrids of the Proton and neutron and designated as spirals 337376 for this reason, being a combination of spiral types 337 and 376.

FIG. 31 shows the altered view of the electron shells 95 for a hydrogen proton 67, two electron shells 217 and 218 for two oxygen neutron backbones with their protons shown as O, a first peeled back electron shell 95a for a partially exposed proton 67a and a second peeled back electron shell 95b for proton 67b. Here, there is proton 67a to neutron 30 sharing and proton 67b to modified proton 247 which is a transitioning proton (to a neutron) found in deuterium; this reflecting something of the structure of deuterium in water and the transition to a helium atom shown as He represented by protons 67a and 67b around a core of two neutrons 251.

Sharing of the electrons can be seen with matrix overlap 361 which partially contains the deuterium 30247S.

### FIG. 32

FIG. 32 shows a portion of water in an almost static state as viewed over some changes in x, perhaps reflecting an insignificant part of a second.

The molecule of water shown exists within a matrix here shown as molecular bundle 276 and within this bundle is the oxygen atomic bundle 275. For purposes of this drawing, states smaller than a photon are not shown, but it is understood that there is a complex web behind this of compression and decompression which is reflected in the compression and decompression shown in the view. Moreover, only exemplary states are shown with the understanding that there is a web of even more states although many electrons, protons and 4 of the 8 neutrons 30 are shown. In addition, the dimensional characteristics are presented in a limited way since scale differences are impossible, the electrons being shown largely as two dimensional, the protons as beginning to take on the third dimensional features and the neutrons being shown as having 3 dimensions, the dimensions being shown to bubble out of the two dimensional matrix in the fashion observed.

One electron 12 is shown expanded out to show the component ct4t12 states 172 and a center of charge 57. The net center of charge 57 is an average from a time-based perspective is the location of the electron which is a function of all the moving elements of the electron 12 as x changes.

COC 57 composed of many sub-spews, indeed everything is so composed except ct1 and the first fold of ct2 which is only ct1. Hence, you don't have fundamental particles, fields and space; space itself can be broken down and there is only one fundamental element, necessarily or equivalence would be impossible (e.g. e=mc\hat{ }2; spacetime, etc). It is easy to see why the chances of a sustained fusion reaction are limited, because there is no incentive for the neutrons to form stable ct4-5 transition states except where in a prior compression state there is an overall tendency towards compression in the lower ct state transitions. Hence in fusion, the goal is to concentrate those compression tendencies.

Here there is a shared ct4t12 state 172S shared between the electron and a proton 67 which represents an element of charge frozen in place in this view.

Maintaining the method of designation, spew 3030S is the strong force reflecting absorption and spew between two neutrons, the absorption of space at this high concentration being exponentially higher, but of the same form as gravity which is not shown in this view. Not all spew goes to a subgrouping and this is designated as 67XS by example, spew from a proton 67 to no place in particular designated as X. The X does not designate a randomness, only that the spew is not specifically designated in the drawing.

Neutron to Proton Spew 3067S reflects the weak force sharing of information between the neutron and the proton. One can see there is electron to photon spew 12168S and spew between two different electrons and a proton remote electron to proton spew 1294Sa and adjacent electron to proton spew 1294Sb. There is proton to proton spew 6767S seen largely as a repulsive force, perhaps as both ejecting ct4t12 states towards each other. While many photons 169 and electrons 12 are shown; no attempt has been made to show the full extent of population of even this very simple atom according to this model, but only to show the dynamic nature of the bonding to be targeted in reactions.

FIG. 33 shows an alternate view of burning oxygen 276A with Hydrogen 276b to get water 276 using the designation of FIGS. 3,4, and 19. Neutron B,C to Neutron B,C information sharing can be seen as spew 3030S ultimately resulting in proton to neutron sharing 3067S; but the processes shown in FIGS. 31 and 32 do not exist in a vacuum and a different view in FIG. 33 shows more about how this process works.

### FIG. 34

FIG. 34 shows a view of fusion. Here Hydrogen shown as H2 and Lithium six shown as Li-6 are shown with some spew identified as 3030S between neutrons in the fashion indicated. The result here includes but is not limited to a Helium built from the unbalanced lithium neutrons 30Li1 which are only partially balanced by proton 375 and its electron shell 376. He− designates the elements of the reaction which did not bind to create fusion, but which would approximate another Helium with these limited elements.

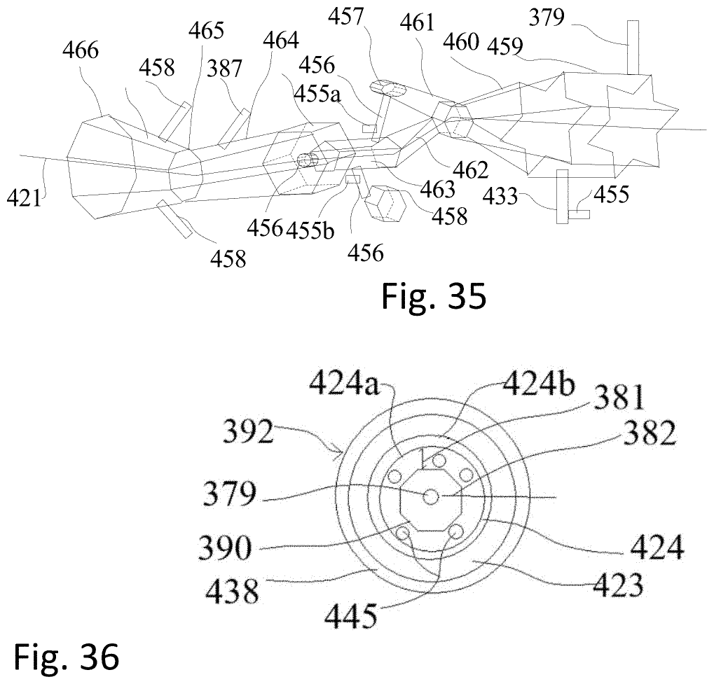

### Process FIG. 35

The transitional nature of the reaction is shown in exemplary form in FIG. 35. At least one first contact means 379 for generating a plasma or plasma arc. In this case there is a two-pulse plasma 459 targeting the atomic level as six sided in this example maintained by at least one plasma cannon 433 with plasma accelerated into the reaction by at least one electromagnetic accelerator means 455. At this point there is a compression step 460 followed by separating out reactants 461 from 462 transitioning from a six sided targeting to a five sided targeting 463 where the separated 10 sided reactant 457 is brought back in with a channel means 456 aided by at least one second electromagnetic accelerator means 455a followed by the addition of a six sided reactant 458 via a second channeling means 456a aided by a third electromagnetic accelerator means 455b to get the ten sided reactant 457 within the six sided reactant 458 which may be subject to spinning compression 464. At least one shaped charge means 387 to a shift to 8 sided geometry at inflection point 465 after which at least one expanding means 458 uncompacts the reaction all along a line of reaction means 421 for defining the line of reaction, possibly following the plasma generating means.

The exact nature and steps of this reaction will vary with experimentation, the key element being that it targets the many targetable features including dimensional shape at the atomic level and the shifts in dimensional state, absorption and spew and the related rotational symmetry and balance, concentration, time of reaction, number of actual dimensional transitions of various reactants, purities of reactants and the resulting purities and separations within the steps of the reaction, voids and the makeup of those voids (amounts of ct1-3 and beyond), separations by plasma, electromagnetic means, pressure, heat, volume and the like, compression by the same features, barriers, and the precise series of steps and pauses.

This reaction focuses on the reaction of six sided features to 10 sided features to the possibility of an 8 sided geometry allowing the transition first to a 10 sided neutron from a possible mixture of 10 sided neutrons and protons (not shown) to neutrons which are ultimately paired and stabilized with other reactants.

In this example, targeting of six sided features is followed by separating, the primary role of Plasma, then 8 sided, five sided, six sided back to 8 6 and 5-sided expanding six with compressed 10 and the 8 sided transitions are all targeted. This shifts from a coarse pummeling of features to attempting to manipulate the reaction and dimensional shifts.

### Pellets FIGS. 36-55

FIG. 36 shows at least one first contact means 379, in this case a wire hooked to a microwave generator (not shown) for generating plasma when in contact with at least one second contact means 382 which is a wire attached to the other lead of the microwave generator (also not shown) for generating plasma in the manner known in the prior art. The area of the plasma generated covers a great deal of a plasma core means 390 for generating a reactive fusion material, in this case means 390 is a Li-6.

A first shield means 424 separates the plasma reactants. Means 424 is a destructible barrier which effectively dissolves when the plasma from the plasma heated core means 390 reaches means 424. Here there is a separation between the inner wall 424a and outer wall 424b of means 424 to provide a scaled separation to mimic fractal changes desired.

Inside of the shield means 424, embedded within insulating means 381 is a proton enrichment means, here second reactant layer 445, possibly hydrogen. There is a second compression means 423, which may be an explosive reactant mix. The entire pellet 392 is held within a second shield means 438 which is a harder shell to partially contain the explosive reaction between core means 390 reacts with the second reactant 445.

The arrangement is one where absorption and spew are targeted. When we say Li-6H explodes in contact with water, we are talking about a shifting matrix, not the bulk relationships of pre-AuT physics. Hence a shaped dimensional change is desired. For this reason, the core means 379 has a base six shape and the second reactant a base 5 shape. The interaction of the wires, the charge, the resulting plasma, the effect of the macroscopic features on the microscopic features define the process.

While the core means 390 is defined as Li-6H, it can also include an ignitable foam of the type known in the art for enhancing explosive fusion reactions. The foam may be layered or replaced with substrates, like graphene to provide a shaped surface against which the reactions can be pushed to attain desired dimensional features at the atomic level where compression occurs.

The second reactant 445 here is contained with an insulating means 381 (typically in the prior art a foam) used for encouraging the reaction around the means 390 to both insulate the Li-6H from the first shield means 424, in place of the shield means 424, and/or to achieve stabilizing effects.

The arrangement of reactants can be changed. Means 390 may exist inside a shaped hollow wire, especially where the wire burns in the presence of the generated plasma, the ignitable wire might be means 379.

In the preferred embodiment, the plasma is generated with a microwave generator of the same type used in an oven, with conductors insulated to the point of contact with reactants along one of the conductors or around the conductors at the point(s) of contact. Other types of plasma generation known in the art may be used in place of this method. The triggering wire (means 382) and a reactant wire (means 379) hooked to a microwave generator to achieve plasma can be replaced with other means for generating plasma.

Instead of using a secondary explosive to get compression, a Li-6 core is directly exposed to the plasma and in the plasma it moves through an insulating barrier bringing the Li-6 within contact of a reactant matrix, heavy water, for exploding free Li-6 to compress the reactants and add neutrons. The simple pellet so defined is finished with a hard shell which contains the chemical explosion focusing it inwards. Additional explosives and fuels can be salted within the insulating barriers or reactants to achieve or enhance the shaping or compressive features of the explosion or other features or the reaction.

This pellet can be altered to improve the science and this simple version is only given to define a few minimal concepts of the AuT fusion reaction in terms of a pellet.

### Construction of Pellets and Using

This can involve putting a pellet as defined herein, into a magnetic field to hold protons as neutrons are pushed toward the center. Heavier info plus spinning increase to push together in center. The construction of pellets can be set out as picking the reactant(s), one or a plurality, coating the reactants with liquid foam or cutting out a chamber in dried foam and inserting, then sealing the reactants. The type of foam, density, width and shape define the order of reactants and their reaction times to maximize the desired dimensional transition.

The pellet may be exposed to salt water or other plasma accelerators. There can be mineral spirits or other non-water environment coatings for wires with water reactive Li6H. This is discussed in terms of placing the LiH or other reactants within foam, sealing and joining the reactants.

Shaped explosive outer layers or otherwise focused charges encourage smaller pellet design. Exhaust lines for the non-reactant elements (e.g. a vacuum line directed to one or more element of space) can help to enhance reactions.

The entire pellet can be subjected to the fields and lasers or a portion can be targeted to get the effects, but they are not treated as fields or lasers, but as fractal state modifications to a matrix to be modified, the matrix here being the pellet.

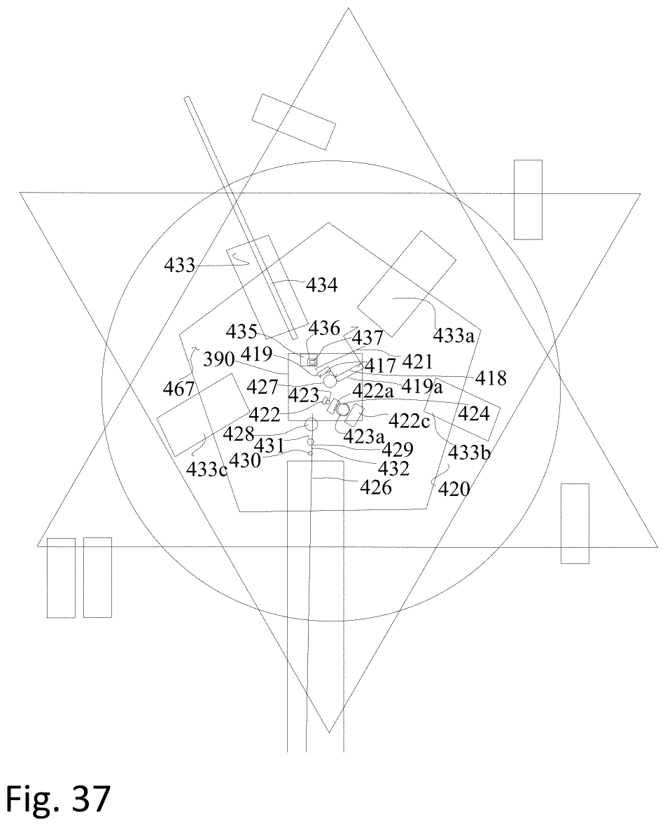

FIGS. 37-55 show similar concepts for carrying out reactions using pellets which have more features than the base conceptual framework of FIG. 1 in order to give a better feel for the broad experimental features available under the preferred embodiments.

In FIG. 37 the inside of a pellet is shown. The degree to which each element is within or without the pellet is determined by the desired design parameters. Along line of plasma reaction 421 there is f-series spacing between first spacing 417 and second spacing 418 of first reaction means 419. The F-reactor means 419, S-reactor means 420, T-reactor means 428, F1-reactor means 429 and F2-reactor means 430 F3-reactor means 421, S i-reactor means 425, T1-reactor means 426, can be any of a number of different features for isolating and focusing reactants including magnetic fields, magnetic accelerators, plasma generators, plasma canons, lasers or just wires hooked up to different power sources crating an arc when they are in contact.

In the embodiment shown in FIG. 37, The line of line of plasma reaction is triggered by contact between FR 419, SR 420 or TLR 426 which react with companion reaction means 427, in this case a wire attached to the other polarity of the plasma generator.

Any of these wires may be protected by an insulator means 422, 422a, 422b or 422c.

To enhance a post plasma reaction Effectors as described by function above are used. Reactants, referred to as compression means 423 which may be any effector leading to compression, here an explosive charge detonated by either the plasma or electrical contact of any of the reactor means to a companion reaction means 427. There is a shield means 424 for focusing the compression means, in this case a physical shield shaping the blast of the explosive charge. A second compression means 423a is shown with a second insulator means 422a and third insulator means 422c protecting it on either side from premature reaction.

To allow more control of the timing of the reactants, they are aligned along the reactor means.

The reaction in this case continues with T-reactor means 428, F1-reactor means 429 and F2-reactor means 430 in this case being, respectively, Li6, salt water, a means to enhance the plasma, and Deuterium with spacing 431 between items 428 and 429 and spacing 432 spacing between items 429 and 430. This spacing can act as part of the EFFECTOR structure.

Where necessary to maintain the reaction or otherwise to trigger the reaction, a focusing means 433, hear a focused beam of plasma, can be used for introducing plasma into the plasma core means 390, here the meeting area for the different reactants. There is a fourth line of plasma 434 in this case a tube for carrying the plasma from the cannon means 433 into the plasma core means 390. Core means 390 can be a foam container or other material for maintaining the plasma during the separation and concentration steps of the reaction.

Plasma is primarily discussed to separate protons and neutrons. Unstable compounds in conjunction with other reactants, notably Li-6H and heavy water, can be used without plasma. The foam keeps reactants separated until they are ready to be combined.

In this case, there is a second reaction internal to the first triggered by the focusing means 433 including a First material means 435, LiH around a second material means 436 transitioned in amount according to F-series transitions targeted and in this case Deuterium followed by a third material means 437 also designed to mimic an opposite f-series transition which in this case is water.

The movement of means 421, 425 and 426 against means 427 or each other generates plasma through having opposite plasma generating currents which may shift between them during the reaction process to obtain the results desired.

One way of controlling the reaction is to have any contact between means 417, 418, 419, 420, 421, 425, 426, 428, 429, 430 be wires moving along the means 427 in the order desired as plasma separates and allows combination of reactants items 428, 429, 430, 423 and 423a as well as any material of item 390.

A foam means 467 for enhancing plasma has features to encourage fusion, can be in different to compress, to encourage separation and to encourage dimensional change.

Dimensional features are encouraged with focusing means 433, 433a,433b and 433c in conjunction with the means 421,425 and 426 in this embodiment.

There are several ways which will be discussed, but it is worth looking at how an engine can power the broad steps of ignite a reaction with plasma to open the electron and proton shells, imploding to push together and eliminating ct states using movement as by the sequential explosion to spin reactants, placement of reactants at steadily expanded positions, or otherwise. In this case one of a potential series of rotary engines is shown to allow for sequential ignition of rotating pellets.

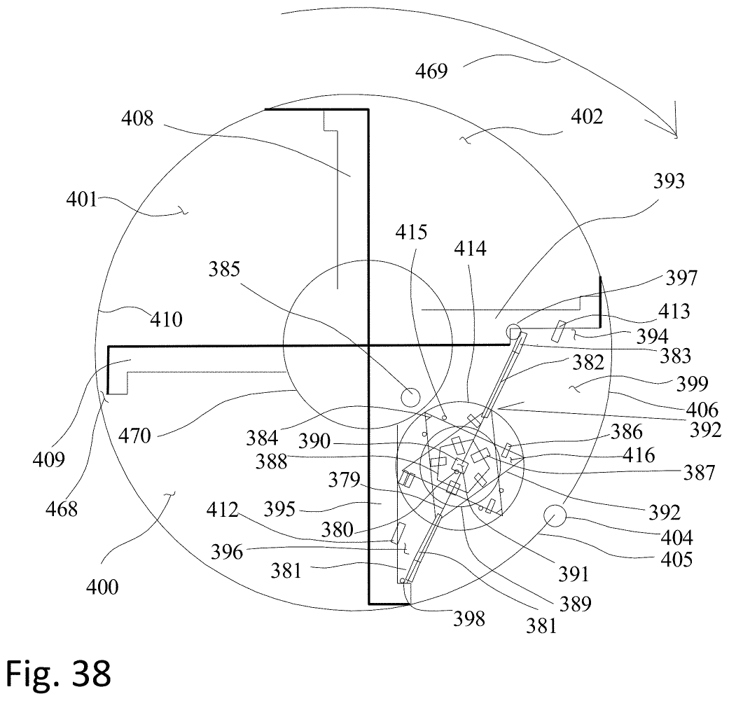

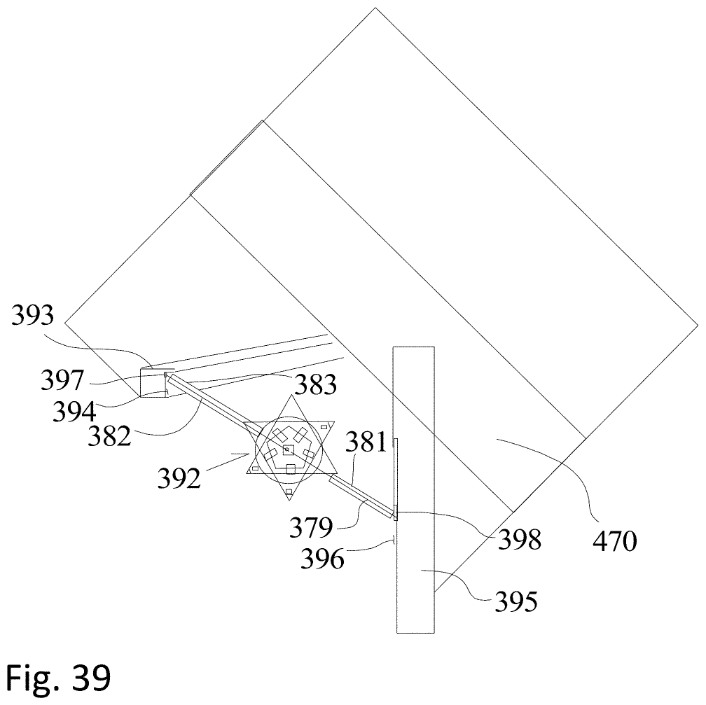

### FIGS. 38-39 (18-19)

The steps for the rotating engine are: a) insert pellet, b) inject pellet with arm of plasma generating spark, c) coordinating reactions to get dimensional results, d) coordinating effects to get dimensional results, e) heat exchange from the reaction and f) expel heat and residual pellet as shown in FIG. 38 and the side view shown in FIG. 39.

Using the Effector parameters (e.g. pulsing plasma, charge, dimensional effect, compressive effect, decompressive effect, etc) the number of times can correspond to the state desired as a function of f-series of compression series steps and dimensional changes as desired including transitional states desirable to the reaction in question.

Accelerate the entire pellet within a field (to reduce time components); with or without rotation (as with rifling) to give rotational stability to change the features of the pellet as it is accelerated towards a target. Collision can be used to enhance compression and shape and balance.

FIG. 39 shows another alternate where the pellet is designed like the other pellets with at least one first contact means 379 for generating plasma (arc) within a coating means 380 for enhancing the reaction. This means 380 may be foam, saltwater, heavy water, etc. The means 379 is protected by an insulation means 381. The plasma is generated by contact of means 379 with at least one second contact means 392 for generating plasma which in turn is protected by a second insulation means 383. In this case means 381 and 383 form a spindle on which the pellet is rotationally held.

At least one magnetic tip 384 interacts with a magnetic rotation means 385 to allow the pellet to spin around the spindle. The spin can be enhanced or replaced by a fuel accelerator means 386 and compression can be assisted with a shaped charge means 387 and a shaped foam plasma means 388 can serve to maintain the plasma until it is time to remove it for compression.

The sequential steps may be separated by a separating layer means 389. There is a plasma core means 390 for generating a reactive fusion material 390 in the preferred embodiment this is the N-unbalanced.

There is an ignition gap means 391 for extending the plasma.

At the point where ignition is initiated, the pellet means 392 is held by arm 393 by holding electro-magnetically or mechanically the insulator 383 within gap 394 in arm 393. The other insulator 379 is held by a second gap 396 in the second arm 395 in a similar fashion.

Ignitor means 397 in the first arm is a charge source connected to the wire part of means 383

Second ignitor means 398 contacts the wire part of means 379 in the same way to transfer charge from the arms into the pellet where it creates the plasma.

Four arms for the purpose extend from an arm hub 470 separating the first ignition chamber 399, a heat exchange second chamber 400, a third clearing chamber 401 and a fourth loading chamber 402 in this embodiment. Both the arms and the pellet may spin up to or beyond the point of cavitation.

To allow for spin a closure 403 with a closure seal 404 formed with a door for the first chamber 405 and a second door for the first chamber 406. These may be injected with and disposed of with the pellet.

The third arm 408 and fourth arm 409 complete the separation of the chambers.

The function of the circular engine is to load pellet and enclose it if necessary, rotate and ignite the pellet, circulate to allow heat exchange and to discharge the old pellet and load the next pellet. Multiple engines of this type may be aligned to provide the heat required from the arrangement.

Pulsed plasma may be used in place of constant plasma because of plasma's limited purpose. The purpose for spin inducing through whatever means is discussed in more detail with respect to other drawings, but the key is to eliminate pre-time states to allow compression to occur more easily and/or to encourage balance of the resulting states.

Shaped charge means 387 for shaping the post plasma reactants may be actual explosive charges and may stabilize and possible spin by targeting the plasma at an angle. These could initiate the reaction by firing along the line of the spindle and being aligned and then offset, pulses of plasma. They can also pulse electromagnetic radiation and/or excited electrons to help balance the resulting transition and complete ct state. Potentially these could be used before (not just instead of) the plasma inducing contact means (382 and 379). This would be as easy has having means 382 replaced with a plasma cannon which can be offset as by at least one pulse canon means 412 for inducing spin, enhancing the plasma and/or adding additional spin, compression or plasma.

A second plasma cannon means 413 is provided for the same purpose as means 412.

A spin means 415 which may be in the form of a rocket may be used to increase or decrease spin depending on the effect determined most beneficial at any stage.

Some of the effects in this system are to (1) stage plasma to separate and energize reactants at different points in the reaction, collapse or expand the reactants, increase the richness relative to neutrons, protons and electrons in the sequence desired as well as lower states at different points in the reaction and change the amount of time/lower ct state changes by accelerating pressure and heat.

While this shows reaction from the inside out, out reactions could work from the outside in as is discussed with other pellet designs.

The preferred arm layout is to allow loading of pellets with grooves to get alignment supplemented with magnets, pathways to target and control movement and timing of expanding and compressing steps, alternating compression and decompression, pulsing of plasma, cooling, spinning, controlling dimensional shape, timing steps, enhancing the absorption and spew environment and reactant components and exerting varying Intensity, timing, amount, concentration, volume of the energies and reactants involved to provide desired f-series effects.

The use of centrifuge (speed pressure in place of gravity) is discussed in more detail relative to other drawings.

Current 110 is used to control the movement of the protons and electrons which, being charged, can be directed in this way.

A rotational (centrifuge mixer and expander means 127 can serve a couple of purposes. One is to push together the neutrons 30, but it can also push apart protons 67 and bring them back together.

If you have a proton shell that you want to leave mostly intact, you might still want to add lower information states to the proton shell to expand it so that you have room for the neutron to enter.

This process recognizing the form of the reactants both in terms of their fractal shells, absorption, spew and dimensional components should allow for a more efficient reaction. This is enhanced with the step of (VII) stabilizing the new nucleus (here two protons 94 and two neutrons 30) with a new COC 93F by adding information bundles 106A and 107A including ct4t12 states 95 for example with accompanying shells and lower ct states to allow the formation of stable bundles 99A to encourage fusion formation by adding the type and quantity of information necessary for stabilizing the new core according to the fractal model taught herein.

Where spirals and specific chamber dimensions are not possible, it may be possible using shaped reactants, sized reactants, spaced reactants, shaped spacing, timed compression, timed decompression, timed application of plasma and the like to simulate an order which might be opposite shown and extremes that encourage the type of quantum fractal transitions that should be obtainable in terms of both imparting rotational and compression oriented stabilization necessary to get fusion.

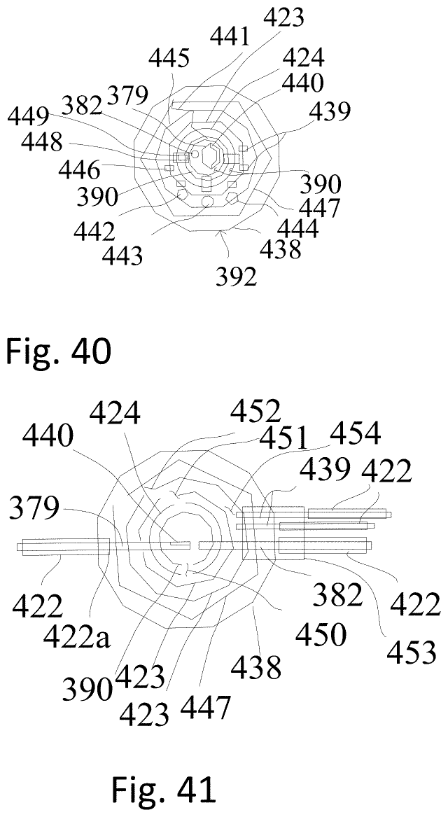

### FIGS. 40 and 41 (20 and 21)

FIGS. 40 and 41 show how the pellet reactants may be rearranged to get desired results and how other features can be added to the pellet to encourage a reaction of the type desired while minimizing time by having the reactants sequentially react from the center to the outside of the pellet.

At the center is the plasma core means 390 for generating a reactive fusion material, containing, and enhancing the plasma and possibly extending it into the other sections of the pellet 392. Within the core means 390 is at least one first contact means for generating plasma 379 protected by insulation means 381 which may also be a form in some cases. In the preferred embodiment, a charge of the type discussed above moves through this means 379 when in contact with at least one second contact means 382 for generating plasma.

There is an insulator means 422 to protect the means 379 and 382 which can be wires and a portion of the insulator means 422a which extends into the pellet 392 where that is desired to ensure the reaction remains where desired within the pellet.

There is at least one compression means 423 with a shield means 424 to contain and direct the force of the compression means, in this case inward; there is in this case a second line of plasma generating means 425 protected from the initial reaction by a second shield means 438. There is a spark means 439 may be a tesla coil to provide a different expansion media of plasma.

In this embodiment, a shaped surface 440 is provided against which reactants may be driven or from which they may be drawn to encourage the geometry desired.

There is a fuse line means 441 which may be an ignitable material to steer and carry reaction, and the reaction can be continued at a first secondary reactant 442 which may be salt to mix with water, within the matrix, or other reactant as well as a second secondary reactant 443 both of which work to alter a portion of a layer as opposed to the entire layer and even a third secondary reactant 444 passing between layers to enhance the interaction of one layer with another.

These are distinguished from the second reactant layer 445 which is an entire layer of reactant as opposed to an impurity within a layer like items 442-444, which might be more lithium, etc.

To ensure the reaction continues there is a secondary plasma generator means 446 for providing a plasma reaction or pulse or drive the reactants towards the center of the pellet defined by item 390 before secondary explosive 447 or in conjunction with the secondary explosive.

There is at least one secondary neutron source 448, a deuterium accelerator and in this case a secondary neutron source 449 of the same or different type.

In FIG. 40 there is a first effect opening means 450 which functions like the fuse line means 441 to direct the reaction and in this case through other layers there are a second effect opening means 451 and a third effect opening mean 452.

To allow rotation along with the rotation of the pellet there is an axle means 453 for providing a central rotational axle on one or both sides of the pellet. Also shown are an air type layer 454 only shown to distinguish it from what are otherwise through of as solid layers, but each layer is designed to encourage the effects taught herein.

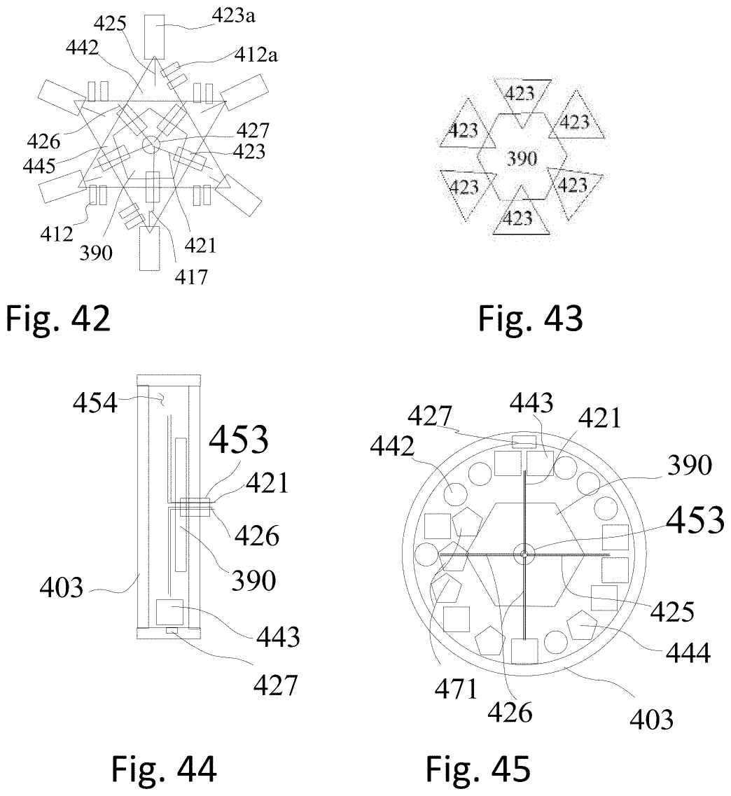

### FIGS. 42 and 43 (22 and 23) Alternate Pellet Designs for Spin

FIGS. 42 and 43 and FIGS. 44 and 45 show alternate methods of imparting spin to the reaction.

Referring FIGS. 42 and 43, the pellet revolves around a central companion reaction means 427, here a current carrying spindle.

In this design there are two sets of reactants, the inner reactants which drive a neutron heavy plasma to the core and a secondary set of reactants which are proton heavy (a third set of electron heavy reactants may be used or the proton heavy reactant may use electromagnetism to allow the protons to preferentially move toward the neutron heavy plasma first.

The same wires can trigger both in the manner shown, breaking the first point of contact at the center in favour of the second points of contact in the middle when the compressive agents in the center are set off to create a more simultaneous reaction.

The means 421, 425 and 426 are moved outward to work in common when gaps such as f-series spacing 417 between them are closed by the rotation of the central companion reaction means 427 allowing reactants 443, 445 and 442 to sequentially be made a part of the reaction.

Means 412 and 412a impart, respectively spin or counter spin to the pellet.

FIG. 43 shown where an alternative placement of item 423 can change the reaction from 5-sided pressure to six-sided pressure as a shaped compressive charge.

### FIGS. 44 and 45 (24 and 25)

FIGS. 44 and 45 shown a spinning outer shell from closure 403. This version uses second reactants 442, 443 and 444 which are separated in an f-series arrangement and include a spiraling layer 471, here made up of reactant 444.

The means 427 here is within the outer wall defined by closure 403 or means 427 can even be made into the outer wall contacting items 412, 425 and 426 which enter through item 453 previously identified. Item 426 can be seen with two separate arms to react in multiple places as opposed to items 412 and 425 which have single arms for single reaction locations.

In this way with or without rotation of time 390 the entire inside of closure 403 can be spun to create pressure against the closure 403.

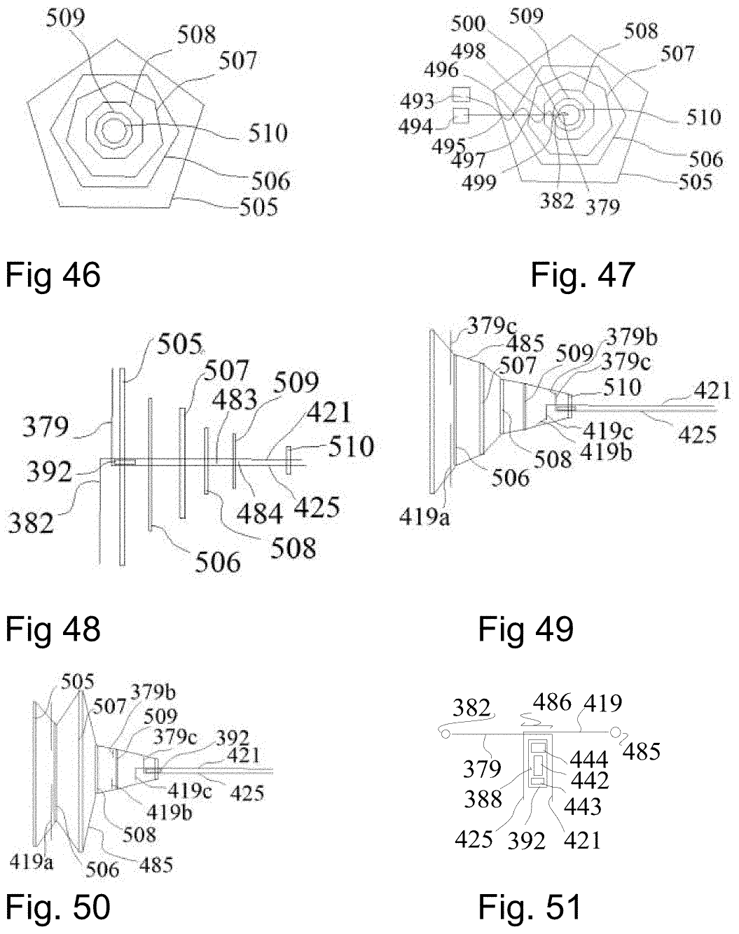

### FIG. 46

FIG. 46 shows an alternate to FIGS. 39 and 40, a 5 to ten-sided funnel transition. This transitions with real or, more likely, virtual walls to encourage the dimensional structures for separation, concentration and compression sequentially for each type of reactant using different sided structures (wallsided refers to the number of sides), here, one or more of 5 wallsided 505, 6 wallsided 506, 7 wallsided 507, 8 wallsided 508, 9 wallsided 509 and 10 wallsided 510

While this shows a gradual decrease from 5 to 10 in diameter, it is equally possible to have contracting alternating with expanding at any level.

The 5 wallside 505 is shown as the largest, but that is just exemplary. Skipping sides is possible, e.g. from 5 directly to 10 or from 10 directly to 5. There can be other sidings since base 8 and the resulting 16 side (not shown) are involved in molecular states.

### FIG. 47

FIG. 47 shows a shaped wire (the ends are referred to as pins at times) as the contact means 382 which can define one or more of the openings otherwise shown by the exterior walls as 5 side through 10 side in FIG. 46. This one defines an opening on the interior and can contact wires either on the interior or exterior and can have exterior or interior reactants within the area where the plasma is generated. Not every contact with the wallside 505 need be associated with a plasma reaction and sequential plasma reactions would primarily be necessary to maintain the reactants in a plasma state as they are reduced. Movement of the wires can be in either direction or with multiple wires in both directions at once.

The spacing of the curves, the number of different pins and the arc resulting can all be used to mimic the features required to achieve dimensional changes and compression changes relative to the reaction(s) in question.

The reactants on each wire, within each plasma field or part thereof in terms of size, concentration, reactant effect, can be varied to achieve the dimensional and compression features of the fractal endpoints and intermediary.

In this case the features are positive lead 493 negative lead 494 both leads of a plasma voltage generator (not shown) and where the point of contact referred to is between these leads as item 279 is withdrawn or inserted into the pellet within item 505 point t of contact at wall5 495, point of contact at wall6 496, point of contact at wall7 497, point of contact at wall8 498, point of contact at wall9 499 and point of contact wall10 500.

While physical walls are shown, the idea of creating virtual walls would allow the reactants to be maintained in place and for the size of the walls to be controlled by careful timing of the plasma cannons or lasers or explosives pushing the elements. On the negative side, successful fusion even on a small scale to generate energy without a gravity well on the scale of the sun or a pressure well on the order of deep within the earths mantle suggests that exploding pellets and disposable chambers defined as pellets would have some advantages and give an engine quality to an otherwise explosive core.

### FIGS. 48 and 49

FIG. 48 shows a side view of FIG. 48 and FIG. 49 shows a cone closing the side view.

Two wires 379 and 419 which contact the exterior walls 505-510 sequentially, which wires are designed to be dragged via ends 421 and 425 running to their charging source (not shown) respectively through holding a pellet 392 between them.

This shows how the wires can be used to drag the pellet or the plasma ignite the pellet through the decreasing diameter and increasing sides mimicking the direction. It also shows how the distance between the wallsides may vary, in this case primarily shown between wallside 9 and 10.

Balancing is also critical to stabilizing structures just as unbalancing can be used to stabilize them.

The simplest way to accomplish this is shown in FIG. 49 where the wire is broken or bent, in this case wire section 379a is broken off when it passes through item 506 and wire section 279b is bent up as it passes through 509. The same is true for wire 419, 419a, b and c.

The wall 485 of each of items 505-510 acts as the ground to complete the circuit for fusion. The distance between the sections can be seen to be varied for purposes of mimicking f-series or compression features as set out for all Effectors.

### FIG. 50

FIG. 50 shows the small chamber and expanded chamber with expanded and reduced exposure to the edges of the walls 485 where it grounds to create plasma with contact between the wires and the exterior wall 485 for the embodiment of FIG. 49 where the change in diameter is inconsistent, opening between 506 and 507 before continuing to close at 508.

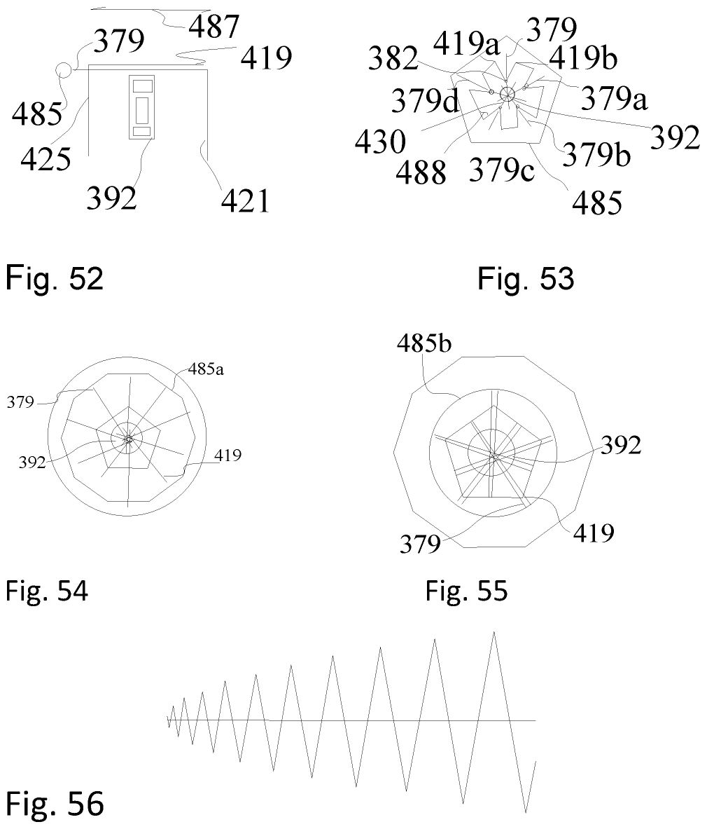

### FIGS. 51 and 52

FIGS. 51 and 52 shows an alternate embodiment to FIG. 49 showing where there is expansion followed by compression. FIG. 51 shows the small chamber 486 and expanded chamber 497 formed by the wires dragging the pellet 392 with parts 442,443 and 444 as described as reactants in a foam 388 with expanded and reduced exposure to the edges where it grounds to create plasm with the exterior wall 485 or means 382 for the embodiment FIG. 53

The number of pins can vary so that one adds pins at different levels to go from a base 3 (3, 6, 9 pins) to a base 5 (5, 10, 15 pins) by way of examples and even a base 8 pin set and these can be combined in different layers, even by using the drag through method as shown where pins 379-379d provide 5 sided contact, on either side of each, as with 379 is two points of contact (with a circle) 419a and 419b and with interior pins 430, for example, here providing for 10 points of contact around pellet 392 so that multiple reactant locations, such as 488 within the shaped pin formed by the contact between items 419, can react in near unison and with varying degrees of dimensional or shaped control or compression within the scope of Effectors as described herein.

FIGS. 54 and 55 show the type of pin structures described in reference to FIGS. 51 and 52 here contacting either at 10 points along item 455a or at 5 for 485b by bringing, in this example, 379 and 419 together or drawing them apart.

FIG. 56 is a chart which shows the solutions for fpix added together for the first 32 changes in X. Since this is a fractal equation (fpix), this chart is ultimately reflected in higher compression states and can be said to show why subsequent compression occurs, as a fractal reflection of this early, inherent compression. The universe is constantly moving between net positive or net negative. At higher compression (ct2 and higher) the universe moves between net expanding or contracting. The universe never fully expands or contracts.

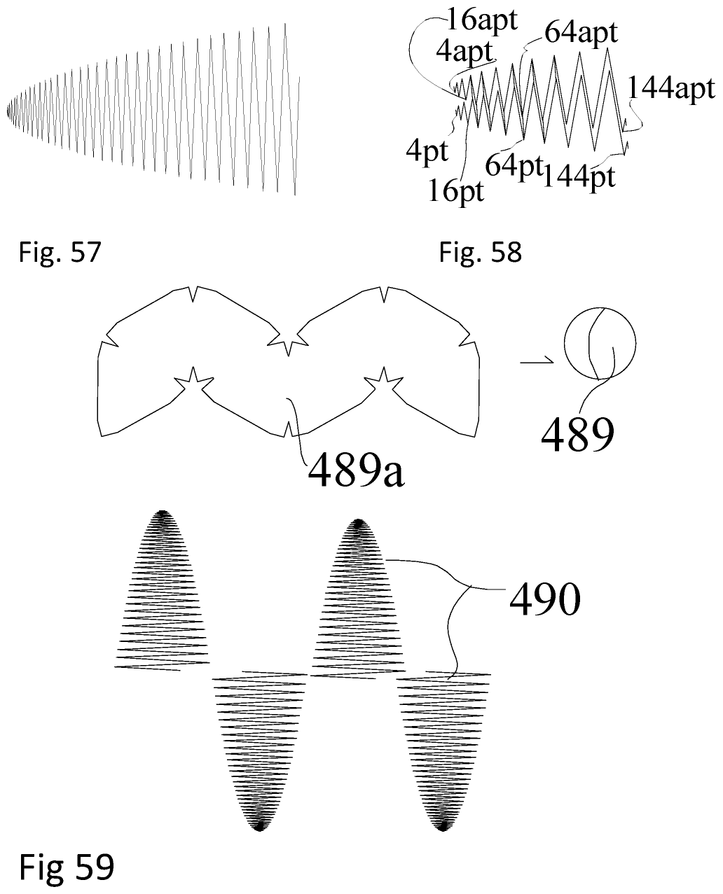

FIG. 57 shows 5000 points in a chart like FIG. 56.

FIG. 58 shows one method of folding from ct2 to ct3 where it extends into a second dimension showing possible alignment of points 4pt with 4apt, 16pt with 16apt 64pt with 64apt and 144pt with 144apt each of these points being defined by their value at the inflection point (e.g. a value of 4, 16, 64 and 144 from the midline).

FIG. 59 shows an alternate folding to FIG. 58 leading to Gaussian curvature possible because of the fractal nature. A sphere 489 is shown and the flattened sphere 489a is shown. The realignment of 4 5000 point charts 490 of the type shown in FIG. 57 shows an alignment not dissimilar to the flattened sphere 489a which shows how folding in this way leads to the type of observed curvature we observe. These changes in curvature can be individually targeted to get desired results. When one talks about mass bending space, this is the process, this folding of ct1-3 into an “un-flattening” globe; a black hole merely folds lower states into a “un-flattening” 4 dimensional globe, difficult to envision, but merely the next higher state of ct compression mathematically. This shows the dimensional targets for manipulation of dimensional changes at different levels (FIGS. 56-59).

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1-20. (canceled)

21. A process for dimensional manipulation comprising the steps of (1) defining dimensional features as ct states defined by at least one iterated equation which separates compressing ct states from decompressing ct states wherein compressing is towards higher dimensional features and decompressing is the movement from higher dimensional features to lower dimensional features; (2) identifying a matrix containing a plurality of “ct states” and (3) changing at least one ct state to alter at least one dimensional feature of the matrix.

22. The process of claim 21 wherein the at least one iterated equation is at least one non-dimensional iterated equation generating quantum ct states and wherein compressing quantum ct states yields compressed ct states and lower compressed ct states between at least one of the compressed ct states and the quantum ct states.

23. The process of claim 22 wherein the at least one non-dimensional iterated equation generates the quantum informational states which change between positive and negative values according to a quantum count with a fuse length for each quantum ct state, a net compression for each compressed ct state, and an inflection point for each compressed ct state where each compressed ct state changes between compressing and decompressing.

24. The process of claim 23 wherein the matrix change is absorption where the matrix becomes more compressed and the matrix change is spew as the matrix becomes less compressed.

25. The process of claim 24 wherein compression further comprises balancing compressed ct states on a fulcrum comprised of shared lower ct states from at least two higher ct states as Fibonacci series spiral solutions of the at least 2 compressed ct states.

26. The process of claim 25 wherein balancing further comprises successively lower ct states within the spiral solutions of successively higher compression lower ct states to balance the compressed higher ct states.

27. The process of claim 33 wherein balancing is further defined by balancing absorption of spew of ct states between compressed ct states and where targeting further comprises targeting the absorption and spew of the matrix, targeting shared information between compressed states, or targeting both.

28. The process of claim 27 wherein balancing along a fulcrum spirals further comprises (1) defining the electron shell as a third outer spiral, balanced on inner spirals of a proton outer shells as a second outer spiral, around the neutron cores sharing information as a fulcrum between the two neutrons and from which extends the first inner spiral to form and stabilize a neutron core in a molecular fusion reaction.

29. The process of claim 28 wherein balancing comprises opening at least one of the spirals using plasma before the spirals balance.

30. The process of claim 27 wherein balancing comprises creating conditions to encourage balancing.

31. The process of claim 27 wherein balancing comprises determining a set of resulting ct states desired, determining a plurality of reactant ct states based on the resulting ct states; and changing the reactant ct states to obtain the resulting ct states.

32. The process of claim 24 wherein the at least one non-dimensional iterated equation is fpix, the denominator of pi, and wherein the change in value occurs after the quantum value equals the value of fpix for the ct state's fpix value immediately preceding the change in value and corresponds to the value as a new fpix value for the fuse for the lowest used ct state.

33. The process of claim 28 comprises at least one compression iterated equation derived from the Fibonacci series.

34. The process of claim 29 wherein the compression iterated equation has an exponential result.

35. The process of claim 30 wherein ct states further comprise stepped compression between iterated equation solutions as transitional ct states between ct states defined by successive iterated equation solutions.

36. The process of claim 30 wherein the compression iterated equation is comprised of 2f(n)\hat{ }(2\hat{ }n) where f(n) in the Fibonacci number for n.

37. The process of claim 24 wherein ct states at the level where energy becomes apparent are treated as a transition between pre-time ct states and post-time ct states and wherein changing comprises treating time as change in the pre-time ct states viewed from the post time ct states.

38. The process of claim 33 wherein changing further comprises treating energy as pre-time dimensional change within the matrix.

39. The process of claim 24 wherein changing comes from the group comprising removing ct states (as for observation), compressing, decompressing, increasing ct states within the matrix (as by combining two matrix), changing the net fuse length of the matrix, changing the absorption of the matrix, changing the spew of the matrix and identifying a ct state as an identified ct state within the matrix and changing the ct states making up the identified ct state.

40. The process of claim 24 wherein changing comprises a change from the group of processes comprising identifying the ct states which are to be manipulated, select a compression or decompression ct state component to change the selected ct states, adding the compression or decompression components to yield the new ct states controlling time within the matrix, quantum computing, determining probability of state changes, manipulating energy, identifying qubits, identifying qubit pre-time states, creating qubits, reading qubits, manipulating qubits, pre-atomic fusion, atomic fusion, atomic manipulation, molecular manipulation, post molecular material manipulation; identifying or changing force features; changing multi-dimensional fractals of different fractal compression states within the matrix; changing base states where fractal is made of a base state, ignoring dimensional curvature; targeting relationships between the pretime and post-time features, controlling ct states, targeting at least two ct states sequentially.
